(19) United States
(12) Patent Application Publication
(10) Pub. No.: US 2026/0308320 A1
(43) Pub. Date: Oct. 8, 2026

(54) METHOD FOR MAKING GLYCOLALDEHYDE POLYMERS

(71) Applicant: Sustainable Chemicals, Inc., Golden, CO (US)

(72) Inventors: Silvia De Vito LUEBBEN, Golden, CO (US); Ryan Gerald ANDERSON, Denver, CO (US); Anthony James BROCKWAY, Broomfield, CO (US)

(21) Appl. No.: 19/646,144

(22) Filed: Apr. 13, 2026

Related U.S. Application Data
(63) Continuation-in-part of application No. 19/172,571, filed on Apr. 7, 2025, now abandoned.

(51) Int. Cl. C08G 65/34; C08J 5/18

(52) U.S. Cl. CPC C08G 65/34; C08J 5/18; C08J 2371/08

(57) ABSTRACT

A method for producing polymers and copolymers from alpha-hydroxycarbonyl compounds and their dimers, the method comprises a condensation polymerization at least in part under reduced pressure in the presence of a Lewis acid catalysis wherein either no solvent is used or a variable and decreasing amount of solvent is present during the polymerization reaction. A polymeric product resulting from such a method with weight average molecular weight (Mw) equal to or greater than 15,000 Dalton, preferably in excess of 20,000 Dalton, more preferably in excess of 25,000 Dalton and most preferably in excess of 30,000 Dalton. A polymeric product resulting from such a method which exhibits T95 of 165° C. or higher. Films and molded objects prepared from the polymeric products. Methods for making films and molded objects employing the polymeric products.

### CROSS-REFERENCE TO RELATED APPLICATIONS

This application is a continuation-in-part of U.S. application Ser. No. 19/172,571, filed Apr. 7, 2025. This application is incorporated by reference herein in its entirety.

### STATEMENT REGARDING FEDERALLY SPONSORED RESEARCH OR DEVELOPMENT

This invention was made with government support awarded under contract No. 2024-33530-41906 by the U.S. Department of Agriculture. The government has certain rights in this invention.

### BACKGROUND

There is a significant need to replace or supplement polymeric materials currently generated from petroleum materials with polymers or portions thereof generated from renewable resources. Renewable polymers which exhibit commercially useful properties are of particular interest. Methods disclosed herein can be employed to generate polymeric materials (including copolymers) from renewable resources.

U.S. Pat. No. 9,040,635B1 reports method for making a polymer resulting from the polymerization of alpha-hydroxycarbonyl compounds), particularly alpha-hydroxyaldehydes and alpha-hydroxyketones, including glycolaldehyde. The method reported comprises dehydrating the cyclic dimer of one or more alpha-hydroxycarbonyl compounds promoted by a Lewis acid catalyst. A polymer of structure:

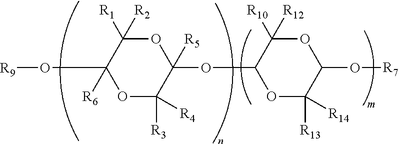

where n, m, R₁—R₈ and R₁₀—R₁₄ are defined therein is reported. Certain end capped polymers in which prepared polymers are reacted with an end capping reagent are also reported. This patent reports (Example 3) polymerization of 2,5-dihydroxy-1,4-dioxane, also known as DHDO, with a catalytic amount of scandium triflate [Sc(OTf)₃] conducted in acetonitrile (CH₃CN) with molecular sieves in a Soxhlet extraction cup under reduced pressure (150 torr). The polymer product reported had Mw of 2836 Da. This U.S. patent is incorporated by reference herein in its entirety for descriptions of polymers and structures thereof and the polymerization method described therein.

Luebben and Raebiger (2015) ACS Symposium Series 1192:305-328 “A Novel Renewable Thermoplastic Polyacetal by Polymerization of Glycolaldehyde Dimer, a Major Product of the Fast Pyrolysis of Cellulosic Feedstock,” Chapter 19 in Green Polymer Chemistry: Biobased Materials and Biocatalysts, DOI: 10.1021/bk-2015-1192.ch019 reports the synthesis of poly(2,5-dihydroxy-1,4-dioxane) PDHDO:

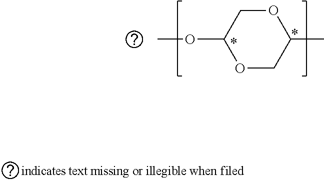

using Lewis acid catalyst to promote dehydration under mild conditions. The “best results” were reported obtained using scandium triflate (Sc(Otf)₃) as the catalyst with a Soxhlet extraction apparatus containing 3 Å molecular sieves to remove water at reduced pressure using acetonitrile and propionitrile at 150 torr of pressure to produce a fluffy white solid. Table 1 (page 322) reports Gel Permeation Chromatography (GPC) results for polymerizations noting Mw of 2836 and 6965 Da for the catalytic process using Sc(OTf)₃ in MeCN and EtCN, respectively. The text states that the catalytic reaction in ionic liquid (BMIM (OTf)) gives a product with Mw of 14, 600 Da. This reference is incorporated by reference herein in its entirety for descriptions of polymers and structures thereof and the polymerization methods described therein. Films produced with the polymer prepared were tested in tension with an Instron Mechanical Tester and specimens were reported to have elongation between 400% and 800%, Young's Modulus of 40-50 kPa and tensile strength at break of 185 kPa.

PCT/US2023/084958 (WO2024137712A1) reports polymers and copolymers that comprise two or more structurally different glycolaldehyde dimers as monomer units, where the dimers are selected from the group consisting of 2,5-dihydroxy-1,4-dioxane; (1,2-dihydroxyethoxy) acetaldehyde; 2-(hydroxymethyl)-1,3-dioxolan-4-ol; 1, 1′-oxydi (ethane-1,2-diol); 2,2′-oxydi (ethane-1,1-diol); (1,3-dioxetane-2,4-diyl)dimethanol; and 2,2′-oxydiacetaldehyde. Methods of making polymers and copolymers by polymerization of a mixture comprising two or more glycolaldehyde dimers in the presence of a Lewis acid catalyst are also reported. A method of making polymers and copolymers and compositions containing one or more of such polymers and copolymers is reported. Copolymers containing two or more glycolaldehyde dimers are reported to have improved optical and mechanical properties. This published PCT application is incorporated by reference herein in its entirety for descriptions of polymers/copolymers and structures thereof and the polymerization method described therein.

The present invention provides polymers and copolymers, including those from renewable resources, particularly polymers and copolymers of DHDO, that exhibit higher molecular weight, specifically polymers and copolymers with weight average molecular weight (Mw) equal to or greater than 15,000 Daltons, and improved physical and mechanical properties.

### SUMMARY OF THE INVENTION

This invention provides enhanced polymerization processes, utilizing advanced Lewis Acid catalysts, improved solvent systems, and/or innovative water removal techniques to achieve higher molecular weight polymers (including homopolymers and copolymers)(Mw≥15,000 Dalton). The invention also provides improved methods for purification of polymers and co-polymers that minimize or avoid the use of water. The methods of the invention are useful in making polymers and copolymers from alpha-hydroxycarbonyl compounds, including both alpha-hydroxyaldehydes and alpha-hydoxyketones. The methods of the invention are particularly useful in making glycolaldehyde polymers and copolymers. The methods of the invention are more specifically useful in polymerization of one or more glycolaldehyde dimers. The method is of particular utility in polymerization of 2,5-dihydroxy-1,4-dioxane (DHDO). The method can also be applied to making copolymers in which one of the monomers is DHDO. The method can be specifically applied in polymerization of two or more structurally different glycolaldehyde dimers, particularly to two or more of 2,5-dihydroxy-1,4-dioxane; (1,2-dihydroxyethoxy) acetaldehyde; 2-(hydroxymethyl)-1,3-dioxolan-4-ol; 1, 1′-oxydi (ethane-1,2-diol); 2,2′-oxydi (ethane-1,1-diol); (1,3-dioxetane-2,4-diyl)dimethanol; and 2,2′-oxydiacetaldehyde. The method is generally useful for making copolymers of DHDO, particularly where DHDO represents 50 molar % or more of the copolymer. In some embodiments, the polymeric yield of the polymerization reaction is significantly enhanced. In embodiments, the yield of polymerization is 50% or more.

In other embodiments, the invention provides improved methods for making oligomers and lower molecular weight polymers and copolymers (Mw<15,000 Da) of glycolaldehyde dimers, and particularly of DHDO, with improved physical properties. In other embodiments, the invention provides improved methods for making oligomers and lower molecular weight polymers and copolymers (Mw<15,000 D) of glycolaldehyde dimers and particularly of DHDO using catalyst of lower cost or catalyst that does not contain perfluorinated substances.

In embodiments, the polymerization method involves selection of a solvent regime, a pressure regime and reaction temperature range which results in polymers and copolymers having improved physical or mechanical properties, such as increased Mw, increased tensile strength, or improved thermal stability compared to polymers prepared by prior art methods. In embodiments, the polymerization reaction is improved in that the reaction is at least partially conducted in the substantial absence of solvent (i.e., without added solvent or with less than 1% by volume of the initial volume of solvent). In embodiments, the polymerization reaction is conducted without added solvent. In embodiments, the polymerization reaction is initiated in solvent and solvent is gradually removed by application of one or more solvent removal (concentration) steps to ultimately reduce the solvent in the reaction mixture to less than 1% of the initial amount of solvent added. In embodiments, the polymerization reaction is initiated in solvent and solvent is gradually removed by application of one or more solvent removal (concentration) steps to ultimately reduce the solvent to less than 0.1% of the initial amount of solvent. In embodiments, the polymerization reaction is initiated in solvent and solvent is gradually removed by application of one or more solvent removal (concentration) steps to ultimately reduce the solvent to a level of less than 1% by weight of the initial monomers added to the reaction. In embodiments, the polymerization reaction is initiated in solvent and solvent is gradually removed by application of one or more solvent removal (concentration) steps to ultimately reduce the solvent to a level of less than 0.1% by weight of the initial monomers added to the reaction.

In embodiments, the polymerization reaction is conducted by mixing one or more monomers in solvent in the presence of catalyst and application of one or more solvent removal steps to ultimately reduce the solvent to less than 1% of the initial amount of solvent or to less than 0.1% of the initial amount of solvent, or to less than 1% by weight of the weight of monomers added to the reaction, or to less than 0.1% by weight of the weight of monomers added to the reaction.

The cost-effective and scalable method of the invention also provides polymers and copolymers having superior mechanical properties. Specifically, in embodiments, the invention provides certain polymers with Young's modulus greater than 100 kPa (kilo Pascal) and/or ultimate tensile strength (i.e., tensile strength at break) higher than 200 kPa.

The cost-effective and scalable method of the invention also provides polymers and copolymers having superior thermal properties. Specifically, in embodiments, the methods of the invention provide certain polymers with T95 (5% mass loss temperature) of 165° C. or higher. In embodiments, the methods of the invention provide certain polymers with T95 of 190° C. or higher. In embodiments, the methods of the invention provide certain polymers with T95 of 200° C. or higher. In specific embodiments, the polymers with T95 of 165° C. or higher are not end-capped. In specific embodiments, the polymers with T95 of 190° C. or higher are not end-capped. In specific embodiments, the polymers with T95 of 200° C. or higher are not end-capped.

In embodiments, the invention provides polymers that exhibit increased Mw and improved mechanical properties, such as increased Young's Modulus. In embodiments, the invention provides polymers that exhibit increased Mw and improved thermal properties, such as increased T95. In embodiments, the invention provides polymers that exhibit increased Mw, improved mechanical properties, such as increased Young's Modulus and improved thermal properties such as increased T95. In embodiments, the polymers with one or more improved properties are not-end-capped polymers. In embodiments, the polymers with one or more improved properties are PDHDO or M-PDHDO. In embodiments, the polymers with one or more improved properties are PDHDO or M-PDHDO which are not end-capped. In embodiments, the invention also provides polymers with one or more improved properties, wherein the polymers with one or more improved properties are thereafter end-capped.

The invention is directed to methods of making polymers and copolymers and the polymers and copolymers made by those methods. In embodiments, the invention provides polymers and copolymers of alpha-hydroxycarbonyl compounds, particularly of glycolaldehyde dimers and more particularly of DHDO with Mw of 15,000 Da or more. In embodiments, the invention provides polymers and copolymers of alpha-hydroxycarbonyl compounds, particularly of glycolaldehyde and more particularly of DHDO having improved mechanical properties. The invention in particular provides PDHDO or M-PDHDO with Mw of 15,000 Da or more. The invention in particular provides PDHDO or M-PDHDO with Mw of 30,000 Da or more. The invention additionally provides polymers of DHDO which have one or more improved properties which are thereafter end-capped.

### BRIEF DESCRIPTION OF THE DRAWINGS

FIG. 1 is the ¹H-NMR spectrum of the polymer product of Example 1.

FIG. 2 is the ¹H-NMR spectrum of the polymer product of Example 3.

FIGS. 3A and 3B illustrate the FT-IR spectrum of the polymer product of Example 3. FIG. 3A is the spectrum from about 4000-500 wavenumbers. FIG. 3B is an enlarged view of the spectrum between about 2800-1300 wavenumbers.

FIGS. 4A and 4B illustrate the FT-IR spectrum of the polymer product of Example 9. FIG. 4A is the spectrum from about 4000-500 wavenumbers. FIG. 4B is an enlarged view of the spectrum between about 2800-1300 wavenumbers.

FIG. 5 is the 1H-NMR spectrum of the polymer product of Example 10.

FIGS. 6A and 6B illustrate the FT-IR spectrum of the polymer product of Example 10. FIG. 6A is the spectrum from about 4000-500 wavenumbers. FIG. 6B is an enlarged view of the spectrum between about 2800-1300 wavenumbers.

FIG. 7 is the 1H-NMR spectrum of the polymer product of Example 12.

### DETAILED DESCRIPTION

The invention provides significantly improved methods for the polymerization of alpha-hydroxycarbonyl compounds (alpha-hydroxyaldehydes and alpha-hydroxyketones). More specifically, the invention provides significantly improved polymerization of glycolaldehyde dimer, which can include one or more of the following species: 2,5-dihydroxy-1,4-dioxane; (1,2-hydroxyethoxy) acetaldehyde; 2-(hydroxymethyl)-1,3-dioxolan-4-ol; 1, 1′-oxydi (ethane-1,2-diol); 2,2′-oxydi (ethane-1,1-diol); (1,3-dioxetane-2,4-diyl)dimethanol; and 2,2′-oxydiacetaldehyde). 2,5-Dihydroxy-1,4-dioxane (DHDO) is typically the most abundant glycolaldehyde dimer species. In embodiments, the improved methods of this invention deliver polymers and copolymers of higher molecular weight than provided by existing processes and preferably the Mw of the polymer or copolymer products is 15,000 Da or higher. In embodiments, the improved methods of this invention deliver polymers and copolymers where the yield of polymerization is improved and preferably the polymerization yield is 50% or higher. The major improvements in the method include the discovery of superior Lewis Acid catalysts, improved solvents or polymerization in the substantial absence of solvent, and methods of water removal to drive increased polymer growth. Additional improvements include purification methods that reduce or minimize the use/addition of water.

The methods of the invention improve upon the shortcomings of the prior art, namely the relatively low weight average molecular weight (Mw) of polymers and copolymers made using certain processes reported in US patent U.S. Pat. No. 9,040,635B1 and PCT/US2023/08495. Mw of polymers made by such prior art methods is generally lower than 15,000 Daltons (Da), which is too low to provide adequate mechanical properties for many applications, such as molded components. Further, low molecular weight polymers are difficult to transform using methods such as blow molding; if the molecular weight is too low, the plastic will be too fluid and difficult to handle, leading to poor wall thickness control and weak final product. This invention provides improved polymerization reaction conditions including the choice of Lewis Acid, solvent (type, amount, and substantial absence of solvent), and/or method of water removal under reduced pressure which has delivered numerous examples of polymers of higher molecular weight than previously disclosed and concomitant improved polymer performance. In embodiments, the invention provides polymers of improved mechanical properties in thin film form, including improved Young's modulus and improved tensile strength at break. Specifically, the invention provides certain polymers with Young's modulus higher than 100 kPa and tensile strength at break higher than 200 kPa.

The improved methods herein have also been found to produce polymers with improved thermal properties, particularly with higher T95 compared to those prepared with prior art methods. In embodiments, the invention provides polymers with T95 of 165° C. or higher. More specifically, the invention provides polymers with T95 of 165° C. or higher and which are not end-capped. In embodiments, the polymers with T95 of 165° C. or higher are PDHDO or M-PDHDO polymers. In embodiments, these polymers have T95 of 190° C. or higher or 200° C. or higher.

The polymerizations of alpha-hydroxycarbonyl compounds of this invention generate water and require removal of water to facilitate the reaction. Prior art methods report that water removal can be accomplished by refluxing reaction solvent during polymerization through a Soxhlet apparatus with dehydrating agents in the thimble. Preferred dehydrating agents include MgSO₄, Na₂SO₄, zeolites, Al₂O₃, and silica gel. Useful zeolites include 4 Å molecular sieves, 3 Å molecular sieves, zeolite 5 Å, zeolite 13X. A more preferred dehydrating agent is 3 Å molecular sieves. In embodiments, the invention provides the use of certain improved polymerization catalysts, such as aluminum triflate [Al(OTf)₃], iron (III) triflate [Fe(OTf)₃], bismuth triflate [Bi(OTf)₃] or copper (II) triflate [Cu(OTf)₂] and/or improved reaction solvent conditions, such as use of organic nitriles or ethers, including acetonitrile, propionitrile, 1,2-dimethoxyethanol, the slow removal of solvent, or the substantial absence of reaction solvent.

In embodiments, polymers and copolymers with Mw (<15,000 Da) and/or improved polymer mechanical properties and polymerization methods providing higher polymer yield, and/or lower manufacturing cost are achieved employing selected catalysts, selected solvents or both, wherein the reaction solvent is refluxed under vacuum and passed through a dehydrating agent. In embodiments, the polymerization is conducted in a reaction mixture containing a selected reaction solvent with reflux of reaction solvent through a Soxhlet apparatus with the dehydrating agent in the thimble. In this embodiment, preferred catalysts are Al₂(SO₄)₃, Al(OTS)₃, Al(OMS)₃, Al(OTf)₃, Fe₂(SO₄)₃, Fe(OTs)₃, Fe(OMs)₃, Fe(OTf)₃, Bi₂(SO₄)₃, Bi(OTS)₃, Bi(OMs)₃, Bi(OTf)₃, In₂(SO₄)₃, In(OTs)₃, In(OMs)₃, In(OTf)₃, Ga₂(SO₄)₃, Ga(OTs)₃, Ga(OMs)₃, Ga(OTf)₃, CuSO₄, Cu(OTs)₂, Cu(OMs)₂, or Cu(OTf)₂. In this embodiment, preferred solvents are alkyl nitriles, for example, MeCN or EtCN or ethers, for example, 1,2-dimethoxyethane or 1,4-dioxane. In this embodiment, pressure of the reaction during reflux is at 100 torr or less by application of vacuum. More preferably, the pressure of the reaction is at 90 torr, 80 torr, 70 torr, 60, torr, 50 torr, 40, torr, 30 torr, 20 torr, 10 torr, 5 torr or 1 torr or less. In embodiments, the pressure of the reaction is maintained using dynamic vacuum. In embodiments, the pressure of the reaction in a given reaction step is independently maintained within a range of pressures. In embodiments, the reaction pressure of a given reaction step is maintained between 1-150 torr, between 1-100 torr, between 1-50 torr, between 1-30 torr, between 1-20 torr, between 1-10 torr, between 5-20 torr, between 5-10 torr, between 1-30 torr, between 1-20 torr, between 1-10 torr, or between 0.1-1 torr. In embodiments, the reaction temperature is 35° C. or higher such that polymerization proceeds and the reaction solvent is at reflux. In embodiments, the reaction temperature is between 35 to 80° C. In embodiments, the reaction temperature is between 35 to 70° C. In embodiments, the reaction temperature is between 35 to 50° C. In embodiments, the reaction temperature is between 35 to 45° C.

In embodiments of this invention, an unexpected, improved process is provided which does not require use of a dehydrating agent and Soxhlet apparatus. This improved process encompasses running the reaction under direct vacuum to remove water along with the controlled removal of the reaction solvent over time which causes the process to: 1) begin as a polymerization in solution phase, then 2) gradually remove the solvent together with the water formed as the byproduct of the polymerization reaction until 3) the amount of solvent present is small, negligible or none and the reaction is continued under reduced pressure for a selected amount of time.

In additional embodiments of this invention, an unexpected, improved process is provided which does not require use of a dehydrating agent and Soxhlet apparatus and wherein no solvent is employed in (i.e., no solvent is added to) the reaction. This improved process encompasses running the reaction without solvent and under direct vacuum to remove water and the reaction is continued under reduced pressure for a selected amount of time. In embodiments, the reaction in the substantial absence of or the absence of added solvent is conducted under reduced pressure in a melt containing one or more monomers to be polymerized and the catalyst at a temperature where the one or more monomers are liquid (melted) and thus at a temperature at the reduced pressure where the one or more monomers are substantially in liquid form. In embodiments, the temperature of the reaction conducted in the substantial absence of or the absence of added solvent are conducted at a temperature of 100° C. or less. Preferred monomers for use in the substantial absence of solvent or in the absence of added solvent are those monomers that have melting points lower than 100° C. at the reduced pressure applied to the reaction.

The improved processes of this invention are advantageous because they reduce the cost of the equipment required to carry out the polymerization reaction with the elimination of the dehydrating agent and Soxhlet apparatus. They also allow for easier scale-up since the mass of polymer manufactured is no longer limited by the volume of the dehydrating agent. Finally, and most importantly the polymer or copolymer product obtained has increased weight average molecular weight (Mw) equal to or greater than 15,000 Da, preferably greater than 15,000 Da (15 kDa), preferably equal to or greater than 20,000 Da, more preferably equal to or greater than 25,000 Da and most preferably equal to or greater than 30,000 Da. In embodiments, the upper limit of Mw of these polymers or copolymers is 50,000 Da, 75,000 Da, 100,000 Da, 500,000 Da or 1,000,000 Da. In embodiments, the Mw of the polymers and copolymers made by certain preferred methods herein ranges from 15,000 Da to 100,000 Da, 20,000 Da to 100,000 Da, 25,000 Da to 100,000 Da, or 30,000 Da to 100,000 Da. In embodiments, the Mw of the polymers and copolymers made by certain preferred methods herein ranges from 15,000 Da to 50,000 Da, 20,000 Da to 50,000 Da, 25,000 Da to 50,000 Da, or 30,000 Da to 50,000 Da. In embodiments, the Mw of the polymers and copolymers made by certain preferred methods herein ranges from 15,000 Da to 40,000 Da, 15,000 Da to 35,000 Da, 15,000 Da to 25,000 Da, or 15,000 Da to 30,000 Da.

The weight average molecular weight (Mw) is determined by Gel Permeation Chromatography (GPC) using a refractive index detector coupled with data collection software. Molecular weights (Mw, Mn, Mz) and the distribution of polymers are determined based on a calibration curve with monodisperse polymer standards of known molecular weight. Molecular weight determination by GPC analysis is well-known in the art. However, other methods for measurement of Mw, Mn and Mz can be employed to characterized polymers prepared by methods of this invention.

Polydispersity index (PDI) is a measure of the breadth of molecular weight distribution in a polymer. PDI (also designated molar-mass dispersity) is calculated as the ratio of weight average molecular weight (Mw) to the number average molecular weight (Mn), i.e. Mw/Mn. A PDI of 1 (its lowest value) indicates that all polymers have the same chain length. PDI of synthetic polymers generally varies dependent upon the mechanism of the polymerization reaction and upon the reaction conditions and most often is greater than 1. Most often, PDI ranges up to 20. Uniformity of polymer properties generally increases with decreasing PDI. In embodiments, the methods herein provide polymers with PDI less than 10 and more preferably less than 5. In specific embodiments, methods herein provide polymers with PDI of less than 3, less than 2.5 or less than 2.

In embodiments, the solvent regime of the reaction is selected to increase Mw of the resultant polymers and copolymers. The term solvent regime refers to the type, and amount of solvent present during the reaction. Solvent regime includes choice of solvent, amount of solvent, change in amount of solvent over time, absence of solvent, as well as application of vacuum to remove water, or to remove solvent and water, or to continue to remove water after solvent is depleted. In embodiments, solvent regime includes conducting the polymerization reaction substantially without solvent for at least a portion of the reaction time. In embodiments, the polymerization reaction is conducted substantially without solvent for 30 min, or more. In embodiments, the polymerization reaction is conducted substantially without solvent for 60 min, or more. In embodiments, the polymerization reaction is conducted substantially without solvent for 90 min, or more. In embodiments, the polymerization reaction is conducted substantially without solvent for at most 24 h, at most 18 h., at most 12 h, at most 6 h, or at most 90 min. In embodiments, the reaction time in the substantial absence of solvent is selected to maximize the Mw of the polymer produce and to minimize decomposition of monomers. In embodiments, the polymerization reaction is conducted substantially without solvent for 15 min to 24 h, or preferably for 30 min to 6 h, or more preferably for 30 min to 90 min.

In embodiments, the solvent regime includes conducting the polymerization without addition of solvent (i.e., in the absence of solvent). In embodiments, the solvent regime involves a step of initially conducting the polymerization reaction in solvent, followed by one or more steps of concentrating the reaction mixture to remove solvent. In embodiments, a selected amount of the solvent added is removed. In embodiments, 50%, 60%, 70%, 80%, 90%, 95%, 99% or more of the solvent is removed in one or more concentration steps. In embodiments, the solvent remaining after one or more concentration steps is less than 1% or less than 0.1% of the original volume of solvent. In embodiments, the amount of solvent remaining after one or more concentration steps is less than 1% by weight or less than 0.1% by weight of the weight of monomers added to the reaction. In embodiments, the reaction is concentrated by application of vacuum to generate a sub-ambient reaction pressure. Application of vacuum can be in one or more steps wherein the reaction pressure is the same or different in each step. In embodiments, when the reaction is conducted without solvent, vacuum is applied to generate sub-ambient reaction pressure and remove water generated during reaction. In embodiments, the level of vacuum applied to the reaction can be varied over the course of the reaction to change the reaction pressure. In embodiments, the level of vacuum can be increased as the polymerization without solvent proceeds.

In embodiments, the pressure regime under which the polymerization reaction is conducted is selected to increase Mw of the resultant polymers and copolymers. The pressure regime relates to pressure or pressures or a range of pressures at which the reaction is conducted which include ambient pressure (atmospheric pressure dependent upon altitude) at which reaction is conducted, the application of vacuum to a reaction mixture (i.e., sub-atmospheric or sub-ambient pressure), which may be employed to induce solvent reflux or evaporation of solvent and/or water over the course of the reaction. A constant or varying level of vacuum may be applied to the reaction. Dynamic vacuum may be applied to the reaction. A constant or varying level of vacuum may be applied for a selected time to the reaction mixture. A constant or varying level of vacuum may be applied to the reaction to control removal of solvent and water from the reaction. A constant or varying level of vacuum may be applied to the reaction where there is no solvent present or where solvent has already been removed to facilitate removal of water formed on polymerization.

It will be apparent to one of ordinary skill in the art that the pressure regime employed during polymerization can affect the solvent regime of the reaction. It will also be apparent that the temperature or temperatures at which the reaction is conducted can be affected by the solvent regime and the pressure regime of the reaction. In embodiments, temperature of the reaction can also be varied dependent upon the solvent regime and pressure regime applied to increase the Mw of the resultant polymers and copolymers.

The level of vacuum applied determines the pressure of the reaction and is measured herein in units of pressure, specifically in torr, where at sea level, normal atmospheric pressure is defined as 760 torr. As is known in the art, atmospheric pressure changes with altitude (atmospheric pressure at 5,000 ft above sea level is, for example, about 630 torr). Ambient atmospheric pressure is the atmospheric pressure at a given altitude and temperature. Vacuum when applied to polymerization reactions herein generates sub-atmospheric and more specifically sub-ambient pressures in the reaction. In embodiments, vacuum applied to reactions herein results in a pressure that is less than 200 torr and preferably is equal to or less than 150 torr. In embodiments, reaction pressure is equal to or less than 100 torr, or equal to or less than 50 torr, or equal to or less than 30 torr, or equal to or less than 10 torr, or equal to or less than 1 torr. As discussed herein, the reaction pressure can be changed over the course of the reaction to improve product Mw or to improve product polymer yield.

In embodiments, the polymerization reaction and independently any step of the reaction is optionally conducted under an atmosphere that excludes oxygen, e.g., under N₂, or an inert atmosphere, such as Ar. In embodiments, the polymerization reaction is conducted to minimize or avoid the presence of water.

In embodiments, the reaction solvent is a volatile alkyl nitrile including acetonitrile, propionitrile, butyronitrile, valeronitrile, isovaleronitrile, pentanonitrile, hexanenitrile, e.g., R_{A}—CN, where R_{A} is a straight-chain or branched alkyl group having 1-8 carbon atoms and preferably having 1-6 or 1-3 carbon atoms. In embodiments, the reaction solvent is an ether, including a dialkoxyalkyl ether, e.g., R_{E}—O—(CH₂)ₚ—OR_{E}, where R_{E} is a straight-chain or branched alkyl group having 1-6 carbon atoms, preferably having 1-3 carbon atoms and p is an integer ranging from 1 to 6, and preferably 1-3. In embodiments, the solvent is 1,2-dimethoxyethane. In embodiments the solvent is a cyclic ether. In embodiments the solvent is 1,4-dioxane. In embodiments, the boiling point of the solvent is less than 110° C. at 1 atm. In embodiments, the boiling point of the solvent is less than 100° C. at the lowest pressure applied to the polymerization reaction.

In embodiments, the solvent has a boiling point of greater than 35° C. at pressures of 100 torr or less. In embodiments, the solvent has a boiling point of greater than 35° C. at pressures of 50 torr or less. In embodiments, the solvent has a boiling point of greater than 35° C. at pressures of 30 torr or less. In embodiments, the solvent has a boiling point of greater than 35° C. at pressures of 10 torr or less. In embodiments, the solvent has a boiling point of greater than 35° C. at pressures of 1 torr or less. In embodiments, the solvent has a boiling point of greater than 35° C. and less than 80° C. at pressures of 100 torr or less. In embodiments, the solvent has a boiling point of greater than 35° C. and less than 80° C. at pressures of 50 torr or less. In embodiments, the solvent has a boiling point of greater than 35° C. and less than 80° C. at pressures of 30 torr or less. In embodiments, the solvent has a boiling point of greater than 35° C. and less than 80° C. at pressures of 10 torr or less. In embodiments, the solvent has a boiling point of greater than 35° C. and less than 80° C. at pressures of 1 torr or less.

In embodiments, the reaction pressure is maintained at a selected pressure by application of a dynamic vacuum. Dynamic vacuum is an at least periodically maintained vacuum environment, where the pressure is actively adjusted to a selected pressure and monitored throughout a chemical reaction to maintain that selected pressure. In embodiments, dynamic vacuum is maintained on a selected time scale of seconds, or minutes or tens of minutes. In embodiments, dynamic vacuum is continuously maintained. In embodiments, dynamic vacuum is applied to remove water vapor generated by the polymerization reaction. In embodiments, dynamic vacuum is applied to a reaction mixture without added reaction solvent. In embodiments, dynamic vacuum is applied to a reaction mixture having added rection solvent. In embodiments, dynamic vacuum is applied to remove reaction solvent and water vapor generated by the polymerization reaction.

In specific embodiments, the polymerization reaction is carried out in the presence of a Lewis acid catalyst in an ether solvent, particularly 1,2-dimethoxyethane, or a cyclic ether solvent, particularly 1,4-dioxane. The reaction is carried out at an initial temperature ranging from 35° C. to 55° C. under sub-ambient pressure, preferably with reflux of solvent, for a first selected time. The first selected time can range from 1 h to 19 h, or more preferably from 1 h to 6 hr or from 1 h to 2 h. Solvent is gradually removed over this first selected time, optionally with application of full vacuum (for example, a pressure of 10 torr or less, or 1 torr or less). After removal of solvent, the reaction temperature is optionally increased to a second higher temperature of 50° C. to 75° C. and the reaction is carried out for a second selected time. In embodiments, the second reaction time ranges from 2 h to 19 h. In embodiments, the total reaction time ranges from 1 h to 24 h. In embodiments, the catalyst employed are Al(III) or Cu(II) Lewis Acid catalysts, and in particular are triflates, methane sulfonates, or tosylates of Cu(II) or Al(III). In embodiments, the catalysts are Cu(OTf)₂ or Al(OTf)₃. In embodiments, the polymerization reaction results in a polymer having Mw greater than 30,000 Da and more specifically greater than 40,000 Da.

In embodiments, the polymerization is conducted in a selected solvent at a selected concentration of monomer (or a total concentration of one or more different monomers) with added catalyst and the reaction is run with agitation at a selected first temperature for a selected first reaction time at a first selected pressure. In other embodiments, the polymerization reaction is conducted at more than one temperature, at one or more pressures or both. In other embodiments, the polymerization is conducted in a selected solvent at a selected concentration of monomer (or a total concentration of one or more different monomers) with added catalyst and the reaction is run with agitation at a selected first temperature for a selected first reaction time at a first selected pressure. Thereafter the pressure is reduced to a second lower pressure at a second temperature (which may be same as the first temperature or a changed temperature), with agitation or without agitation, for a selected second time to remove water and/or solvent until a selected amount of solvent remains. Thereafter the reaction is optionally held at the second temperature and second pressure and reduced amount of solvent, with or without agitation, for a selected third time. Alternatively, the reaction is optionally held at a third temperature (which may be the same as the second temperature) and a third pressure (which may be the same as the second pressure), with or without agitation, for a selected third time. In an embodiment, the selected catalyst is provided in the reaction in a catalytic amount with respect to monomer (e.g., 0.05 equivalent with respect to monomer). The solvent, pressures, temperatures and reaction times being selected to provide polymers or copolymers of Mw equal to or greater than 15,000 Da and optionally to provide polymerization yield of 50% or more.

In other embodiments, the solvent, pressures, temperatures and reaction times are selected to provide polymers or copolymers having desired mechanical or thermal properties that are improved over polymers or copolymers prepared by prior art methods. In specific embodiments, the solvent, pressures, temperatures and reaction times are selected to provide polymers or copolymers having

In embodiments, the concentration of monomer in solvent ranges from 0.1 to 10 M. In embodiments, the first, second and third pressures are 150 torr or less. In embodiments, the first pressure is 150 torr or less. In embodiments, the second pressure is 20% or more less than first pressure. In embodiments, the second pressure is 30% or more less than the first pressure. In embodiments, the second pressure is 50% or more less than the first pressure. In embodiments, the third pressure is the same as the second pressure. In embodiments, the third pressure is 20%, 30%, 40% or 50% or more less than the second pressure. In embodiments, the first time period ranges from 0.1 to 10 hours. In embodiments, the second time period ranges from 0.1 hour until the selected amount of solvent is removed. In an embodiments, the amount of solvent remaining after one or more solvent removal (concentration) steps is 10% or less, 5% or less, 1% or less, 0.5% or less, or 0.1% or less of the original solvent volume. In embodiments, the amount of solvent remaining after one or more solvent removal steps is less than 1%, or less than 0.5% or less than 0.1% by weight of the monomers added to the reaction. In embodiments, the second time period ranges from 0.1 to 10 hours. In embodiments, the third time period ranges from 0.1 until no additional polymerization is detected, for example, from 0.1 to 48 hours. In embodiments, the first, second and third reaction temperature range from 30° C. to 75° C. In embodiments, the first, second and third reaction temperatures range from 35° C. to 50° C. In embodiments, the first, second and third reaction temperatures are the same+/−10%. In embodiments, the first, second and third reactions temperatures are at the boiling point+/−10% of the selected solvent at the first, second or third pressures, respectively. In embodiments, the concentration of monomers in the selected solvent ranges from 0.1 to 1 M. In embodiments, the concentration of monomers in the selected solvent ranges from 0.1 to 0.5 M. In embodiments, the monomers are soluble in the selected solvent at least up to the selected monomer concentration.

In a more specific embodiment, the polymerization begins with one or more monomer in a selected solvent at a concentration from 0.1M to 10 M with added catalyst and the reaction is run with agitation at a pressure ranging from 1 to 150 torr (a first pressure, which is sub-atmospheric/sub-ambient) by application of a vacuum. After a period of 0.1 hours to 10 hours (first reaction time), the pressure is decreased to a lower pressure (second pressure) between 1 and 120 torr, or between 1 and 105 torr, or between 1 and 75 torr with agitation to gradually remove the solvent and water over a period ranging from 0.1 h to 10 hrs (second reaction time) during which time the amount of solvent in the reaction decreases gradually to less than 10%, less than 5% or less than 1% or preferably less than 0.1% of the original volume. In embodiments, the amount of solvent remaining after one or more solvent removal steps is less than 1%, or less than 0.5% or less than 0.1% by weight of the monomers added to the reaction. The reaction is then held, with or without agitation, at that minimal solvent amount at the lower pressure for a period ranging from 0.1 h to 48 hours. In embodiments, the polymerization is run at a temperature ranging from 30° C. to 80° C. In embodiments, the polymerization is run at a temperature where the solvent is at reflux at the reaction pressure. In embodiments, the polymerization is run at a temperature and a pressure where the solvent is at reflux. In embodiments, the second pressure is 30% or more lower than the first pressure. In embodiments, the second pressure is 50% or more lower than the first pressure. In embodiments, the reaction is maintained at the same temperature throughout the reaction. In embodiments, selected catalyst is added at a catalytic amount with respect to monomer.

In another specific embodiment, the polymerization begins with one or more monomer in a selected solvent at a monomer concentration ranging from 0.1M to 1.4 M with added catalyst and the reaction is run with agitation at a pressure ranging from 10 to 100 torr. After a period of 0.1 h to 3 h the pressure is decreased to a lower pressure less than 100 torr to gradually remove the solvent over a period ranging from 0.1 h to 4 h, with or without agitation, during which time the solvent amount decreases gradually to less than 10%, less than 5%, preferably less than 1% or more preferably less than 0.1% of the original solvent volume. In embodiments, the amount of solvent remaining is less than 1% or more preferably less than 0.1% by weight of the weight of monomers added to the reaction. The reaction is then held either with or without agitation at that minimal solvent amount for a period ranging from 3 h to 24 hours. In an embodiment, the polymerization is run at a temperature ranging from 30° C. to 80° C. In embodiments, the polymerization is run at a temperature where the solvent is at reflux at the reaction pressure. In embodiments, the polymerization is run at a temperature and a pressure where the solvent is at reflux. In embodiments, the second pressure is 30% or more lower than the first pressure. In embodiments, the second pressure is 50% or more lower than the first pressure. In embodiments, the reaction is maintained at the same temperature throughout the reaction. In embodiments, selected catalyst is added at a catalytic amount with respect to monomer.

In a preferred embodiment, the polymerization begins with one or more monomer in a selected solvent concentration from 0.3 M to 0.7 M with added catalyst (at a catalytic amount) and the reaction is run with agitation at a first pressure ranging from 10 to 30 torr. Then over a period of 0.1 hours to 0.5 hours, with or without agitation, the pressure is decreased to less than 30 torr, more specifically between 1 and 30 torr, to gradually remove the solvent over a period ranging from 1 h to 3 h during which time the solvent amount decreases gradually to less than, 10%, less than 5%, preferably less than 1% or more preferably less than 0.1% of the original volume. In embodiments, the amount of solvent remaining after one or more solvent removal steps is less than 1%, or less than 0.5%, or less than 0.1% by weight of the monomers added to the reaction. The reaction is then held (with or without agitation) at that minimal solvent amount for a period ranging from 1 hour to 20 hours. In an embodiment, the polymerization is run at a temperature ranging from 30° C. to 80° C. In embodiments, the polymerization is run at a temperature where the solvent is at reflux at the reaction pressure. In embodiments, the polymerization is run at a temperature and a pressure where the solvent is at reflux. In embodiments, the second pressure is 30% or more lower than the first pressure. In embodiments, the second pressure is 50% or more lower than the first pressure. In embodiments, the reaction is maintained at the same temperature throughout the reaction. In embodiments, selected catalyst is added at a catalytic amount with respect to monomer.

The method of this invention also includes another preferred embodiment, where solvent removal occurs in two or more steps where the one or more monomer are initially in selected solvent at a concertation between 0.1 M and 10 M with added catalyst at ambient pressure and then reaction is held at that monomer concentration in solvent with or without agitation for a time ranging from 0.1 to 24 h. Thereafter the reaction is concentrated under application of high vacuum (i.e., applying a vacuum of 1 torr or less) with agitation to remove solvent to a monomer concentration ranging between 0.2 M and 5 M over a period of 0.1 h to 24 h. In embodiments, the monomer concentration is decreased in a first concentration step by 20 to 80% by removal of solvent. In embodiments, the monomer concentration is decreased 40 to 60% by removal of solvent. In embodiments, the monomer concentration is decreased 50%+/−10% by removal of solvent. The reaction is then first held (with or without agitation) at that decreased monomer concentration for a period between 0.1 h to 24 h and then the reaction is again concentrated by removal of solvent under high vacuum with or without agitation until there is no visible solvent remaining in the flask. This second concentration step occurs over a period of 0.1 hours to 24 hours. The reaction is then held in a second holding step (with or without agitation) in the absence of visible solvent for an additional period of 0.1 hours to 24 hours. Preferably the amount of solvent remaining is less than 1% by weight or more preferably less than 0.1% by weight of the monomers added to the reaction. In an embodiment, the polymerization is run at a temperature ranging from 30° C. to 80° C. In embodiments, the reaction is maintained at the same temperature throughout the reaction. In embodiments, the first concentration step can be conducted in two or more intermediate concentration steps to achieve the selected decreased monomer concentration (solvent removal) and at each additional concentration step, an intermediate holding step can be employed. In embodiments, selected catalyst is added at a catalytic amount with respect to monomer.

In another preferred embodiment, the invention provides a method in which one or more monomer and a selected catalyst are combined in the absence of solvent and heated with or without agitation under sub-ambient vacuum, preferably 10 torr or less and more preferably 1 torr or less, at a temperature ranging from −78° C. to 150° C. dependent upon the monomer(s), catalyst and reaction pressure for a period ranging from 0.1 h to 24 hours. In a more preferred embodiment, the monomer and a catalyst are combined in the absence of solvent, with or without agitation, and heated under sub-ambient vacuum, preferably 10 torr or less and more preferably 1 torr or less, at a temperature ranging from 40° C. to 100° C. for a period ranging from 0.1 h to 12 hours. In a more preferred procedure, the monomer and a catalyst are combined in the absence of solvent and heated under sub-ambient vacuum, preferably 10 torr or less and more preferably 1 torr or less, at a temperature ranging from 50° C. to 80° C., with or without agitation, for a period ranging from 0.1 h to 2 hours. Selected catalyst is added at a catalytic amount. In embodiments, sub-ambient vacuum is high vacuum of less than 1 torr. In embodiments, dynamic vacuum is applied.

The invention also provides a method where solvent removal from a reaction mixture containing one or more monomer with added catalyst, as described in embodiments herein, is used in combination with one or more dehydrating agents (e.g., MgSO₄, Na₂SO₄, zeolites, Al₂O₃, and/or silica gel). Useful zeolites include 4 Å molecular sieves, 3 Å molecular sieves, zeolite 5A, zeolite 13X. A more preferred dehydrating agent is 3 Å molecular sieves. In an embodiment, solvent is refluxed under a selected sub-ambient pressure, refluxed solvent is contacted with dehydrating agent to remove entrained water and returned to the reaction. In embodiments, solvent is refluxed under a selected sub-ambient pressure, refluxed solvent is contacted with dehydrating agent to remove entrained water and returned to the reaction and over time solvent is gradually removed by controlled solvent evaporation. In embodiments, solvent is refluxed under a selected sub-ambient pressure, refluxed solvent is contacted with dehydrating agent to remove entrained water and over time solvent is gradually removed by controlled solvent evaporation. Solvent evaporation is controlled, for example, by increasing the applied vacuum (i.e., decreasing pressure of the reaction) and/or by increasing reaction temperature. Solvent evaporation from the reaction can also be controlled by decreasing the length of any reflux column employed or adjusting (e.g., increasing) the temperature of cooling liquid (water) in the reflux column (normally at 15 to 25° C.). In embodiments, any combination of such solvent evaporation control methods can be employed. In embodiments, solvent removal is over a period of time ranging from 0.5 (30 min) to 24 h, or a period ranging from 1 to 18 h or a period ranging from 1 to 12 h or a period ranging from 1-6 h. In embodiments, sub-ambient pressure is less than 150 torr. In embodiments, sub-ambient pressure is less than 100 torr, or less than 50 torr or less than 30 torr, or less than 10 torr. In embodiments, sub-ambient pressure is less than 1 torr. In embodiments, dynamic vacuum is applied to obtain selected sub-ambient pressure. In embodiments, starting concentration of monomers in selected solvent ranges from 0.1 M to 10 M. In embodiments, starting concentration of monomers in selected solvent ranges from 0.1 M to 1 M. In embodiments, starting concentration of monomers in selected solvent ranges from 0.1 M to 0.5 M. In embodiments, catalyst is provided at a catalytic level.

This invention also encompasses a procedure where the reaction of one or more monomers in the presence of catalyst is carried out in the absence of solvent and where the reaction is under sub-ambient pressure by application of vacuum to remove water and in the presence of one or more dehydrating agents, e.g., MgSO₄, Na₂SO₄, zeolites, Al₂O₃, and/or silica gel. Useful zeolites include 4 Å molecular sieves, 3 Å molecular sieves, zeolite 5 Å, zeolite 13X. A more preferred dehydrating agent is 3 Å molecular sieves. In embodiments, water vapor removed from the reaction by applications of vacuum is contacted with one or more dehydrating agents, In embodiments, high vacuum (less than 1 torr) is applied. In embodiments, the reaction pressure is 500 torr or less. In embodiments, the reaction pressure is 150 torr or less, 100 torr or less, 50 torr or less or 30 torr or less. In embodiments, the reaction temperature ranges from −78° C. to 150° C. dependent upon the monomer(s), catalyst and reaction pressure. In embodiments, the reaction temperature ranges from 35 to 100° C. In embodiments, the reaction temperature ranges from 35 to 80° C. In embodiments, the reaction temperature ranges from 35 to 50° C. In embodiments, the selected catalyst is provided in a catalytic amount with respect to the monomer(s). In embodiments, the reaction is conducted for 0.1 to 48 h. In embodiments, the reaction is conducted from 1 to 24 h. In embodiments, the reaction is conducted from 1-18 h. In embodiments, the reaction is conducted for 1-12 h. In embodiments, the reaction is conducted for 1-6 h.

In embodiments, the reaction components (one or more monomers) and catalyst are added to selected solvent in any order or at the same time. In embodiments, catalyst is added to the solvent prior to addition of the one or more monomers. In embodiments, the one or more monomers are added to solvent prior to addition of the catalyst.

In embodiments, in a first polymerization step the one or more monomers and a first catalyst are added to a first solvent at a first reaction temperature for a selected first reaction time and in a second polymerization step following the first step, the remaining reactants and products of the first reaction step are added to a second solvent with a second catalyst for a selected second reaction time. In an embodiment, the first and second solvent are the same and the first polymerization step is conducted with a first catalyst at a first reaction temperature and the second polymerization step is conducted with a second catalyst at a second reaction temperature. In embodiments, the first catalyst is a weaker Lewis acid catalyst, as defined herein, than the second Lewis acid catalyst.

A weak Lewis acid catalyst has limited electron-pair accepting ability and thus forms less stable adducts, while a strong Lewis acid catalyst readily accepts electron pairs, forming more stable and strongly bound adducts that significantly accelerate catalytic reactions. In embodiments, the second reaction temperature is lower than the first reaction temperature. In embodiments, the first catalyst is a sulfate, for example, aluminum sulfate (Al₂ (SO₄)₃), gallium sulfate, indium sulfate (weaker Lewis acid catalyst) and the second catalyst is a triflate, a methane sulfonate, or a tosylate, for example, a triflate, methane sulfonate or tosylate of aluminum or copper 9a stronger Lewis acid catalyst). In embodiments, the first temperature ranges from 50 to 80° C. and the second temperature is a lower temperature ranging from 35 to 55° C.

In embodiments, where no solvent is employed, the catalyst can be added to the one or more monomers. In embodiments where no solvent is employed, the one or more monomers can be heated to a selected temperature between 35-150° C. prior to addition of the catalyst. In embodiments where no solvent is employed, a first catalyst can be added to the one or more monomers, the reaction can be heated to a first temperature for a selected first reaction time and thereafter a second catalyst can be added to the reaction at a second temperature for a second reaction time. In embodiments, the first catalyst is a weaker Lewis acid catalyst, as defined herein, than the second Lewis acid catalyst. In embodiments, the second reaction temperature is lower than the first reaction temperature. In embodiments, the first catalyst is a sulfate, for example, aluminum sulfate (Al₂ (SO₄)₃), indium sulfate, copper sulfate, ytterbium sulfate, gallium sulfate and the second catalyst is a triflate, a methane sulfonate, or a tosylate, for example, a triflate, methane sulfonate or tosylate of aluminum or copper. In embodiments, the first temperature ranges from 50 to 80° C. and the second temperature is a lower temperature ranging from 35 to 55° C. . . .

In embodiments, when the polymerization is conducted without solvent, with a stronger Lewis acid catalyst (e.g., a triflate, methane sulfonate or tosylate) and the reaction is conducted at a temperature higher than 50° C. (e.g., ranging from 50° C. to 80° C.), the amount of catalyst added is between 0.1 mol % and 0.5 mol %, or more preferably between 0.2 mol % and 0.4 mol %. In embodiments, when the polymerization is conducted without solvent, with a weaker Lewis acid catalyst (e.g., a sulfate) at a temperature higher than 50° C. (e.g., ranging from 50° C. to 80° C.), the amount of catalyst added is between 0.6 mol % and 1.5 mol %, or more preferably between 0.8 mol % and 1.2 mol %.

Generally, total reaction time and the time of each step of the reaction is adapted to provide for increased polymer length. In embodiments, the total reaction time is such that the polymer or copolymer product exhibits Mw of 15,000 Da or more. Solvent removal steps are conducted as indicated until a certain decrease in solvent level is achieved.

Uniform mixing of reactants is generally preferred. However, reactions of this invention can generally be conducted with or without agitation. Agitation when applicant can be any form of magnetic, electromechanical or mechanical mixing appropriate for the reaction components. One of ordinary skill in the art can select agitation appropriate for the various steps of the reactions herein.

In embodiments, the improved polymerization methods of this invention can be applied to any alpha-hydroxycarboxylate monomer. In embodiments, the improved polymerization methods of this invention can be applied to any monomer or combination of monomers as described in U.S. Pat. No. 9,040,635, or International application PCT/US2023/084958, which are each incorporated by reference herein in its entirety for descriptions of such useful monomers. In embodiments, at least one of the one or more monomers is an alpha-hydroxycarboxylate. In embodiments, at least one of the one or more monomers is a glycolaldehyde dimer. In embodiments, at least one of the one or more monomers is 2,5-dihydroxy-1,4-dioxane. In embodiments, the one or more monomers include one or more structurally different glycolaldehyde dimer. In embodiments, the one or more monomers include one or more structurally different glycolaldehyde dimer wherein one or the monomers is 2,5-dihydroxy-1,4-dioxane (DHDO). In embodiments, copolymers prepared by the improved methods of the invention include those that comprise two or more structurally different glycolaldehyde dimers as monomer units. In embodiments, copolymers prepared by the improved methods of the invention include those that comprise two or more structurally different glycolaldehyde dimers as monomer units and where one of the monomers is DHDO. In embodiments, copolymers prepared by the methods of this invention comprise 50% or more of DHDO monomer units. In embodiments, copolymers prepared by the methods of this invention comprise 60%, 70%, 80%, 90%, 95% or 99% or more of DHDO monomer units.

In embodiments, the invention provides polymers and copolymers having monomer units as described herein having Mw of 15,000 Da or more. In embodiments, the invention provides films and in particular free-standing films comprising one or more polymers or copolymers of the invention. In embodiments, the invention provides films and in particular free-standing films comprising one or more polymers or copolymers of the invention having MW of 15,000 Da or more. In embodiments, the invention provides films and in particular free-standing films comprising one or more polymers or copolymers of the invention prepared by the methods of this invention. In embodiments, the invention provides films and in particular free-standing films comprising one or more polymers or copolymers of the invention having Mw of 15,000 Da or more and which are prepared by the methods of this invention. In embodiments, the polymer or copolymers of the invention comprise. In embodiments, films prepared with polymers and copolymers of the invention have thickness ranging from 1 micron to 10 millimeters. Preferred films have thickness between 0.1 mm and 10 mm.

In embodiments, the improved polymerization methods of this invention and in particular the polymerization of 2,5-dihydroxy-1,4-dioxane (DHDO) is carried out in the presence of a Lewis acid. Lewis acids of this invention encompass salts of aluminum, iron, copper, silver, nickel, lutetium, indium, bismuth, samarium, ytterbium, yttrium, erbium, thulium. Salts include chlorides, bromides, fluorides, iodides, sulfates, nitrates, phosphates, alkylsulfonates, aryl sulfonates, and sulfonamides. In some embodiments trifluoromethanesulfonate salts (OTf), methanesulfonate salts, benzylsulfonate or tosylate salts (OTs) are used. Preferred Lewis acids of this invention are anhydrous and contain no water molecules in their crystal structure. Useful Lewis acids include Er(OTf)₃, Tm(OTf)₃, Lu(OTf)₃, Sm(OTf)₃, Bi(OTf)₃, Al₂(SO₄)₃, Fe(OTs)₃ and Cu(OTs)₂. More preferred Lewis acids are Yb(OTf)₃, Cu(OTf)₂, and In(OTf)₃. Even more preferred Lewis acid catalysts are Al(OTf)₃, Fe(OTs)₃, and Bi(OTf)₃.

Embodiments of this invention provide improved catalysts that are capable of producing polymer of weight average molecular weight (Mw) equal to or greater than 15,000 Dalton, whether the reaction is carried out in solution, or under gradual solvent removal or in the absence of solvents. These improved catalysts include aluminum salts, bismuth salts, copper salts, iron salts, ytterbium salts, gallium salts and indium salts. Preferred catalysts are aluminum salts, bismuth salts, and iron salts.

Useful catalysts, particularly for use in reactions in the substantial absence of solvent, include trifluoromethanesulfonate salts (OTf), methanesulfonate salts, benzylsulfonate or tosylate salts of aluminum, bismuth or iron (III). Useful catalyst also include trifluoromethanesulfonate salts (OTf), methanesulfonate salts, benzylsulfonate or tosylate salts of copper, gallium or indium. Useful catalysts also include chloride, bromide, nitrate or acetate salts of aluminum, bismuth, or iron (III). Useful catalysts also include chloride, bromide, nitrate or acetate salts of copper. Useful catalysts include among others Al(OTf)₃, Al(OMS)₃, Fe(OTs)₃, Cu(OTf)₂, Cu(OMS)₂, CuCl₂, CuSO₄, Ga(OTf)₃, In(OTf)₃, and Yb(OTf)₃.

In preferred embodiments catalysts that are made of elements that are abundant in the Earth Curst and are economically priced and exhibit high performance for polymerization of DHDO, such as those that exhibit improved yield, increased Mw or improved polymer purity. Aluminum, iron and copper salts are preferred due to their high performance and lower cost. In contrast, prior art methods indicated that rare-earth elements such as scandium and lanthanum were preferred.

A range of catalyst loading can be used ranging from 0.01 mol % to 20 mol % loading with respect to monomer. Preferably catalyst loading is less that stoichiometric with respect to monomer in the reaction. Preferably, the amount of catalyst employed is a catalytic amount which is less than 1 mol %. Preferred catalyst loading ranges from 0.01 to 10 mol % loading. In embodiments, catalyst loading ranges from 0.5 to 5 mol %. In embodiments, catalyst loading ranges from 0.1 to 1 mol %. In embodiments, catalyst loading ranges from 0.2 to 0.6 mol %.

In embodiments, the polymerization reaction of this invention employs certain Lewis acid catalysts in catalytic amounts, i.e., 5 mol % or less (with respect to monomer) and preferably 1 mol % or less. In specific embodiments, when a strong Lewis acid is employed the amount of catalyst is 0.1 mol % to 0.6 mol % or more preferably from 0.2 mol % to 0.4 mol %. In specific embodiments, when a weak Lewis acid is employed the amount of catalyst is 0.5 mol % to 1.5 mol % or more preferably from 0.8 mol % to 1.2 mol %. Polymerization of DHDO can be conducted by activation of at least a portion of the OH groups in the monomer, e.g., by reaction with stoichiometric amounts (with respect to monomer) of trimethylsilyltrifluorosulfonate. Polymerization using such activators is not cost-effective because it requires stoichiometric amounts of the OH group activator and as such is not employed in the polymerizations of this invention. In embodiments, stoichiometric amounts of such OH group activators are not employed in the polymerizations of this invention. In embodiments, stoichiometric amounts of trialkylsilyltrifluoromethane sulfonates are not used in the polymerization reactions. In embodiments, stoichiometric amounts of trimethylsilyltrifluoromethanesulfonate are not used in the polymerization reaction. In embodiments, no iodo donors, no Schmidt donors, no trichloroacetimidate donors are added to the reaction. In embodiments, no trialkylsilyltrifluoromethanesulfonate is added to the reaction. In embodiments, no trimethylsilyltrifluoromethanesulfonate is added to the reaction.

The polymerization method of this invention and in particular as applied to polymerizations of DHDO can be carried out at reduced pressure by application of vacuum. Most generally, pressure of the reaction can be atmospheric, ambient, sub-atmospheric or sub-ambient. Sub-atmospheric pressure ranges from less than 760 torr to high vacuum (low pressure) of less than 1 torr. In embodiments, reaction pressure is 200 torr or less, 150 torr or less, 100 torr or less, 80 torr or less, 50 torr or less, 30 torr or less, 10 torr or less, or 1 torr or less, or less than 1 torr. In embodiments, reaction pressure ranges from 10 to 200 torr. In embodiments, reaction pressure ranges from 30 to 105 torr. In embodiments, reaction pressure is obtained using a full high vacuum (unregulated) pressure ranging from roughly 1 to 10 torr. In embodiments, reaction pressure is obtained by application of high vacuum and the reaction pressure is 1 torr or less. In embodiments, reaction pressure, particularly sub-ambient pressure, is obtained by application of regulated (controlled) vacuum. In embodiments, sub-ambient reaction pressure is obtained by application of monitored and regulated vacuum. In embodiments, sub-ambient reaction pressure is obtained employing dynamic vacuum. In embodiments, application of vacuum does not expose the reaction to water vapor and as such use of a water aspirator is not preferred.

The polymerization of this invention, particularly with DHDO as a monomer, can be carried out in various organic solvents and miscible mixtures of such solvents. Useful solvents and/or cosolvents include polar solvents such as nitriles, ethers, amides, nitro derivatives, alcohols, glycols, and halogenated solvents. Examples of useful solvents include acetone, acetonitrile, propionitrile, benzonitrile, methoxypropionitrile, dimethyl sulfoxide, dimethylformamide, dimethylacetamide, tetrahydrofuran, methyl tetrahydrofuran, dioxane, dichloromethane, dichloroethane, chloroform, ethyl acetate, ethylene carbonate, propylene carbonate, 1,4-dioxane, nitromethane, nitroethane, nitrobenzene, sulfolane, hexamethylphosphoramide, N-methylpyrrolidone, trifluorotoluene, methyl tert-butyl ether, dimethoxyethane, γ-butyrolactone, tetramethylene sulfone, carbon disulfide, methanol, ethanol, isopropanol, hexafluoro isopropanol, 2-methoxy ethanol, ethylene glycol, diethylene glycol, propylene glycol, and miscible mixtures of such solvents. Preferred solvents include acetonitrile, propionitrile 1,2-dimethoxyethane (DME). nitromethane, 1,4-dioxane, tetrahydrofuran, methyl tetrahydrofuran, and methoxyprioionitrile. A more preferred solvent is 1,2-dimethoxyethane (DME). Even more preferred solvents are acetonitrile and propionitrile. Crown ethers may also be used as solvents or cosolvents.

In embodiments, the solvent is a volatile nitrile including acetonitrile, propionitrile, butyronitrile, valeronitrile, isovaleronitrile, pentanonitrile, or hexanenitrile. In embodiments, the solvent has a boiling point of ranging from 50° C. to 240° C. at normal atmospheric pressure. In embodiments, the solvent has a boiling point less than 100° C. at the reaction pressure. In embodiments, the solvent has a boiling point of 70° C. or less at the reaction pressure. In embodiments, the solvent has a boiling point of 50° C. or less at the reaction pressure. In embodiments, the solvent has a boiling point between 35° C. and 100° C. at the reaction pressure. In embodiments, the solvent has a boiling point between 35° C. and 80° C. at the reaction pressure.

The improved polymerization processes can be run at a temperature from −78° C. to 200° C. A preferred temperature ranges from 0° C. to 100° C. The preferred and more preferred temperature of the polymerization reaction depends in part on the catalyst employed and the monomer(s) to be polymerized. The temperature is selected such that the monomer(s) are dehydrated to facilitate polymerization, but such that further degradation of the monomer(s) is minimized or avoided. A more preferred temperature is between 30° C. and 80° C. or between 50° C. to 110° C. An even more preferred temperature range is between 40° C. and 70° C. or between 65° C. and 100° C. In specific embodiments, the improved processes of the invention include one or more steps in which the reaction temperature may be the same or different. In specific embodiments, the reaction temperature through the entire process is maintained at the same temperature+/−10%.

In specific embodiments, the polymerization method of the invention includes one or more solvent removal steps. In embodiments, the length of time of a given solvent removal step can independently range from 0.1 to 24 h; 0.1 to 18 h; 0.1 to 12 h; 0.1 to 6 h; 0.1 to 3 h; 0.1 to 2 h, 0.1 to 1 h; or 0.1 to 0.5 h. In certain embodiments, a given solvent removal step extends to the time needed to achieve a selected level of decrease in solvent. In certain embodiments, a solvent removal step extends to the time needed to removal all visible solvent from the reaction mixture. It will be appreciated the reaction temperature and reaction pressure of different solvent removal steps in a given method may be the same or different. In embodiments, the reaction temperature of sequential solvent removal steps in a given method is increased to facilitate solvent removal with time. In embodiments, the reaction pressure of each solvent removal step is sub-ambient. In embodiments, the reaction pressure of sequential solvent removal steps in a given method is decreased to facilitate solvent removal with time.

In specific embodiments, the polymerization method of the invention includes one or more holding steps, in some cases at selected monomer concentrations. In embodiments, the length of time of a given holding step can independently range from 0.1 to 48 h; 0.1 to 36 h; 0.1 to 24 h; 0.1 to 18 h; 0.1 to 12 h; 0.1 to 6 h, 0.1 to 3 h; 0.1 to 2 h; 0.1 to 1 h; or 0.1 to 0.5 h. In embodiments, the length of time of the one or more holding steps in a given method is the same within +/−10%. In embodiments, the lengths of time of the one or more holding steps in a given method are different from each other. It will be appreciated the reaction temperature and reaction pressure of different holding steps in a given method may be the same or different. In embodiments, the reaction temperature of sequential holding steps in a given method is increased to facilitate water removal and polymerization. In embodiments, the reaction pressure of each holding step is sub-ambient. In embodiments, the reaction pressure of sequential holding steps in a given method is decreased to facilitate water removal and polymerization.

In some embodiments, the polymerization reaction has an initial reaction step prior to any solvent removal step. This initial reaction step can be conducted at a selected reaction temperature, selected reaction pressure and for a selected reaction time. In embodiments, this initial reaction can be conducted in a selected solvent at a selected concentration of one or more monomer in the solvent and in the presence of catalyst. In embodiments, the reaction pressure of the initial reaction step is ambient pressure. In embodiment, the reaction pressure of the initial reaction step is sub-ambient pressure and can be less than 500 torr, less than 250 torr, less than 200 torr, less than 150 torr, less than 100 torr, less than 50 torr, less than 30 torr or less than 10 torr. In embodiment, the reaction pressure of the initial reaction step is less than 1 torr. In embodiments, solvent removal does not occur in the initial reaction step In embodiments, solvent removal occurs in the initial reaction step. In embodiments, the initial reaction is conducted in the presence of catalyst, but in the absence of solvent. In embodiments, the length of time of the initial reaction step can range from 0.1 to 48 h; 0.1 to 36 h; 0.1 to 24 h; 0.1 to 18 h; 0.1 to 12 h; 0.1 to 6 h, 0.1 to 3 h; 0.1 to 2 h; 0.1 to 1 h; or 0.1 to 0.5 h. In embodiments, the temperature of the initial reaction step ranges from −78° C. to 200° C. In embodiments, the temperature of the initial reaction step ranges from 0° C. to 100° C. The preferred and more preferred temperatures of the initial reaction steps depends in part on the catalyst employed and the monomer(s) to be polymerized. In embodiments, the temperature is selected such that the monomer(s) are dehydrated to facilitate polymerization, but such that degradation of the monomer(s) is minimized or avoided. In embodiments, the temperature of the initial reaction step ranges from 30° C. to 100° C. In embodiments, the temperature of the initial reaction step ranges from 35° C. to 80° C. In embodiments, the temperature of the initial reaction step ranges from 35° C. to 50° C.

In specific embodiments, the polymerization method of the invention is conducted under sub-ambient pressure. In embodiments, the one or more steps of the polymerization method can be conducted at different sub-ambient pressures. In embodiments, the entire reaction is conducted at sub-ambient pressure (all of the reaction steps). In embodiments, a first reaction step is performed at ambient pressure and the remaining solvent removal and holding steps are conducted at sub-ambient pressure. In embodiments, all sub-ambient pressure applied in the steps of a given method are the same sub-ambient pressure+/−10%. In embodiments, sub-ambient pressure is less than 150 torr, less than 100 torr, less than 50 torr, less than 30 torr, less than 10 torr, or less than 1 torr. In embodiments, all sub-ambient pressure applied in the steps of a given method are at different sub-ambient pressures.

In a related aspect, the invention provides a novel process to purify the polymer or copolymers of the invention after synthesis that does not involve the use of water. Such an improved process includes dissolving the product of the polymerization reaction in a non-aqueous solvent in which the polymer is soluble, but the catalyst is insoluble and then filtering off the catalyst and optionally repeating the dissolution filtration cycles multiple times to obtain product of desired purity. Examples of solvents suitable for this procedure include dichloromethane, methyl ethyl ketone, methyl isobutyl ketone and ethyl acetate. This improvement provides significant commercial benefits since the materials of this invention can be processed into free-standing shapes and films.

The invention also relates to films and molded objects prepared employing polymers and copolymers of this invention. In embodiments, the invention provides films and molded objects prepared employing polymers or copolymers of the invention where the polymer or copolymer has Mw equal to greater than 15,0000 Da. In embodiments, the film is a thin film. In embodiments, the thin film is a free-standing thin film. In embodiments, the molded object is free standing. In embodiments, the molded object is prepared by blow molding as is known in the art. The invention further relates to methods of preparing a film employing a polymer or copolymer of the invention and particularly to those methods where the polymer or copolymer has Mw of 15,000 Da or more. In embodiments, the methods of forming a film or object involve solvent casting. In embodiments, the methods of forming a film involve melt pressing, extrusion, blow molding, injection molding, solvent casting, vacuum casting, thermoforming, 3D printing, compression molding or rotational molding. In embodiments, the film formed is a thin film with thickness less than 3 mm. In embodiments, the film formed is a thin film with thickness less than 500 micron. In embodiments, the thin film is free standing. The invention further relates to methods of preparing a molded object employing a polymer or copolymer of the invention and particularly to those methods where the polymer or copolymer has Mw of 15,000 Da or more. In embodiments, the molded object is free standing. In embodiments, the method is a method of blow molding.

In embodiments, polymer films (including thin films) are prepared by either solvent casting or melt pressing employing polymers, copolymers or a combination thereof of the invention. In an exemplary solvent casting method, the polymer is dissolved in an appropriate volatile organic solvent, for example, dichloromethane and sonicated in an ultrasonic disperser, for example for 1-10 minutes, to obtain a uniform solution.5 Preferably a minimum amount of solvent is employed to dissolve the polymer. If needed, a fraction of the solvent is allowed to evaporate until a viscous, yet pourable mixture is obtained. The viscous mixture is poured into a releasable mold from which the molded film can be released (e.g., silicone) or spread with a coating applicator to a desired thickness on a releasable surface from which the formed film can be released, e.g., a polytetrafluoroethylene (PTFE, Teflon® fluoropolymer (The Chemours Company FC, LLC, Delaware) surface. The film is allowed to dry overnight at room temperature and then is heated at a temperature of 100° C. or less for a selected time, e.g., 4 hours at 40° C. in an oven. The film is removed from the substrate with a blade. In embodiments, film prepared from polymers and copolymers of this invention are optically clear and flexible. In embodiments, film prepared from polymers and copolymers of this invention are optically clear and flexible and are free standing. A free-standing film is a thin film that can stand on its own without adhering to a surface.

In an exemplary melt-pressing method, the polymer or copolymer or a mixture thereof in powder form is placed between two sheets of parchment paper, silicone or a related material from which the film can be released and pressed in a hot rosin press at 100-500 psi of pressure at a temperature ranging between 85° F. and 220° F. (between 29° C.-105° C.) until the film is formed (e.g., about 30 seconds).

Conventional methods of solvent casting, melt-pressing and polymer molding including blow molding are known in the art and can be employed in preparation of films (including free standing films and molded films), particularly free-standing and molded thin films.

The mechanical properties of polymer and copolymer films, including tensile strength, modulus, ultimate strength, and tear resistance, are evaluated using a Universal Testing Machine. Testing follows standardized procedures. Specimens are prepared by cutting polymer films into precise shapes, conditioned at controlled environmental settings, and subjected to uniaxial force in the testing machine. The stress-strain data collected provide essential parameters like Young's modulus, ultimate tensile strength, and elongation at break, while tear testing measures the average force required to propagate a notch-induced tear.

Dynamic Mechanical Analysis (DMA) can also be used to measure mechanical properties of polymers and copolymers and also provides information about the viscoelastic behavior of polymer and copolymer films. By applying oscillatory strains and conducting temperature sweeps, DMA determines key properties such as storage modulus, loss modulus, and damping factor, offering insights into material performance under dynamic conditions.

Young's modulus measures a material's stiffness or resistance to elastic deformation. Tensile strength is a measure of the maximum amount of stress a material can withstand before it breaks or fails. Young's modulus and tensile strength are determined by measurement of change of length of a material on application of stress, typically by measurement of at least a portion of the stress-strain curve for a material at a given temperature, where stress is force/unit area and strain is change in length/original length. Young's modulus is the ratio of stress to strain in the elastic region of a material (the initial linear region of a stress-strain curve). Herein Young's modulus and tensile strength are measured at 20° C. (room temperature). Ultimate tensile strength (also simply called tensile strength) is the maximum stress that a material can withstand while being stretched (the highest stress on a stress-strain curve). Tensile strength at break is the stress on the stress-strain curve at break or failure. Methods for measurement of stress-strain curves are known in the art.

In embodiments, polymer and copolymer films of this invention have ultimate tensile strength or tensile strength at break measured at 20° C. greater than 0.01 MPa (MegaPascal) or more preferably greater than 0.1 MPa. In embodiments, polymer and copolymer films of this invention have ultimate tensile strength (20° C.) or tensile strength at break (20° C.) ranging from 0.01 MPa to 1000 MPa, more preferably between 0.1 MPa and 100 MPa and most preferably between 1 MPa and 20 MPa. Polymer and copolymer films of this invention have Young's Modulus (20° C.) greater than 0.01 MPa or more preferably greater than 0.1 MPa. Polymer and copolymer films of this invention have Young's Modulus (20° C.) ranging from 0.01 MPa to 5000 MPa, more preferably between 0.1 MPa and 1000 MPa and most preferably between 0.5 MPa and 500 MPa. In embodiments, preferred polymers have Young's modulus (20° C.) higher than 0.05 MPa. In other embodiments, polymers have ultimate tensile strength (20° C.) higher than 0.2 MPa. In embodiments, the invention provides certain polymers with Young's modulus (20° C.) greater than 100 kPa (0.1 MPa) and/or ultimate tensile strength than 200 kPa (0.2 MPa).

In embodiments, the polymers and copolymers prepared by the methods of this invention have improved thermal properties, including increased thermal stability, which is herein assessed by measurement of T95 (5% mass loss temperature), increased T95 generally indicates increased thermal stability of a polymer. Thermal stability of a polymer depends upon many parameters, the type of polymer, the presence or absence of end-capping, the presence of a catalyst that can trigger depolymerization and in some cases the molecular weight of the polymer. End-capping can significantly improve the thermal stability of a polymer because depolymerization often occurs through unzipping at the polymer ends which is inhibited by end-capping. Polymer preparation costs may be lowered if end-capping can be avoided. So polymers which exhibit good thermal stability without end-capping are of interest. It is advantageous to achieve thermal stability without end-capping. The methods of the invention have been found to provide polymers and copolymers that exhibit thermal stability as assessed by having T95 of 165° C. or higher without end-capping. Any polymer or copolymer of the invention can of course be end-capped to further improve thermal and mechanical properties.

### Definitions

In general, the terms and phrases used in this specification have the meaning recognized in the art, which can be found by reference to standard texts, journal references and contexts known to those skilled in the art. For clarity, the following terms have the following meaning unless otherwise specified:

It will be understood by one of ordinary skill in the art that single numeric values or numeric values in a range, include slight variations or deviations from the stated value which may be used to achieve substantially the same results as the stated value. In cases, where a numeric value is one that is measured, it will be recognized that there is some level of uncertainty in the stated value due to experimental error, which can be determined by one of ordinary skill in the art. In circumstances where this definition cannot be applied to a given stated value, is exceedingly difficult to apply, or wherein an uncertainty value is not specifically recited, then the numeric value has a reasonable deviation from the value, as known to a skilled person in the art. In embodiments, the reasonable deviation for a given value is +/−10% unless otherwise indicated.

Glycolaldehyde is also known as 2-hydroxyacetaldehyde and has formula CHO—CH₂—OH.

Glycolaldehyde dimers include all dimeric forms of glycolaldehyde. Glycolaldehyde dimers include linear dimers and cyclic dimers, including six-member cyclic dimers, five-member cyclic dimers and four-member cyclic dimers. Glycolaldehyde dimers are optionally substituted (particularly with R₁ and R₂ groups as illustrated in the polymers of Structures 1 and 2). Optional substitution of glycolaldehyde dimers includes substitution with one or more alkyl groups (particularly alkyl groups having 1-3 carbon atoms and more particularly one or more methyl groups).

Glycolaldehyde dimers include, but are not limited. to 2,5-dihydroxy-1,4-dioxane; (1,2-dihydroxyethoxy) acetaldehyde; 2-(hydroxymethyl)-1,3-dioxolan-4-ol; 1,1′-oxydi (ethane-1,2-diol); 2,2′-oxydi (ethane-1,1-diol); (1,3-dioxetane-2,4-diyl)dimethanol; and 2,2′-oxydiacetaldehyde and mixtures thereof. Some examples of glycolaldehyde dimers are shown in Scheme 1. Monomers useful in the methods herein include the glycolaldehyde monomers of Scheme 1 as well as functionalized derivatives thereof in which 1, 2, 3, 4, 5 or 6 of the hydrogens of the illustrated monomer are replaced with one or more non-hydrogen functional groups as described herein.

A polymer is a substance composed of very large molecules, called macromolecules, that are multiples of simpler chemical units called monomers. Polymers can be linear, branched or crosslinked. In specific embodiments herein polymers prepared by the method of this invention have Mw (weight average molecule weight) of 15,000 Da or higher. Mw of polymers can, for example, range from 15,000 Da to 100,000 Da or from 15,000 Da to 50,000 Da or from 15,000 Da to 40,000 Da.

A copolymer is a polymer derived from more than one species of monomer. Copolymers may contain a mixture of two or more monomers, three or more monomers, four or more monomers, five or more monomers, etc. In embodiments, copolymers of the invention are those wherein at least one monomer is a glycolaldehyde dimer and more specifically wherein at least one monomer is DHDO. In specific embodiments herein copolymers prepared by the method of this invention have Mw (weight average molecule weight) of 15,000 Da or higher. Mw of copolymers can, for example, range from 15,000 Da to 100,000 Da or from 15,000 Da to 50,000 Da or from 15,000 Da to 40,000 Da.

A prepolymer or pre-polymer refers to a monomer or system of monomers that have been reacted to an intermediate-molecular mass state. A prepolymer is capable of further polymerization by reaction with reactive groups, e.g., with a second monomer or mixture of monomers, to a fully cured, high-molecular-mass state. Prepolymers are also called resins. If OH terminated, prepolymers are also called polyols. The useful size of a prepolymer depends on specific polymerizations to be carried out as well as the desired polymerized product. Often viscosity, solubility, miscibility and reactivity with the second monomer or mixture of monomers are important factors for selection of prepolymer size. In embodiments of this invention, prepolymers nominally include species with two or more of the same or different repeating units and extend up to species having 1,000 or more repeating units. In embodiments of this invention, the size of the prepolymer can vary widely. In embodiments, the polymers or copolymers made by the methods herein are prepolymers intended for additional polymerization reactions or cross-linking reactions. In embodiments, the methods herein can be employed to prepare prepolymers. In specific embodiments, the prepolymers herein range in Mw from 15,000 Da to 25,000 Da. In specific embodiments, prepolymers herein range in Mw from 300 to less than 15,000 Da and more specifically from 300 to 10,000 Da or 300 to 8,000 Da. Specific prepolymers of this invention include PDHDO (Structure 1) and M-PDHDO (of Structure 2) and more specifically PDHDO and M-PDHDO having Mw ranging from 300 to 14,000 Da (or 300 to 10,000 Da or 300 to 8,000 Da).

Oligomer is used to describe species having a few monomer units linked together. For clarity herein, the term oligomer refers to species containing 10 or fewer monomer units. Oligomers can contain repeating units that are all the same or two or more different repeating units. In certain cases, oligomers and prepolymer are synonymous. For example, an oligomer can be used as a starting material in a polymerization reaction. For use herein, the term prepolymer is used for an intermediate compound used for further polymerization (including species of the size of oligomers) and the term oligomer refers to a final product.

An alpha-hydroxyaldehyde (also written as α-hydoxyaldehyde) is a chemical compound that comprises an aldehyde group and a hydroxyl group substituent on the adjacent (alpha) carbon to the aldehyde group. Examples of this group include glycolaldehyde, lactaldehyde, malic aldehyde, mandelic aldehyde, and pyruvaldehyde. Alpha-hydroxyaldehydes may exist in one or more dimer forms.

An alpha-hydroxyketone (also written as α-hydroxyketone) is a chemical compound that comprises an aldehyde ketone group and a hydroxyl group substituent on the adjacent (alpha) carbon to the ketone group. Examples of this group include hydroxyacetone, dihydroxyacetone, benzoin, 2-hydroxycyclohexanone, and mandelic acid in its keto form. The term alpha-hydroxycarbonyl most generically is a chemical compound that is an alpha-hydroxyaldehyde or an alpha-hydroxyketone.

PDHDO refers to a polymer including a prepolymer of Structure 1:

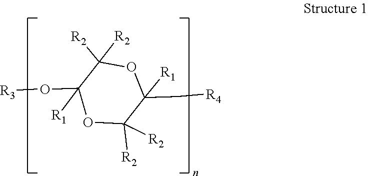

where n is the number of repeating units in the polymer and is greater than 10 (to exclude oligomers) and ranges up to 10,000,000, but more typically ranges from 10 up to about 10,000, 5,000, 1,000, 500, 350, 150, or 50; and
each R₁, each R₂ and R₃ is independently selected from the group consisting of hydrogen (—H), deuterium (-D), a halogen atom (—F, —Cl, —Br, —I), a hydroxyl group (—OH), an amino group (—NH₂), an alkylamino group (—NHR₉), a (bisalkylamino) group [—N(R₉)₂], an alkyl group, an alkenyl group, an alkynyl group, an alkoxy group, an alkoxyalkyl group, an alkoxyalkenyl group, an aminoalkylene group, an (alkylamino)alkylene group, a (bisalkylamino)alkylene group, an alkoxyalkynyl group, an haloalkyl group, an haloalkenyl group, an haloalkynyl group, an haloalkoxy group, an aryl group, an alkoxyaryl group, an haloaryl group, an alkylaryl group, an alkyl carbonate group, an acrylate group, a methacrylate group, a group comprising an oxirane ring, a glycidyl group, a thiol group (—SH), alkylthio (—SR₉), a nitro group (—NO₂), a cyano group (—C═N), a isocyanate group (—N═C—O), a azide group (—N₃), a cyanate group (—O═C═N), a nitroso group (—NO), a phosphine group (—P(R₉)₂), a phosphate group (—OP(O)(OR₉)₂), a phosphonate group (—P(O)(OR₉)₂), a sulfate group (—O—SO₃R₉), a sulfonate group (—SO₃R₉), a thiocyanate group (—S═C═N), a iso thiocyanate group (—N═C═S), a —COR₉ group, a —COOR₉ group, a —CON(R₉)₂ group, a —CSR₉ group, a —CS—OR₉ group, a —N(R₉)₂ group, a —CO—O—CO—R₉, a —CO—NR₉—CO—R₉, a —N═C(R₉)₂, and a —CR₉—NR₉; where each R₉ is independently, a hydrogen, deuterium, an alkyl, an aryl, an alkenyl or an alkynyl group, and each of which R₉ is optionally substituted with one or more halogen, hydroxy group, nitro group, cyano group, isocyano group, oxo group, thioxo group, azide group, cyanate group, isocyanate group, nitroso group, phosphine group, phosphate group, thiocyano group, or thiocyanate group; and
R₄ independently of R₃ is any of the groups listed above for R₃ and can also be —O—R₃ and/or any one or more of R₁, R₂, R₃ and R₄ is oligomeric, prepolymeric or polymeric.

In embodiments, the methods of the invention are particularly useful for preparation of polymers of Structure 1, where Mw is 15,000 Da or greater. Such polymers include those in which n is 100 or more, 125 or more or 150 or more.

In specific embodiments, each R₁ and each R₂ are independently selected from H, D, optionally substituted alkyl groups having 1-3 carbon atoms, and optionally substituted aryl groups, particularly optionally substituted phenyl or benzyl groups. In specific embodiments, each R₃ independently is hydrogen, deuterium, alkyl, acyl, acrylic, methacrylic, glycidyl, aminoalkylene, (alkylamino)alkylene, (bisalkylamino)alkylene, in particular R₉CO⁻, where R₉ is optionally substituted alkyl, optionally substituted alkenyl or optionally substituted aryl (for example, optionally substituted phenyl or benzyl). The R₁ and R₂ groups derive from the optional substitution of the one or more glycolaldehyde dimer which is being polymerized.

In specific embodiments, each of R₁ and R₂ is hydrogen. In specific embodiments, R₃ is hydrogen, alkyl or acyl. In specific embodiments, R₄ is H, OH, alkyl, alkoxy, acyl or —O-acyl.

In embodiments, one or both of R₃ or R₄ is independently oligomeric, pre-polymeric or polymeric. In embodiments, one or more of R₁ or R₂ is independently optionally oligomeric, pre-polymeric or polymeric. In embodiments, one or both of R₃ or R₄ is independently oligomeric, pre-polymeric or polymeric and each of R₁ and R₂ is non-oligomeric, not pre-polymeric or non-polymeric. In embodiments, each R₁, each R₂ and R₃ and R₄ are nonoligomeric. In embodiments, each R₁, R₂, R₃ and R₄ are not prepolymeric. In preferred embodiments, each R₁, each R₂ and R₃ and R₄ are non-polymeric.

In embodiments, n ranges from about 145 to about 1,000. In other embodiments, n ranges from about 145 to about 500. In yet other embodiments, n ranges from about 145 to about 350.

The invention also relates to copolymers of DHDO with one or more other monomers. Such copolymers are herein designated M-PDHDO (mixed PDHDO) refers to a copolymer including a prepolymer of Structure 2, where n and m are both non-zero:

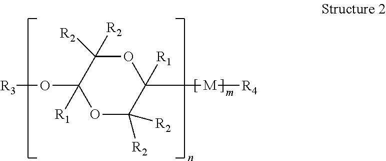

where n+m is the number of repeating units in the copolymer and is greater than 10 (to exclude oligomers) and ranges up to 10,000,000, but more typically ranges from 10 up to about 10,000, 5,000, 1,000, 500, 350, 150, or 50 and m/(n+m) ranges from 0.01 to 0.5 or more specifically ranges from 0.01 to 0.25, or 0.01 to 0.2 or 0.1 to 0.1 or 0.1 to 0.5 or 0.1 to 0.25, or 0.1 to 0.2;

M is a monomer other than DHDO which is linked to the DHDO through an appropriate chemical linkage, such as —O—, —OCO—, —COO—, or —CO—; and

R₁, R₂, R₃ and R₄ are as defined for Structure 1.

In embodiments, the methods of the invention are particularly useful for preparation of polymers of Structure 2, where Mw is 15,000 Da or greater. Such polymers can include those in which n+m is 100 or more, 125 or more, 150 or more or 175 or more.

In embodiments, the monomer M is optionally substituted with one or more non-hydrogen groups independently selected from the group consisting of deuterium (-D), an halogen atom (—F, —Cl, —Br, —I), a hydroxyl group (—OH), an amino group (—NH₂), an alkylamino group (—NHR₉), a (bisalkylamino) group [—N(R₉)₂], an alkyl group, an alkenyl group, an alkynyl group, an alkoxy group, an alkoxyalkyl group, an alkoxyalkenyl group, an aminoalkylene group, an (alkylamino)alkylene group, a (bisalkylamino)alkylene group, an alkoxyalkynyl group, an haloalkyl group, an haloalkenyl group, an haloalkynyl group, an haloalkoxy group, an aryl group, an alkoxyaryl group, an haloaryl group, an alkylaryl group, an alkyl carbonate group, an acrylate group, a methacrylate group, a group comprising an oxirane ring, a glycidyl group, a thiol group (—SH), alkylthio (—SR₉), a nitro group (—NO₂), a cyano group (—C═N), a isocyanate group (—N═C—O), an azide group (—N₃), a cyanate group (—O═C═N), a nitroso group (—NO), a phosphine group (—P(R₉)₂), a phosphate group (—OP(O)(OR₉)₂), a phosphonate group (—P(O)(OR₉)₂), a sulfate group (—O—SO₃R₉), a sulfonate group (—SO₃R₉), a thiocyanate group (—S═C═N), a iso thiocyanate group (—N═C═S), a —COR₉ group, a —COOR, group, a —CON(R₉)₂ group, a —CSR₉ group, a —CS—OR, group, a —N(R₉)₂ group, a —CO—O—CO—R₉ group, a —CO—NR₉—CO—R₉ group, a —N═C(R₉)₂ group, and a —CR₉—NR₉ group; where each R₉ is independently, a hydrogen, deuterium, an alkyl, an aryl, an alkenyl or an alkynyl group, each of which Reis optionally substituted with one or more halogen, hydroxy group, nitro group, cyano group, isocyano group, oxo group, thioxo group, azide group, cyanate group, isocyanate group, nitroso group, phosphine group, phosphate group, thiocyano group, or thiocyanate group.

In embodiments, the monomer M is optionally substituted with one or more non-hydrogen groups independently selected from the group consisting of D, optionally substituted alkyl groups having 1-3 carbon atoms, and optionally substituted aryl groups, particularly optionally substituted phenyl or benzyl groups.

In embodiments, M is an alpha-hydroxyaldehyde or an alpha-hydroxyketone monomer other than DHDO (2,5-dihydroxy-1, 4-dioxane). In embodiments, M is a dimer of glycolaldehyde other than 2, 5-dihydroxy-1, 4-dioxane (such as illustrates in Scheme 1). In embodiments, M is a functionalized derivative of a dimer of glycolaldehyde other than 2, 5-dihydroxy-1, 4-dioxane (such as illustrated in Scheme 1) where the dimer is optionally functionalized with 1, 2, 3, 4, 5, or 6 non-hydrogen substituents (in place of hydrogens) where optional substitution is substitution with one or more of deuterium (-D), an halogen atom (—F, —Cl, —Br, —I), a hydroxyl group (—OH), an amino group (—NH₂), an alkylamino group (—NHR₉), a (bisalkylamino) group [—N(R₉)₂], an alkyl group, an alkenyl group, an alkynyl group, an alkoxy group, an alkoxyalkyl group, an alkoxyalkenyl group, an aminoalkylene group, an (alkylamino)alkylene group, a (bisalkylamino)alkylene group, an alkoxyalkynyl group, an haloalkyl group, an haloalkenyl group, an haloalkynyl group, an haloalkoxy group, an aryl group, an alkoxyaryl group, an haloaryl group, an alkylaryl group, an alkyl carbonate group, an acrylate group, a methacrylate group, a group comprising an oxirane ring, a glycidyl group, a thiol group (—SH), alkylthio (—SR₉), a nitro group (—NO₂), a cyano group (—C═N), a isocyanate group (—N═C—O), a azide group (—N₃), a cyanate group (—O═C═N), a nitroso group (—NO), a phosphine group (—P(R₉)₂), a phosphate group (—OP(O)(OR₉)₂), a phosphonate group (—P(O)(OR₉)₂), a sulfate group (—O—SO₃R₉), a sulfonate group (—SO₃R₉), a thiocyanate group (—S—C—N), a iso thiocyanate group (—N═C—S), a —COR₉ group, a —COOR group, a —CON(R₉)₂ group, a —CSR₉ group, a —CS—OR group, a —N(R₉)₂ group, a —CO—O—CO—R₉ group, a —CO—NR₉—CO—R₉ group, a —N—C(R₉)₂ group, and a —CR₉—NR₉ group; where each R₉ is independently, a hydrogen, deuterium, an alkyl, an aryl, an alkenyl or an alkynyl group, and each of which R₉ is optionally substituted with one or more halogen, hydroxy group, nitro group, cyano group, isocyano group, oxo group, thioxo group, azide group, cyanate group, isocyanate group, nitroso group, phosphine group, phosphate group, thiocyano group, or thiocyanate group. Preferred substituents for optional substitution are optionally substituted alkyl groups having 1-3 carbon atoms, and optionally substituted aryl groups, particularly optionally substituted phenyl or benzyl groups. In specific embodiments, optional substituents include alkyl, acyl, acrylic, methacrylic, glycidyl, aminoalkylene, (alkylamino)alkylene, (bisalkylamino)alkylene, in particular R₉CO⁻, where R₉ is optionally substituted alkyl, optionally substituted alkenyl or optionally substituted aryl (for example, optionally substituted phenyl or benzyl). Each of such substituents is itself optionally substituted with one or more of a halogen, an unsubstituted C₁-C₃ alkyl group, an unsubstituted C₁-C₃ alkoxy group, an unsubstituted C₂-C₄ alkenyl group, a C₁-C₃ haloalkyl group, an unsubstituted phenyl or benzyl group, an unsubstituted C₁-C₃ acyl group (e.g., an acetyl group), a —COOH, a —COOR₁₀, where R₁₀ is an unsubstituted C₁-C₃ alkyl, an unsubstituted C₁-C₃ alkoxy, an unsubstituted C₂-C₄ alkenyl group, an C₁-C₃ haloalkyl group, an unsubstituted phenyl or unsubstituted benzyl group, or an unsubstituted C₁-C₃ acyl group.

Non-limiting examples of comonomers for introduction of M into copolymers of Structure 2 include dicarboxylic acids. Examples of dicarboxylic acids useful for making copolymers of structure 2 include, among others, oxalic acid, malonic acid, succinic acid, glutaric acid, adipic acid, pimelic acid, suberic acid, azelaic acid, sebacic acid, dodecanedioic acid, terephthalic acid, phthalic acid, isophthalic acid, fumaric acid, maleic acid, brassylic acid, thapsic acid, traumatic acid, undecanedioic acid, octadecanedioic acid, itaconic acid, citraconic acid, mesaconic acid, muconic acid, 2,5-furandicarboxylic acid (FDCA), diglycolic acid, dipicolinic acid, homophthalic acid, naphthalene-1,4-dicarboxylic acid, naphthalene-2,6-dicarboxylic acid, 2,6-pyridinedicarboxylic acid, 2,5-pyridinedicarboxylic acid, and 3,5-pyridinedicarboxylic acid. In embodiments non-limiting examples of comonomers for introduction of M into copolymers of Structure 2 include derivatives of the above listed acids including their acid halides, acid chlorides, anhydrides, methyl esters, ethyl esters and alkyl ester derivatives, each of which can be optionally substituted. For example, one or more hydrogens in these species can be substituted with one or more groups as defined in Structure 1 for R₁—R₃. In embodiments, optional substitution includes substitution with one or more halogen, one or more alkyl, one or more alkoxy, one or more phenyl or benzyl, one or more phenoxy or benzyloxy. Alkyl and alkoxy substitutents include those having 1-3 carbon atoms. In embodiments non-limiting examples of comonomers for introduction of M into copolymers of Structure 2 include diisocyanates. Examples of di-isocyanates useful for making copolymers of structure 2 include methylene diphenyl diisocyanate (MDI), toluene diisocyanate (TDI), hexamethylene diisocyanate (HDI), isophorone diisocyanate (IPDI), naphthalene diisocyanate (NDI), methylene dicyclohexyl diisocyanate (H12MDI), xylylene diisocyanate (XDI), tetramethylxylylene diisocyanate (TMXDI), trimethylhexamethylene diisocyanate (TMDI), lysine diisocyanate (LDI), para-phenylene diisocyanate (PPDI), trans-cyclohexane diisocyanate (CHDI), 1,4-cyclohexane diisocyanate, meta-tetramethylxylylene diisocyanate (m-TMXDI). In particular embodiments, the methods herein are useful for preparation of such copolymers wherein Mw is 15,000 Da or more.

Copolymers that can be prepared by the methods herein include those of Structures 1-9 of PCT/US2023/084958 (published as WO2024137712A1) which is incorporated by reference herein for these copolymer structures and definitions of variables of these structures. In particular embodiments, the methods herein are useful for preparation of such copolymers wherein Mw is 15,000 Da or more. US application 19/243,46, filed Jun. 19, 2025, is a continuation-in-part of International application PCT/US23/84958 and is incorporated by reference herein in its entirety.

DHDO refers to 2, 5-dihydoxy-1, 4-dioxane (a particular glycolaldehyde dimer). M-DHDO containing at least some amounts of other glycolaldehyde dimers (as impurities), which are designated mixed glycolaldehyde dimers can be used in polymerization methods herein to prepare certain copolymers. Exemplary other glycolaldehyde dimers are illustrated in Scheme 1. In certain embodiments, polymers prepared from M-DHDO exhibit improved mechanical properties compared to polymers of DHDO. Polymers of M-DHDO (PM-DHDO) are described in more detail in PCT/US2023/084958 (published as WO2024137712A1) and particularly in Structure 1, therein.

The improved methods herein can be employed to make polymers and copolymers as described in U.S. provisional application SN 64/033,110, entitled “FUNCTIONALIZED GLYCOLALDEHYDE DIMERS AND METHOD OF MAKING SAME” (Attorney Docket No. 340246:8-25P1), filed Apr. 8, 2026. This application is incorporated by reference herein in its entirety for descriptions of such polymers and copolymers.

Polymers and copolymers of glycolaldehyde dimers that can be prepared by the methods of this invention include alternating, random and block copolymers of glycolaldehyde dimers. Copolymers of this invention may be linear, branched or crosslinked. Copolymers of glycolaldehyde dimers of this invention include copolymers in which the glycolaldehyde dimer exists in either its linear forms, six-member cyclic form, five-member cyclic form, four-member ring form or a mixture of two or more forms. Copolymers of glycolaldehyde dimer include those in which the dimer is in the form of 2,5-dihydroxy-1,4-dioxane; (1,2-dihydroxyethoxy) acetaldehyde; 2-(hydroxymethyl)-1,3-dioxolan-4-ol; 1, 1′-oxydi (ethane-1,2-diol); 2,2′-oxydi (ethane-1,1-diol); (1,3-dioxetane-2,4-diyl)dimethanol; and 2,2′-oxydiacetaldehyde (see Scheme 1) and mixture thereof. Copolymers of this invention include copolymers in which all the monomers are different forms of glycolaldehyde dimers, and copolymers in which one or more glycolaldehyde dimers or two or more glycolaldehyde dimers are reacted with one or more other, chemically different, comonomers.

The invention provides methods for making copolymers of glycolaldehyde and particularly of DHDO with comonomers which are other alpha-hydroxyaldehydes and/or alpha-hydroxyketones, including but not limited to hydroxyacetone, lactic aldehyde, malic aldehyde, and mandelic aldehyde, benzoin, pyruvaldehyde, 2-hydroxycyclohexanone, and mandelic acid (in its keto form). In embodiments, copolymers contain 50 molar % or more of glycolaldehyde, including 60 molar % or more, 70 molar % or more, 80 molar % or more, 90 molar % or more or 95% or more of glycolaldehyde. In embodiments, copolymers contain 50 molar % or more of DHDO, including 60 molar % or more, 70 molar % or more, 80 molar % or more, 90 molar % or more or 95% or more of DHDO.

The invention additionally provides improved methods for making copolymers that comprise, consist essentially of, or consist of DHDO. In an embodiment, the invention provides improved methods for making copolymers that comprise, consist essentially of, or consist of two or more different glycolaldehyde dimers. In an embodiment, the invention provides improved methods for making copolymers that comprise, consist essentially of, or consist of DHDO and one or more glycolaldehyde dimers other than DHDO.

Polymers and copolymers of this invention, particularly those prepared by the improved methods herein, are optionally end capped by reaction with an end-capping reagent. End-capping allows introduction of end groups on one or more free hydroxyl groups of the polymer or copolymer, such as groups R₃ and R₄ in Structure 1 or Structure 2. Reagents useful for end-capping of OH groups include among others, anhydrides, acyl chlorides, triflates, isocyanates, alkyl iodides, activated ethers, activated thioethers, chlorosilanes and chlorocarbonates. For example, an acid anhydride, such as acetic anhydride can be used to add acyl groups (such as acetyl groups) to free OH groups of the polymer and particularly to the ends of the polymer.

In one aspect, the invention provides a method of producing polymers and copolymers from alpha-hydroxycarbonyl compounds and their dimers, the method comprising a condensation polymerization conducted at least in part under sub-ambient pressure in the presence of a Lewis acid catalysis. In embodiments, a variable and decreasing amount of solvent is present during the duration of the polymerization reaction.

In another aspect, the invention provides a method of producing polymers and copolymers from alpha-hydroxycarbonyl compounds and their dimers, the method comprising a condensation polymerization conducted under a solvent and pressure regime which results in increased Mw of the polymers and copolymers formed by polymerization to 15,000 Da or more, increased polymeric yield or increased purity of the polymers or copolymers. In embodiments, improved Mw of 15,000 Da or more of polymers and copolymers is their Mw as formed in the polymerization reaction without end-capping.

In yet another aspect, the invention provides a method of producing polymers and copolymers from alpha-hydroxycarbonyl compounds and their dimers, the method comprising a condensation polymerization conducted in the presence of a Lewis acid catalyst and substantially without solvent for at least a portion of the reaction time. In an embodiment of this aspect, the method is conducted without addition of solvent. In a further embodiment, vacuum is applied to generate sub-ambient reaction pressure and remove water generated during reaction. In a further embodiment, the reaction pressure is less than 150 torr. In another embodiment of this aspect, the reaction includes a step of the polymerization in solvent, followed by one or more steps of concentrating the reaction mixture to remove solvent, In a further embodiment, the selected amount of the solvent added to the reaction is removed by application of vacuum. In a further embodiment, 50%, 60%, 70%, 80%, 90%, 95%, 99% or more by volume of the solvent added is removed in one or more concentration steps. In a further embodiment, the solvent remaining after the one or more concentration step is less than 1% or less than 0.1% of the original volume of solvent. In further embodiments, the solvent remaining after the one or more concentration step is less than 1% by weight or less than 0.1% by weight of the weight of monomers added to the reaction.

In any preceding aspect or embodiment, the reaction is conducted under application of vacuum to generate a sub-ambient reaction pressure. In an embodiment, the reaction pressure is less than 150 torr, less than 125 torr, less than 110 torr, less than 100 torr, less than 50 torr, less than 30 torr, or less than 10 torr. In a further embodiment, the reaction pressure is between 1-10 torr. In a further embodiment, the reaction pressure is less than 1 torr.

In any preceding aspect or embodiment, vacuum applied to the reaction is varied over the course of the reaction to change the reaction pressure.

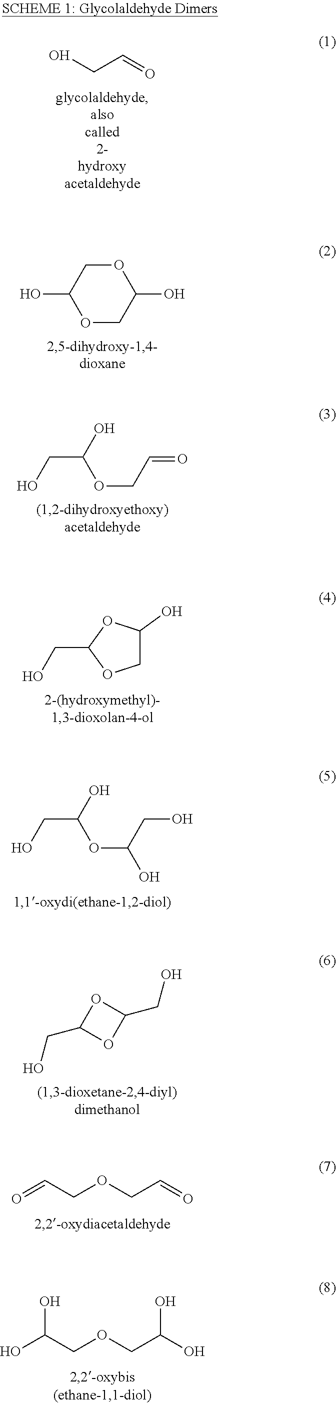

In any preceding aspect or embodiment, the temperature of the reaction ranges from 35° C. to 100° C. In a further embodiment, the temperature of the reaction ranges from 35° C. to 80° C. In a further embodiment, the temperature of the reaction ranges from 35° C. to 70° C. In a further embodiment, the temperature of the reaction ranges from 35° C. to 50° C. In a further embodiment, the temperature of the reaction ranges from 50° C. to 110° C. In a further embodiment, the temperature of the reaction ranges from 65° C. to 100° C.

In any preceding aspect or embodiment, the alpha-hydroxycarbonyl compound is a glycolaldehyde dimer. In a further embodiment, the alpha-hydroxycarbonyl compound is DHDO.

In any preceding aspect or embodiment, a catalytic amount of a dehydration catalyst is employed in the reaction. In a further embodiment, the Lewis acid catalyst is an anhydrous salt of aluminum or copper.

In a fourth aspect, the invention provides a method for producing polymers from alpha-hydroxycarbonyl compounds and their dimers, comprising a condensation polymerization under reduced pressure in the presence of a Lewis acid catalysis wherein no solvent is present in the reaction mixture. In a further embodiment, the condensation polymerization is conducted under a solvent and pressure regime which results in increased Mw of the polymers and copolymers to 15,000 Da or more, increased polymeric yield or increased purity of the polymers or copolymers.

In an embodiment of any preceding aspect or embodiment, the alpha-hydroxycarbonyl compound is a glycolaldehyde dimer and preferably is optionally substituted DHDO or unsubstituted DHDO.

In an embodiment of any preceding aspect or embodiment, the Lewis acid catalyst is an anhydrous salt of aluminum or copper.

In a fifth aspect, the invention provides a polymeric product (polymer or copolymer) made by a method of any preceding aspect or embodiment. In a further embodiment, the polymer or copolymer product has a weight average molecular weight (Mw) equal to or in excess of 15,000 Dalton, 20,000 Dalton, more preferably 25,000 Dalton and most preferably, equal to or in excess of 30,000 Dalton.

In a sixth aspect, the invention provides a film or molded object prepared from a polymeric product of any preceding aspect or embodiment or prepared by a method of any preceding aspect or embodiment. In a further embodiment, the film or molded object is free-standing. In a further embodiment, the film is a free-standing thin film.

In an embodiment of any preceding aspect or embodiment, the film has Young's modulus of greater than 0.1 MPa. In an embodiment of anu preceding aspect or embodiment, the film has tensile strength at break of greater than 0.05 MPa. In a further embodiment of any p-receding aspect or embodiment, the film has both Young's modulus greater than 0.1 MPa and tensile strength at break greater than 0.05 MPa.

Groups herein are optionally substituted most generally with one or more alky, alkenyl, alkynyl, aryl, heteroaryl, carbocyclyl, or heterocyclyl groups and are optionally substituted, for example, with one or more oxo group, thioxo group, halogen, nitro, cyano, cyanate, azido, thiocyano, isocyano, isothiocyano, sulfhydryl, hydroxyl, alkyl, alkoxy, alkenyl, alkenyloxy, alkynyl, alkynyloxy, aryl, aryloxy, heteroaryl, heteroaryloxy, carbocyclyl, carbocyclyloxy, heterocyclyl, heterocyclyloxy, alkylthio, alkenylthio, alkynylthio, arylthio, thioheteroaryl, thiocarbocyclyl, thioheterocyclyl, —CORs, —COH, —OCORs, —OCOH, —CO—ORS, —COOH, —CO—O—CO-Rs, —CON(Rs)₂, —CONHRs, —CONH₂, —NRs-CORs, —NHCORs, —NHRs, —N(Rs)₂, —O—SO₂-Rs, —SO₂-Rs, —SO₂—NHRs, —SO₂—N(Rs)₂, —NRs-SO₂-Rs, —NH—SO₂-Rs, —NRsCO-N(Rs)₂, —NH—CO—NHRs, —O—PO(ORs)₂, —O—PO(ORs)(N(Rs)₂), —O—PO(N(Rs)₂)₂, —N—PO(ORS)₂, —N—PO(ORs)(N(Rs)₂), —P(Rs)₂, —B(OH)₂, —B(OH)(ORs), —B(ORs)₂, where each Rs independently is an organic group and more specifically is an alkyl, alkenyl, alkynyl, aryl, heteroaryl, carbocyclyl, or heterocyclyl group or two Rs within the same substituent can together form a carbocyclic or heterocyclic ring having 3 to 10 ring atoms or 3-6 ring atoms. Organic groups of non-hydrogen substituents are in turn optionally substituted with one or more halogens, nitro, cyano, isocyano, isothiocyano, hydroxyl, sulfhydryl, haloalkyl, hydroxyalkyl, amino, alkylamino, dialkylamino, arylalkyl, unsubstituted alkyl, unsubstituted alkenyl, unsubstituted alkynyl alkylalkenyl, alkylalkynyl, haloaryl, hydroxylaryl, alkylaryl, unsubstituted aryl, unsubstituted carbocylic, halo-substituted carbocyclic, hydroxyl-substituted carbocyclic, alkyl-substituted carbocyclic, unsubstituted heterocyclic, unsubstituted heteroaryl, alkyl-substituted heteroaryl, or alkyl-substituted heterocyclic. In specific embodiments, Rs groups of substituents are independently selected from alkyl groups, haloalkyl groups, phenyl groups, benzyl groups and halo-substituted phenyl and benzyl groups. In specific embodiments, non-hydrogen substituents have 1-20 carbon atoms, 1-10 carbon atoms, 1-7 carbon atoms, 1-5 carbon atoms or 1-3 carbon atoms. In specific embodiments, non-hydrogen substituents have 1-10 heteroatoms, 1-6 heteroatoms, 1-4 heteroatoms, or 1, 2, or 3 heteroatoms. Heteroatoms include O, N, S, P, B and Se and preferably are O, N or S.

In embodiments, optional substitution is substitution with one or more of the groups listed in the definitions of R₁—R₃ of Structure 1 herein.

In specific embodiments, optional substitution is substitution with 1 to 12 (or 1, 2, 3, 4, 5, 6, 7, 8, 9, 10, 11 or 12) non-hydrogen substituents. In specific embodiments, optional substitution is substitution with 1-6 non-hydrogen substituents. In specific embodiments, optional substitution is substitution with 1-3 non-hydrogen substituents. In specific embodiments, optional substitution is substitution with 1 or 2 non-hydrogen substituents. In specific embodiments, optional substitution is substitution with 1 non-hydrogen substituent. In specific embodiments, optional substituents contain 6 or fewer carbon atoms. In specific embodiments, optional substitution is substitution by one or more halogen, hydroxyl group, cyano group, oxo group, thioxo group, unsubstituted C₁-C₆ alkyl or alkoxy group, unsubstituted aryl group (including phenyl, benzyl and biphenyl groups), haloalkyl (including fluoroalkyl) or haloaryl group (including fluorophenyl and fluorobenzyl groups). The term oxo group and thioxo group refer to substitution of a carbon atom with a “═O” moiety or a “═S” moiety to form, respectively, —CO-(carbonyl) or —CS-(thiocarbonyl) groups.

In specific embodiments, non-hydrogen substituents for optional substitution include alkyl, alkoxy, halogen (F, Cl, Br or I and preferably CI or F), haloalkyl, or haloalkoxy. In specific embodiments, non-hydrogen substituents for optional substitution include methyl, ethyl, methoxy, ethoxy, F, CI, and trifluoromethyl.

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RsCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups, and methoxyphenyl groups, particularly 4-methoxyphenyl groups.

Optional substituents include monovalent organic radicals. A monovalent organic radical is a radical formally obtained by the removal of a hydrogen atom from an organic molecule. Non limiting examples of monovalent organic radical include, methyl, ethyl, propyl, isopropyl, butyl, pentyl, hexyl, heptyl, phenyl, aryl, alkyl, alkenyl, alkoxy, alkylcarbonyl, alkanoyl, alkylthio, cycloalkyl, cycloalkoxy, alkyloxy, alkenyloxy, alkenyldioxy, acyl, aryl, alkylaryl, arylalkyl, aryloxy, amino, alkylamino, dialkylamino, alkylcarbonylamino, alkylsulfinyl, aryloxyalkyl, alkoxylalkyl, heterocyclic, heteroaryl, polyetheralkyl, halogenated alkyl (haloalkyl) fluorinated alkyl, perfluoroalkyl, sulfonate, alkylsulfonate, arylsulfonate, alkylsulfate, arylsulfate, nitroalkyl, alkylsilyl, and arylsilyl. In general, an organic radical can contain any number of carbon atoms. In embodiments, organic radicals contain 1-100, 1-50, 1-20, 1-10, 1-6 or 1-3 carbon atoms. In embodiments, organic radicals can contain 1-6 heteroatoms (e.g., O, N, S or P). In specific embodiments, organic radicals include alkyl, alkenyl, alkoxyl (alkyloxy), acyl, alkylamino, dialkylamino, alkylsulfinyl, haloalkyl and fluoroalkyl groups having 1-6 or 1-3 carbon atoms. In specific embodiments, organic radicals include aryl, alkylaryl, cycloalkyl, heterocyclic, and heteroaryl groups having 3-20 carbon atoms (or 3-10 or 6-10 carbon atoms and up to 4 heteroatoms. Monovalent organic radicals are optionally substituted as described herein. In embodiments, alkyl, alkoxy, haloalkyl, fluoroalkyl, and alkylthio groups have 1-3 carbon atoms and are optionally substituted. In embodiments, alkenyl and alkynyl groups have 2-4 carbon atoms and are optionally substituted. In embodiments, each R₁, each R₂, each R₃ and each R₄ of any polymer structure herein (e.g., Structure 1 or 2), can independently, be a monovalent organic radical.

Additional examples of monovalent organic radicals formally obtained by the removal of a hydrogen atom from an oligomeric or polymeric chain made by repeating one or more monomers selected from glycols, ethers, fluoroethers, olefins, fluoroolefins, acrylates and methacrylates, vinyl groups alkynes, esters, amino acids, lactones and lactams, urethanes, epoxies, hydroxyacids, dienes, chloroolefins, diols, diamines, polyamines, groups containing acrylates or methacrylates, groups containing esters, ethers, hydroxyls, epoxies or amines, epoxidized groups, ring-opened epoxy groups, polyglycols, polyethylene glycol, polyethers, poly(fluoroethers), polyacetals, polyenes, polyolefins, polystyrene and its copolymers, polyfluoroolefins, polyoxides, polychloroolefins, polychlorofluoroolefins, polysiloxanes, polyesters, polybromoesters, natural and synthetic rubbers, polyacids, polycarbonates, polyanhydrides, polysulfides, polyamides, polyamines, polyimides, vinyl polymers, polymers derived from the polymerization of unsaturated monomers, polyacrylates, polymethacrylates, polyacrylonitrile and its copolymers, polybutadiene and its copolymers, alkyds, polyols, polyalcohols, polyurethanes, epoxies, cellulose and its derivatives, starch and its derivatives, polypeptides, oligonucleotides, nucleotides, oligosaccharides, polysaccharides, and combinations and copolymers thereof. One or more carbons of an organic radical are optionally substituted.

A bivalent organic radical is a radical formally obtained by the removal of two hydrogen atoms from an organic molecule, oligomer or polymer. Non limiting examples of divalent organic radicals include —(CH₂)ₙ— (where in embodiments n ranges from 1-20), alkylenes, arylenes, optionally substituted alkylene, methylene, linear alkylene, cyclic alkylene groups, alkenylene, and arylene groups, optionally substituted ether or polyether groups, optionally substituted thioether or polythioether groups. In general, a bivalent organic radical can contain any number of carbon atoms. In embodiments, bivalent organic radicals contain 1-100, 1-50, 1-20, 1-10, 1-6 or 1-3 carbon atoms. In embodiments, bivalent organic radicals can contain 1-6 heteroatoms (e.g., O, N, S or P). In embodiments, a bivalent organic radical links a monovalent organic radical to another moiety herein. For example, any one of variables R₁, R₂, R₃ or R₄ of the Structures herein (particularly Structures 1 and 2) can independently be an organic radical linked to the Structure through a bivalent organic radical linker.

Bivalent (or divalent) organic radicals also include species formally resulting from removing two hydrogen atoms from an oligomer or a polymer chain made by repeating one or more monomers selected from glycols, ethers, fluoroethers, olefins, fluoroolefins, acrylates and methacrylates, vinyl groups alkynes, esters, amino acids, lactones and lactams, urethanes, epoxies, hydroxyacids, dienes, chloroolefins, diols, diamines, polyamines, groups containing acrylates or methacrylates, groups containing esters, ethers, hydroxyls, epoxies or amines, epoxidized groups, ring-opened epoxy groups, polyglycols, polyethylene glycol, polyethers, poly(fluoroethers), polyacetals, polyenes, polyolefins, polystyrene and its copolymers, polyfluoroolefins, polyoxides, polychloroolefins, polychlorofluoroolefins, polysiloxanes, polyesters, polybromoesters, natural and synthetic rubbers, polyacids, polycarbonates, polyanhydrides, polysulfides, polyamides, polyamines, polyimides, vinyl polymers, polymers derived from the polymerization of unsaturated monomers, polyacrylates, polymethacrylates, polyacrylonitrile and its copolymers, polybutadiene and its copolymers, alkyds, polyols, polyalcohols, polyurethanes, epoxies, cellulose and its derivatives, starch and its derivatives, polypeptides, oligonucleotides, nucleotides, oligosaccharides, polysaccharides, and combinations and copolymers thereof.

Chemical nomenclature used herein is generally well understood in the art. In embodiments, the term carbocyclic (carbocyclyl) refers to a chemical moiety (e.g., a mono or bivalent radical) having at least one ring structure that is composed entirely of carbon atoms and wherein the at least one ring is saturated, unsaturated and/or aromatic ring. In contrast, heterocyclic (heterocyclyl) refers generally to chemical moiety having at least one ring structure that contains an atom other than carbon in the ring, i.e., a heteroatom (e.g., N, S, P, etc.) and wherein the at least one ring is saturated, unsaturated and/or aromatic ring. In embodiments, carbocyclic moieties can contain from 3-20 carbon atoms and 1-3 rings which can include fused or non-fused rings. In embodiments, carbocyclic rings can contain 3-10 carbon atoms or 3-6 carbon atoms or 5 or 6 carbon atoms. In embodiments, carbocyclic groups are optionally substituted. In embodiments, heterocyclic moieties can contain from 3-20 carbon atoms and 1-6 heteroatoms and 1-3 rings which can include fused or non-fused rings. In embodiments, heterocyclic rings can contain 2-10 carbon atoms or 2-6 carbon atoms or 3 or 5 carbon atoms and 1 to 3 heteroatoms. In embodiments, heterocyclic groups are optionally substituted. The term aryl refers to a moiety containing at least one aromatic ring. In embodiments, aryl rings can contain 3-20 carbon atoms and 1-3 rings of which at least one is aromatic. In embodiments, an aromatic ring contains one or more 5 or 6-member carbon ring which may be fused. The term heteroaryl refers to a moiety containing at least one aromatic ring that also contains at least one heteroatom in the ring. In embodiments, heteroaryl rings can contain 3-20 carbon atoms and 1-3 rings of which at least one is aromatic. In embodiments, a heteroaromatic ring contains one or more 5 or 6-member carbon ring which may be fused. Exemplary aryl groups include among others phenyl, biphenyl, naphthyl, indenyl, each of which is optionally substituted. Exemplary heteroaryl groups include among others, furanyl, pyrrolyl, thiophenyl, thiazolyl, pyridinyl, pyridazinyl, pyrimidinyl, pyrazinyl, indolyl, each of which is optionally substituted.

As to any of the above groups which contain one or more substituents, it is understood, that such groups do not contain any substitution or substitution patterns which are sterically impractical and/or synthetically non-feasible. In addition, the compounds of this invention include all stereochemical isomers arising from the substitution of these compounds.

Polymers and copolymers of the invention may contain chemical groups (acidic or basic groups) that can be in the form of salts. Exemplary acid addition salts include acetates (such as those formed with acetic acid or trihaloacetic acid, for example, trifluoroacetic acid), adipates, alginates, ascorbates, aspartates, benzoates, benzenesulfonates, bisulfates, borates, butyrates, citrates, camphorates, camphorsulfonates, cyclopentanepropionates, digluconates, dodecylsulfates, ethanesulfonates, fumarates, glucoheptanoates, glycerophosphates, hemisulfates, heptanoates, hexanoates, hydrochlorides (formed with hydrochloric acid), hydrobromides (formed with hydrogen bromide), hydroiodides, 2-hydroxyethanesulfonates, lactates, maleates (formed with maleic acid), methanesulfonates (formed with methanesulfonic acid), 2-naphthalenesulfonates, nicotinates, nitrates, oxalates, pectinates, persulfates, 3-phenylpropionates, phosphates, picrates, pivalates, propionates, salicylates, succinates, sulfates (such as those formed with sulfuric acid), sulfonates (such as those mentioned herein), tartrates, thiocyanates, toluenesulfonates such as tosylates, undecanoates, and the like. Exemplary basic salts include ammonium salts, alkali metal salts such as sodium, lithium, and potassium salts, alkaline earth metal salts such as calcium and magnesium salts, salts with organic bases (for example, organic amines) such as benzathines, dicyclohexylamines, hydrabamines [formed with N, N-bis(dehydro-abietyl)ethylenediamine], N-methyl-D-glucamines, N-methyl-D-glucamides, t-butyl amines, and salts with amino acids such as arginine, lysine and the like. Basic nitrogen-containing groups may be quaternized with agents such as lower alkyl halides (e.g., methyl, ethyl, propyl, and butyl chlorides, bromides and iodides), dialkyl sulfates (e.g., dimethyl, diethyl, dibutyl, and diamyl sulfates), long chain halides (e.g., decyl, lauryl, myristyl and stearyl chlorides, bromides and iodides), aralkyl halides (e.g., benzyl and phenethyl bromides), and others.

Compounds of the present invention, and salts thereof, may exist in their tautomeric form, in which hydrogen atoms are transposed to other parts of the molecules and the chemical bonds between the atoms of the molecules are consequently rearranged. It should be understood that all tautomeric forms, insofar as they may exist, are included within the invention.

Additionally, compounds useful in this invention may have trans and cis isomers and may contain one or more chiral centers, therefore exist in enantiomeric and diastereomeric forms. The invention includes all such isomers, as well as mixtures of cis and trans isomers, mixtures of diastereomers and racemic mixtures of enantiomers (optical isomers). When no specific mention is made of the configuration (cis, trans or R or S) of a compound (or of an asymmetric carbon), then any one of the isomers or a mixture of more than one isomer is intended. The processes for preparation can use racemates, enantiomers, or diastereomers as starting materials. When enantiomeric or diastereomeric products are prepared, they can be separated by conventional methods, for example, by chromatographic or fractional crystallization. The inventive compounds may be in the free or hydrate form. With respect to the various compounds of the invention, the atoms therein may have various isotopic forms, e.g., isotopes of hydrogen include deuterium and tritium. All isotopic variants of compounds of the invention are included within the invention and particularly included at deuterium and 13C isotopic variants. It will be appreciated that such isotopic variants may be useful for carrying out various chemical and biological analyses, investigations of reaction mechanisms and the like. Methods for making isotopic variants are known in the art.

In one aspect, the invention provides a method of producing polymers and copolymers from alpha-hydroxycarbonyl compounds and their dimers, the method comprising a condensation polymerization conducted in the presence of a Lewis acid catalyst substantially without solvent for at least a portion of the reaction time. In embodiments, the polymerization is conducted in the presence of a Lewis acid catalyst substantially without solvent for at least 30 min. In embodiments, vacuum is applied to generate sub-ambient reaction pressure and remove water generated during reaction. In embodiments, the reaction pressure is less than 150 torr. In embodiments, the reaction is conducted under application of vacuum to generate a sub-ambient reaction pressure. In embodiments, the level of vacuum applied to the reaction is varied over the course of the reaction to change the reaction pressure. In embodiments, the temperature of the polymerization reaction ranges from 35° C. to 100° C. In embodiments, the temperature of the polymerization reaction ranges from 50° C. to 100° C. In embodiments, the temperature of the polymerization reaction ranges from 65° C. to 100° C. In embodiments, the temperature of the reaction is conducted in steps at different temperatures, for example, at a first reaction temperature followed by a step at a second reaction temperature. In embodiments, the first reaction temperature is lower than the second reaction temperature. In embodiments, the alpha-hydroxycarbonyl compound is a glycolaldehyde dimer. In embodiments, the alpha-hydroxycarbonyl compound is DHDO. In embodiments, the Lewis acid catalyst is an anhydrous salt of aluminum, bismuth, or iron. In embodiments, the Lewis acid catalyst is an anhydrous salt of indium or copper. In embodiments, the Lewis acid catalyst counter anion is an alkylsulfonate, a haloalkylsulfonate, a fluoroalkylsulfonate, an arylsulfonate, a haloarylsulfonate or a fluoroarylsulfonate. In embodiments, the Lewis acid catalyst counter anion is trifluoromethanesulfonate (triflate), benzylsulfonate, toluenesulfonate (tosylate) or methanesulfonate (mesylate). In embodiments, the Lewis acids catalyst counter ion is chloride, bromide, nitrate or acetate. In embodiments, the polymer produced is PDHDO or M-PDHDO. In embodiments, the one or more monomer is glycolaldehyde dimer. In embodiments, the one or more monomer is one or more of 2,5-dihydroxy-1,4-dioxane; (1,2-hydroxyethoxy) acetaldehyde; 2-(hydroxymethyl)-1,3-dioxolan-4-ol; 1,1′-oxydi (ethane-1,2-diol); 2,2′-oxydi (ethane-1,1-diol); (1,3-dioxetane-2,4-diyl)dimethanol; or 2,2′-oxydiacetaldehyde. In embodiments, the monomer is 2,5-dihydroxy-1,4-dioxane (DHDO).

In a second aspect, the reaction is conducted in the presence of a Lewis acid catalyst in the absence of added solvent. In embodiments, the polymerization is conducted in the presence of a Lewis acid catalyst in the absence of solvent for at least 30 min. In embodiments, vacuum is applied to generate sub-ambient reaction pressure and remove water generated during reaction. In embodiments, the reaction pressure is less than 150 torr. In embodiments, the reaction pressure is 1 torr or less. In embodiments, vacuum is applied to generate sub-ambient reaction pressure and remove water generated during reaction. In embodiments, the reaction pressure is less than 150 torr. In embodiments, the reaction is conducted under application of vacuum to generate a sub-ambient reaction pressure. In embodiments, the level of vacuum applied to the reaction is varied over the course of the reaction to change the reaction pressure. In embodiments, the temperature of the polymerization reaction ranges from 35° C. to 100° C. In embodiments, the temperature of the polymerization reaction ranges from 50° C. to 100° C. In embodiments, the temperature of the polymerization reaction ranges from 65° C. to 100° C. In embodiments, the temperature of the reaction is conducted in steps at different temperatures, for example, at a first reaction temperature followed by a step at a second reaction temperature. In embodiments, the first reaction temperature is lower than the second reaction temperature. In embodiments, the alpha-hydroxycarbonyl compound is a glycolaldehyde dimer. In embodiments, the alpha-hydroxycarbonyl compound is DHDO. In embodiments, the Lewis acid catalyst is an anhydrous salt of aluminum, bismuth, or iron. In embodiments, the Lewis acid catalyst is an anhydrous salt of indium or copper. In embodiments, the Lewis acid catalyst counter anion is an alkylsulfonate, a haloalkylsulfonate, a fluoroalkylsulfonate, an arylsulfonate, a haloarylsulfonate or a fluoroarylsulfonate. In embodiments, the Lewis acid catalyst counter anion is trifluoromethanesulfonate (triflate), benzylsulfonate, toluenesulfonate (tosylate) or methanesulfonate (mesylate). In embodiments, the Lewis acids catalyst counter ion is chloride, bromide, nitrate or acetate. In embodiments, the polymer produced is PDHDO or M-PDHDO. In embodiments, the one or more monomer is glycolaldehyde dimer. In embodiments, the one or more monomer is one or more of 2,5-dihydroxy-1,4-dioxane; (1,2-hydroxyethoxy) acetaldehyde; 2-(hydroxymethyl)-1,3-dioxolan-4-ol; 1,1′-oxydi (ethane-1,2-diol); 2,2′-oxydi (ethane-1,1-diol); (1,3-dioxetane-2,4-diyl)dimethanol; or 2,2′-oxydiacetaldehyde. In embodiments, the monomer is 2,5-dihydroxy-1,4-dioxane (DHDO).

In a third aspect, the reaction includes a step of the polymerization in solvent, followed by one or more steps of concentrating the reaction mixture to remove solvent. In embodiments, the polymerization is conducted in the presence of a Lewis acid catalyst in the absence of solvent for at least 30 min. In embodiments, vacuum is applied to generate sub-ambient reaction pressure and remove solvent and/or water generated during reaction. In embodiments, the reaction pressure is less than 150 torr. In embodiments, the reaction pressure is 1 torr or less. In embodiments, a selected amount of the solvent added to the reaction is removed by application of vacuum. In embodiments, 50% or more or optionally 60%, 70%, 80%, 90%, 95%, 99% or more of the solvent is removed in one or more concentration steps. In embodiments, solvent remaining after the one or more concentration step is less than 1% of the original volume of solvent. In embodiments, solvent remaining after the one or more concentration step is less than 0.1% of the original volume of solvent. In embodiments, solvent remaining after the one or more concentration step is less than 1% by weight of the weight of monomers added to the reaction. In embodiments, solvent remaining after the one or more concentration step is less than 0.1% by weight of the weight of monomers added to the reaction. In embodiments, the reaction is conducted under application of vacuum to generate a sub-ambient reaction pressure. In embodiments, the level of vacuum applied to the reaction is varied over the course of the reaction to change the reaction pressure. In embodiments, the temperature of the polymerization reaction ranges from 35° C. to 100° C. In embodiments, the temperature of the polymerization reaction ranges from 50° C. to 100° C. In embodiments, the temperature of the polymerization reaction ranges from 65° C. to 100° C. In embodiments, the temperature of the reaction is conducted in steps at different temperatures, for example, at a first reaction temperature followed by a step at a second reaction temperature. In embodiments, the first reaction temperature is lower than the second reaction temperature. In embodiments, the alpha-hydroxycarbonyl compound is a glycolaldehyde dimer. In embodiments, the alpha-hydroxycarbonyl compound is DHDO. In embodiments, the Lewis acid catalyst is an anhydrous salt of aluminum, bismuth, or iron. In embodiments, the Lewis acid catalyst is an anhydrous salt of indium or copper. In embodiments, the Lewis acid catalyst counter anion is an alkylsulfonate, a haloalkylsulfonate, a fluoroalkylsulfonate, an arylsulfonate, a haloarylsulfonate or a fluoroarylsulfonate. In embodiments, the Lewis acid catalyst counter anion is trifluoromethanesulfonate (triflate), benzylsulfonate, toluenesulfonate (tosylate) or methanesulfonate (mesylate). In embodiments, the Lewis acids catalyst counter ion is chloride, bromide, nitrate or acetate. In embodiments, the polymer produced is PDHDO or M-PDHDO. In embodiments, the one or more monomer is glycolaldehyde dimer. In embodiments, the one or more monomer is one or more of 2,5-dihydroxy-1,4-dioxane; (1,2-hydroxyethoxy) acetaldehyde; 2-(hydroxymethyl)-1,3-dioxolan-4-ol; 1,1′-oxydi (ethane-1,2-diol); 2,2′-oxydi (ethane-1,1-diol); (1,3-dioxetane-2,4-diyl)dimethanol; or 2,2′-oxydiacetaldehyde. In embodiments, the monomer is 2,5-dihydroxy-1,4-dioxane (DHDO).

In further aspects, the various aspects of the methods of the invention provide a polymeric product having a weight average molecular weight (Mw) in excess of 15,000 Dalton. In further aspects, the various aspects of the methods of the invention provide a polymeric product having PDI ranging from 1-10 or more preferably ranging from 1-5. In further aspects, the various aspects of the methods of the invention provide a polymeric product having a weight average molecular weight (Mw) in excess of 15,000 Dalton and having PDI ranging 1-5 or more preferably less than 3. In further aspects, the various aspects of the methods of the invention provide a polymeric product having T95 of 165° C. or higher. In embodiments, the methods provide a polymer having T95 of 190° C. or higher. In embodiments, the methods provide a polymer having T95 of 200° C. or higher. In embodiments, the polymer having T95 of 165° C. or higher is not end-capped. In further aspects, the various aspects of the methods of the invention provide a polymeric product having a weight average molecular weight (Mw) in excess of 15,000 Dalton and having T95 of 165° C. or higher. In further aspects, the various aspects of the methods of the invention provide a polymer having Young's modulus greater than 100 kPa (kilo Pascal) and/or ultimate tensile strength tensile higher than 200 kPa. In further aspects, the various aspects of the methods of the invention provide a polymer having Young's modulus greater than 100 kPa (kilo Pascal) and/or ultimate tensile strength tensile higher than 200 kPa. In further aspects, the various aspects of the methods of the invention provide a polymeric product having a weight average molecular weight (Mw) in excess of 15,000 Dalton and having Young's modulus greater than 100 kPa (kilo Pascal) and/or ultimate tensile strength tensile higher than 200 kPa. In further aspects, the various aspects of the methods of the invention provide a polymeric product having a weight average molecular weight (Mw) in excess of 15,000 Dalton, having Young's modulus greater than 100 kPa (kilo Pascal) and/or ultimate tensile strength tensile higher than 200 kPa, and/or having T95 of 165° C. or higher.

In additional aspects, the invention provides films or molded objects prepared from polymers or copolymer made by the various improved methods herein. In embodiments, the polymers and copolymers employed to prepare the films and molded objects exhibit one or more of the improved mechanical or thermal properties described herein. In embodiments, films or molded object herein have Young's modulus of greater than 0.1 MPa at 20° C. and/or tensile strength at break at 20° C. of greater than 0.05 MPa.

The terms and expressions which have been employed are used as terms de of description and not of limitation, and there is no intention in the use of such terms and expressions of excluding any equivalents of the features shown and described or portions thereof, but it is recognized that various modifications are possible within the scope of the invention claimed. Thus, it should be understood that although this invention has been specifically disclosed by preferred embodiments, exemplary embodiments and optional features, modification and variation of the concepts disclosed may be resorted to by those skilled in the art, and that such modifications and variations are considered to be within the scope of this invention as defined by the claims. The specific embodiments provided are examples of useful embodiments of the invention and it will be apparent to one skilled in the art that the invention may be carried out using a large number of variations of the devices, device components, methods steps set forth in the description.

As used in this specification and in the appended claims, the singular forms “a”, “an”, and “the” include plural references unless the context clearly dictates otherwise. Also, the terms “a” (or “an”), “one or more” and “at least one” can be used interchangeably. It is also to be noted that the terms “comprising”, “including”, and “having” can be used interchangeably. The expression “of any of claims XX—YY” (wherein XX and YY refer to claim numbers) is intended to provide a multiple dependent claim in the alternative form, and in some embodiments is interchangeable with the expression “as in any one of claims XX—YY.”

All references throughout this application, for example patent documents including issued or granted patents or equivalents; patent application publications; and non-patent literature documents or other source material; are hereby incorporated by reference herein in their entireties, as though individually incorporated by reference.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

When a group of substituents is disclosed herein, it is understood that all individual members of those groups and all subgroups, including any isomers and enantiomers of the group members, and classes of compounds that can be formed using the substituents are disclosed separately. When a compound is claimed, it should be understood that compounds known in the art including the compounds disclosed in the references disclosed herein are not intended to be included. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination.

One of ordinary skill in the art will appreciate that methods, device elements, starting materials, synthetic methods, characterization and analytical methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention.

### THE EXAMPLES

### Example 1. Polymerization of 2,5-dihydroxy-1,4-dioxane (DHDO) with molecular sieves and a catalytic amount of Ytterbium Triflate Yb(OTf)₃ in acetonitrile (MeCN) under partial reflux

Under N₂ environment, 70 mL of acetonitrile was added to a 100 mL round bottom flask (rbf) followed by Yb(OTf)₃ (0.26 g, 0.4 mmol, 0.05 equival. with respect to DHDO), and DHDO (1.0 g, 8.3 mmol). The flask was then quickly connected to a Soxhlet apparatus with 3 Å molecular sieves in the thimble cup (filled ~75% by vol.). The Soxhlet extractor was connected via a two-way manifold to a J-KEM scientific digital vacuum regulator with the regulator set to 105 torr. The regulator was connected to a Maxima C Plus high vacuum pump (Fisher Scientific). The mixture was then heated with agitation to 40° C., at which time reflux was observed. The mixture was allowed to reflux through the Soxhlet for 19 hours. During the overnight reflux, the solvent slowly evaporated to dryness and the reaction then continued in the absence of solvent. The mixture was then cooled to room temperature. Water (25 mL) was added, the water was decanted, and then the residue was dried in vacuo in a rotary evaporator overnight to give a white solid (0.14 g; 16.5% yield).

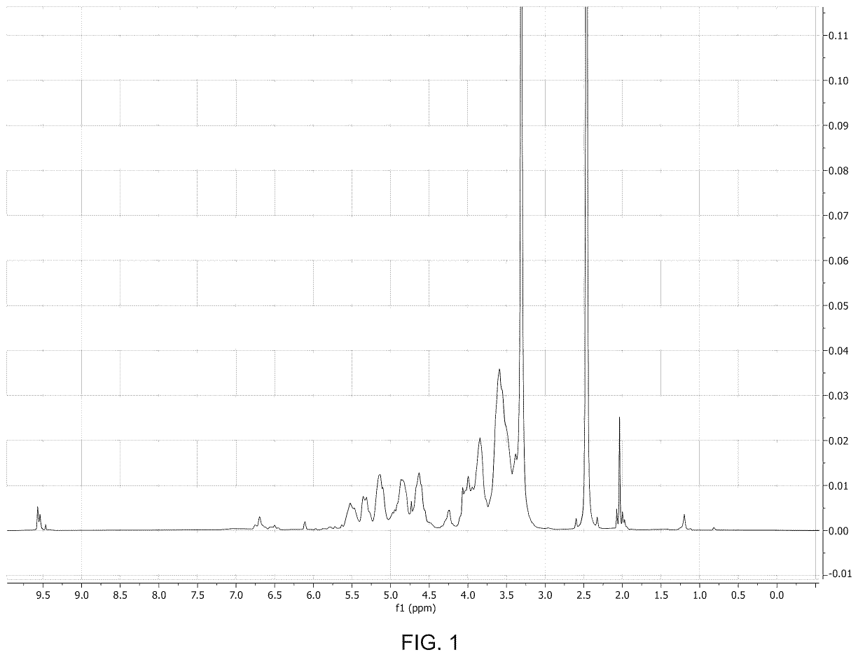

Gel Permeation Chromatography (GPC) analysis was carried out on this product in N,N-dimethylformamide (DMF) solvent containing 0.05M LiBr using a Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was 7,654 Dalton and the Weight Average Molecular Weight (Mw) was 12,692 Dalton. The polydispersity index (PDI) was 1.66. The 1H-NMR spectrum of the product is shown in FIG. 1.

### Example 2. Polymerization of 2,5-Dihydroxy-1,4-Dioxane (DHDO) with Molecular Sieves and a Catalytic Amount of Aluminum Triflate Al(OTf)₃ in MeCN Under Reflux. Solution Polymerization Conditions Employing a Soxhlet Extractor and Molecular Sieves

Under N₂ environment, 70 mL of MeCN was added to a 100 mL rbf followed by Al(OTf)₃ (0.59 g, 1.3 mmol, 0.05 equival. with respect to DHDO), and DHDO (3.0 g, 25 mmol). The flask was then quickly connected to a Soxhlet apparatus with 3 Å molecular sieves in the thimble cup (filled ~75%). The Soxhlet extractor was connected via a two-way manifold to a J-KEM scientific digital vacuum regulator with the regulator set to 80 torr. The regulator was connected to a Maxima C Plus high vacuum pump (Fisher Scientific). The mixture was then heated to 40° C. at which time reflux was observed. The mixture was allowed to reflux through the Soxhlet for 19 hours. The mixture was then cooled to room temperature and concentrated using a rotary evaporator. Water (50 mL) was added, and the mixture was vortexed for a few minutes after which 50 mL of dichloromethane (DCM) was added. The layers were separated and the aqueous layer was extracted with 2×50 mL of DCM. The organic layers were combined, dried (MgSO₄), and concentrated in vacuo then dried under high vacuum overnight to give a white solid (2.0 g, 78% yield).

GPC analysis was carried out on this product in tetrahydrofuran (THF) solvent using a Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was 1,191 Dalton and the Weight Average Molecular Weight (Mw) was 2,535 Dalton. The polydispersity index (PDI) was 2.13.

### Example 3. Polymerization of 2,5-Dihydroxy-1,4-Dioxane (DHDO) with Molecular Sieves and a Catalytic Amount of Aluminum Triflate Al(OTf)₃ in Propionitrile Under Reflux (Solution Polymerization Conditions with Soxhlet and Molecular Sieves)

Under N₂ environment, 70 mL of propionitrile (EtCN) was added to a 100 mL rbf followed by Al(OTf)₃ (0.59 g, 1.3 mmol), and DHDO (3.0 g, 25 mmol). The flask was then quickly connected to a Soxhlet apparatus with 3 Å molecular sieves in the thimble cup (filled ~75%). The Soxhlet extractor was connected via a two-way manifold to a J-KEM scientific digital vacuum regulator with the regulator set to 30 torr. The regulator was connected to a Maxima C Plus high vacuum pump (Fisher Scientific). The mixture was then heated to 40° C. at which time reflux was observed. The mixture was allowed to reflux through the Soxhlet for 19 hours. The mixture was then cooled to room temperature and concentrated in vacuo. Water (50 mL) was added, and the mixture was vortexed for a few minutes before 50 mL of DCM was added. The layers were separated and the aqueous phase was extracted with 2×50 mL of DCM. The organic layers were combined, dried (MgSO4), and concentrated in vacuo then dried under high vacuum overnight to give an off-white solid (1.9 g, 75% yield).

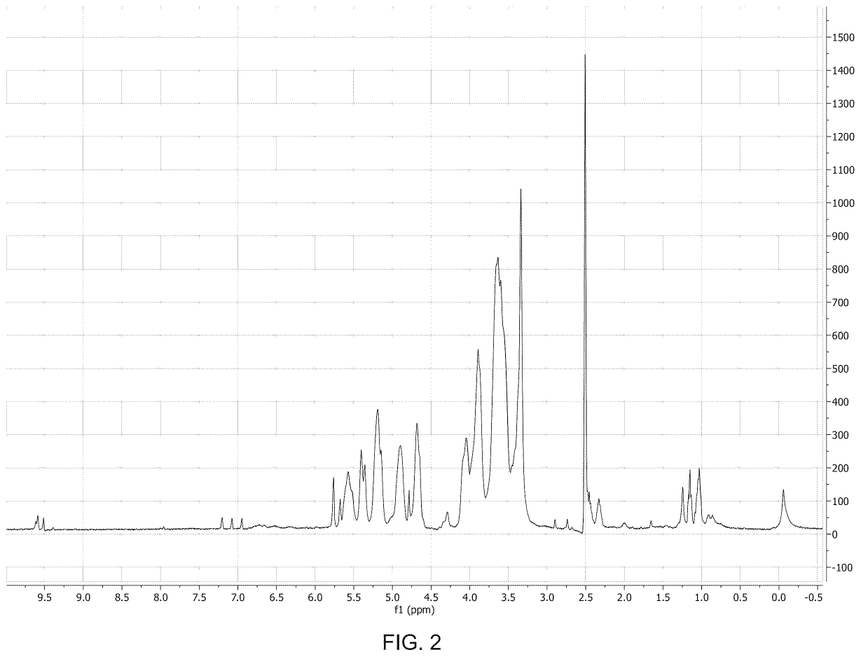

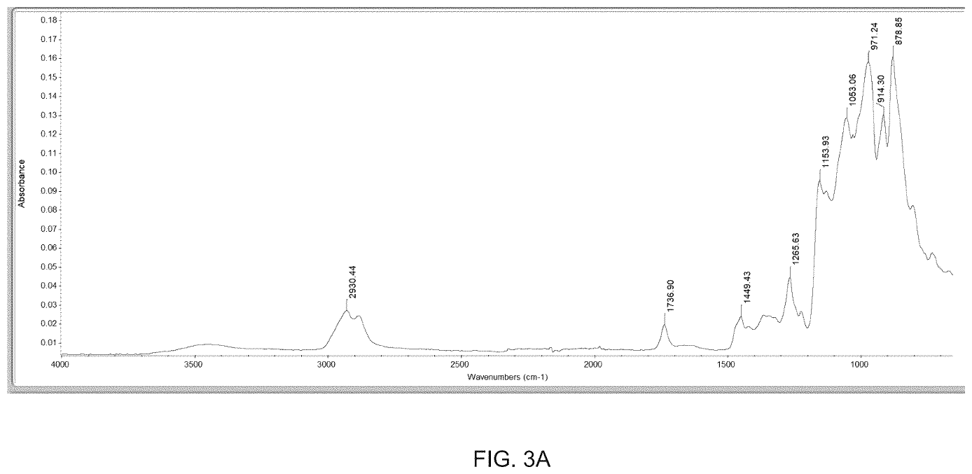

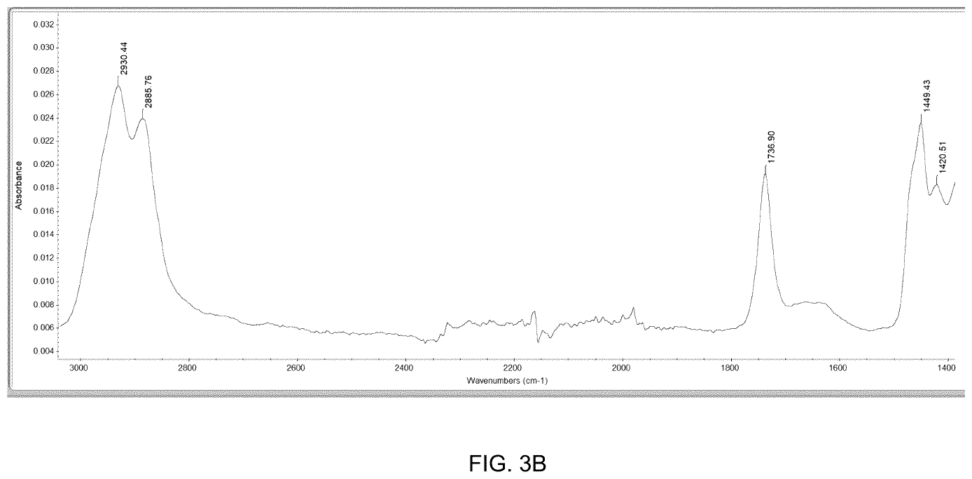

GPC analysis was carried out on this product dissolved in DMF containing 0.05M LiBr using a Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was 9,130 Dalton and the Weight Average Molecular Weight (Mw) was 19,900 Dalton. The polydispersity index (PDI) was 2.18. The FT-IR spectrum of the material was collected on neat powder material with a Nicolet 510 Fourier Transform Infrared Spectrometer (FTIR) equipped with Attenuated Total Reflectance (ATR) and is shown in FIG. 2 IR vₘₐₓ/cm⁻¹ (film): 2930, 1736, 1449, 1265 cm⁻¹. The ¹H-NMR of this polymer is provided in FIG. 3.

Polymer (200 mg) was dissolved in 1 mL of hexafluoroisopropanol. Sonication (30 sec) was used to speed up dissolution. The solution was cast on a Teflon® (The Chemours Company FC, LLC, Delaware) polyfluoropolymer block and allowed to dry 15 days at room temperature in air. The film was removed from the block and cut into 2 mm wide strips. Tensile testing was performed at room temperature (20° C.) on the strips using a RSA-G2 instrument (TA Instruments, New Castle, DE). Young's modulus was measured as 2.2 MPa (2,200 kPa), elongation at break was measured as 373% and ultimate tensile strength was measured as 0.24 MPa (240 kPa).

Polymer (200 mg) was dissolved in 2 mL of DCM. Sonication (2×30 sec) was used to speed up dissolution. The solution was allowed to evaporate until 50% of the original volume remained and then a film was cast on a Teflon® fluoropolymer block and allowed to dry 15 days at room temperature in air. The film was removed from the block and cut into 2.75 mm wide by 21.64 mm long strips. The film thickness was 0.15 mm. Tensile pull testing was performed at room temperature (20° C.) using a RSA-G2 instrument (TA instrument) with elongation set at a constant linear rate of 8.0 μm/second. Young's modulus was measured as 2.9 MPa (2,900 kPa), the ultimate tensile strength was measured as 0.40 MPa (400 kPa), and the elongation at break was 333%.

### Example 4. Polymerization of 2,5-Dihydroxy-1,4-Dioxane (DHDO) with Molecular Sieves and a Catalytic Amount of Indium Triflate in(OTf)₃ in Acetonitrile Under Reflux (Solution Polymerization Conditions with Soxhlet and Molecular Sieves)

Under N₂ environment, 70 mL of MeCN was added to a 100 mL rbf followed by In(OTf)₃ (0.70 g, 1.3 mmol, 0.05 equival. with respect to DHDO), and DHDO (3.0 g, 25 mmol). The flask was then quickly connected to a Soxhlet apparatus with 3 Å molecular sieves in the thimble cup (filled ~75%). The Soxhlet extractor was connected via a two-way manifold to a J-KEM scientific digital vacuum regulator with the regulator set to 80 torr. The regulator was connected to a Maxima C Plus high vacuum pump (Fisher Scientific). The mixture was then heated to 40° C. at which time reflux was observed. The mixture was allowed to reflux through the Soxhlet for 19 hours. The mixture was then cooled to room temperature and concentrated in vacuo. Water (50 mL) was added, and the mixture was vortexed a few minutes after which 50 mL of DCM was added. The layers were separated and the aqueous phase was extracted with 2×50 mL of DCM. The organic layers were combined, dried (MgSO₄), and concentrated with the rotary evaporator then dried under high vacuum overnight to give a white solid (1.3 g, 51% yield).

GPC analysis was carried out on this product dissolved in DMF containing 0.05M LiBr using a Waters GPC with an Optilab refractive index detector coupled with Nelson Analytical data collection software. Molecular weights (Mw, Mn, Mz) and distribution of polymers were based on calibration with monodisperse polystyrene standards. The Number Average Molecular Weight (Mn) was measured as 4,004 Dalton and the Weight Average Molecular Weight (Mw) was measured as 6,648 Dalton. The polydispersity index (PDI) was 1.66.

### Example 5. Polymerization of 2,5-Dihydroxy-1,4-Dioxane (DHDO) with Molecular Sieves and a Catalytic Amount of Indium Triflate in(OTf)₃ in Propionitrile Under Reflux (Example of Solution Polymerization with Reverse Work-Up)

Under N₂ environment, 70 mL of EtCN was added to a 100 mL rbf followed by In(OTf)₃ (0.70 g, 1.3 mmol, 0.05 equival. with respect to DHDO), and DHDO (3.0 g, 25 mmol). The flask was then quickly connected to a Soxhlet apparatus with 3 Å molecular sieves in the thimble cup (filled ~75%). The Soxhlet extractor was connected via a two-way manifold to a J-KEM scientific digital vacuum regulator with the regulator set to 60 torr. The regulator was connected to a Maxima C Plus high vacuum pump (Fisher Scientific). The mixture was then heated to 40° C. at which time reflux was observed. The mixture was allowed to reflux through the Soxhlet for 19 hours. The mixture was then cooled to room temperature and concentrated in vacuo. DCM (50 mL) was added, and the mixture was vortexed for a few minutes before 50 mL of water was added. The layers were separated and the aqueous phase was extracted with 2×50 mL of DCM. The organic layers were combined, dried (MgSO₄), and concentrated using a rotary evaporator then dried under high vacuum overnight to give an off-white solid (1.7 g, 67% yield).

GPC analysis was carried out on this product dissolved in DMF solvent containing 0.05M LiBr using Waters GPC with an Optilab refractive index detector coupled with Nelson Analytical data collection software. Molecular weights (Mw, Mn, Mz) and distribution of polymers were based on calibration with monodisperse polystyrene standards. The Number Average Molecular Weight (Mn) was measured 6,650 Dalton and the Weight Average Molecular Weight (Mw) was measured as 10,500 Dalton. The polydispersity index (PDI) was 1.58.

### Example 6. Polymerization of 2,5-Dihydroxy-1,4-Dioxane (DHDO) with Molecular Sieves and a Catalytic Amount of Copper (II) Triflate Cu(OTf)₂ in Propionitrile Under Reflux

Under N₂ environment, 70 mL of EtCN was added to a 100 mL rbf followed by Cu(OTf)₂ (0.45 g, 1.3 mmol, 0.05 equival. with respect to DHDO), and DHDO (3.0 g, 25 mmol). The flask was then quickly connected to a Soxhlet apparatus with 3 Å molecular sieves in the thimble cup (filled ~75%). The Soxhlet extractor was connected via a two-way manifold to a J-KEM scientific digital vacuum regulator with the regulator set to 30 torr. The regulator was connected to a Maxima C Plus high vacuum pump (Fisher Scientific). The mixture was then heated to 40° C. at which time reflux was observed. The mixture was allowed to reflux through the Soxhlet for 19 hours. The mixture was then cooled to room temperature and concentrated in vacuo. Water (50 mL) was added, and the mixture was vortexed for a few minutes before 50 mL of DCM was added. The layers were separated and the aqueous phase was extracted with 2×50 mL of DCM. The organic layers were combined, dried (MgSO₄), and concentrated in vacuo then dried under high vacuum overnight to give an off-white solid (2.0 g, 78% yield).

GPC analysis was carried out on this product dissolved in DMF solvent containing 0.05M LiBr using Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was measured as 8,112 Dalton and the Weight Average Molecular Weight (Mw) was measured as 17,603 Dalton. The polydispersity index (PDI) was 2.17.

### Example 7. Polymerization of 2,5-Dihydroxy-1,4-Dioxane (DHDO) with Molecular Sieves and a Catalytic Amount of Copper (II) Triflate Cu(OTf)₂ in 1,2-Dimethoxyethane Under Reflux

Under N₂ environment, 70 mL of 1,2-Dimethoxyethane was added to a 100 mL rbf followed by Cu(OTf)₂ (0.45 g, 1.3 mmol, 0.05 equival. with respect to DHDO), and DHDO (3.0 g, 25 mmol). The flask was then quickly connected to a Soxhlet apparatus with 3 Å molecular sieves in the thimble cup (filled ~75%). The Soxhlet extractor was connected via a two-way manifold to a J-KEM scientific digital vacuum regulator with the regulator set to 90 torr. The regulator was connected to a Maxima C Plus high vacuum pump (Fisher Scientific). The mixture was then heated to 40° C. at which time reflux was observed. The mixture was allowed to reflux through the Soxhlet for 19 h. The mixture was then cooled to room temperature and concentrated in vacuo. DCM (50 mL) was added, and the mixture was vortexed for a few minutes before 50 ml of water was added. The layers were separated and the aqueous phase was extracted with 2×50 mL of DCM. The organic layers were combined, dried (MgSO₄), and concentrated in vacuo then dried under high vacuum overnight to give an off-white solid (2.0 g, 78% yield).

GPC analysis was carried out on this product dissolved in DMF containing 0.05M LiBr using a Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was measured as 9,170 Dalton and the Weight Average Molecular Weight (Mw) was measured as 23,100 Dalton. The polydispersity index (PDI) was 2.52.

Polymer (200 mg) was dissolved in 2 mL of DCM. Sonication (2×30 sec) was used to speed up dissolution. The solution was allowed to evaporate until 50% of the original volume remained and was then cast on a Teflon® fluoropolymer block and allowed to dry 15 days at room temperature in air. The film was removed from the block and cut into 4.65 mm wide and 13.25 mm long strips. The film thickness was 0.10 mm. Tensile testing was performed at room temperature using a RSA-G2 instrument (TA instrument) with elongation set at a constant linear rate of 11.0 μm/second. Young's modulus was measured as 71.9 MPa (71,900 kPa), the ultimate tensile strength was 0.77 MPa (770 kPa), and elongation at break was 64% and tensile strength was 0.25 MPa (250 kPa).

### Example 8. Polymerization of 2,5-Dihydroxy-1,4-Dioxane (DHDO) with Molecular Sieves and a Catalytic Amount of Copper (II) Tosylate Cu(OTs)₂ in Propionitrile Under Reflux

Under N₂ environment, 70 mL of EtCN was added to a 100 mLrbf followed by Cu(OTs)₂ (0.51 g, 1.3 mmol, 0.05 equival. with respect to DHDO), and DHDO (3.0 g, 25 mmol). The flask was then quickly connected to a Soxhlet apparatus with 3 Å molecular sieves in the thimble cup (filled ~75%). The Soxhlet extractor was connected via a two-way manifold to a J-KEM scientific digital vacuum regulator with the regulator set to 60 torr. The regulator was connected to a Maxima C Plus high vacuum pump (Fisher Scientific). The Soxhlet extractor was connected to vacuum set to 60 torr. The mixture was then heated to 40° C. at which time reflux was observed. The mixture was allowed to reflux through the Soxhlet for 19 h. The mixture was then cooled to room temperature and concentrated in vacuo. DCM (50 mL) was added, and the mixture was vortexed for a few minutes before 50 ml of water was added. The layers were separated and the aqueous phase was extracted with 2×50 mL of DCM. The organic layers were combined, dried (MgSO₄), and concentrated in vacuo then dried under high vacuum overnight to give an off-white solid (0.8 g, 31% yield).

GPC analysis was carried out on this product dissolved in DMF solvent containing 0.05M LiBr using Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was measured as 5,050 Dalton and the Weight Average Molecular Weight (Mw) was measured as 10,300 Dalton. The polydispersity index (PDI) was 2.04.

### Example 9. Polymerization of 2,5-Dihydroxy-1,4-Dioxane (DHDO) with Molecular Sieves and a Catalytic Amount of Ytterbium (III) Triflate Yb(OTf)₃ in 1,2-Dimethoxyethane Under Reflux

Under N₂ environment, 70 mL of 1,2-Dimethoxyethane was added to a 100 mL rbf followed by Yb(OTf)₃ (0.77 g, 1.3 mmol, 0.05 equival. with respect to DHDO), and DHDO (3.0 g, 25 mmol). The flask was then quickly connected to a Soxhlet apparatus with 3 Å molecular sieves in the thimble cup (filled ~75%). The Soxhlet extractor was connected via a two-way manifold to a J-KEM scientific digital vacuum regulator with the regulator set to 90 torr. The mixture was then heated to 40° C. at which time reflux was observed. The mixture was allowed to reflux through the Soxhlet for 19 h. The mixture was then cooled to room temperature and concentrated in vacuo. DCM (50 mL) was added, and the mixture was vortexed for a few minutes before 50 ml of water was added. The layers were separated and the aqueous phase was extracted with 2×50 mL of DCM. The organic layers were combined, dried (MgSO₄), and concentrated in vacuo then dried under high vacuum overnight to give a white solid (1.5 g, 59% yield).

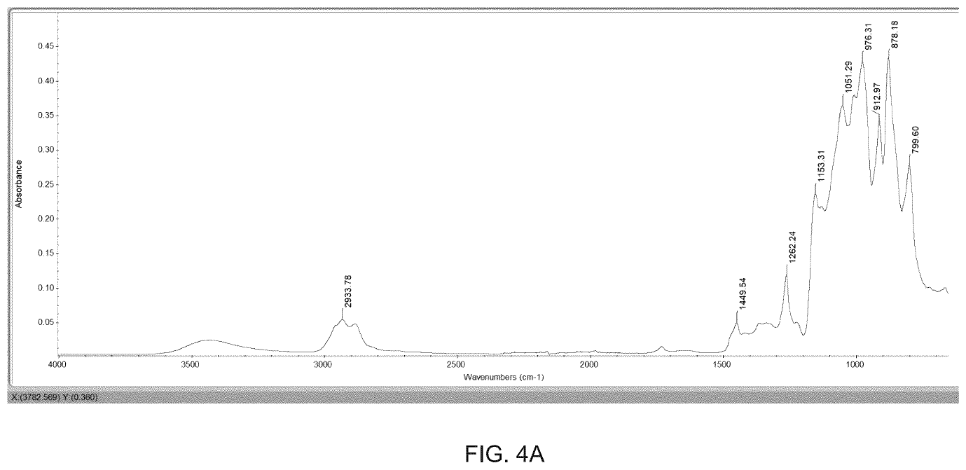

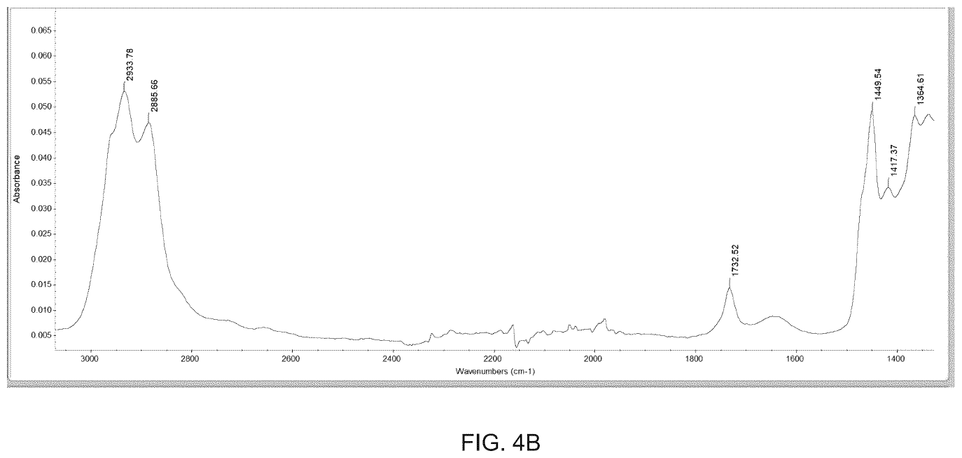

GPC analysis was carried out on this product dissolved in DMF containing 0.05M LiBr using Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was measured as 3,207 Dalton and the Weight Average Molecular Weight (Mw) was measured as 4,604 Dalton. The polydispersity index (PDI) was 1.44. The FT-IR Spectra of the material was collected on neat powder material with a Nicolet 510 Fourier Transform Infrared Spectrometer (FTIR) equipped with Attenuated Total Reflectance (ATR) and is shown in FIG. 4. IR vₘₐₓ/cm⁻¹ (film): 2933, 1732, 1449, 1262.

### Example 10. Polymerization of 2,5-Dihydroxy-1,4-Dioxane (DHDO) with Molecular Sieves and a Catalytic Amount of Aluminum Triflate Al(OTf)₃ in Acetonitrile Under Reduced Pressure with Gradual Solvent Removal (Run Dry Conditions with Sohxlet)

An oven-dried 100 mL rbf, under N₂, was charged with a stir bar and anhydrous MeCN (70 mL) followed by Al(OTf)₃ (0.59 g, 1.3 mmol, 0.05 equival. with respect to DHDO) then DHDO (3.0 g, 25 mmol) and allowed to stir. The flask was then quickly connected to a Sohxlet apparatus with 3 Å mol. sieves in the thimble cup (filled 75%). The Sohxlet extractor was connected to a vacuum line pulling vacuum at a range of 5-20 torr. The mixture was heated to 40° C. and the solvent was allowed to evaporate over 1.5 h. At which point the Sohxlet apparatus and stirbar were removed and flask was connected to a direct vacuum line pulling at a range of 5-20 torr and allowed to sit at 40° C. for 18 hours. The mixture was then cooled to room temperature and quenched with water (25 mL). The mixture was vortexed and sonicated for a few minutes. Then the mixture was diluted with DMC (25 mL). The organic layer was separated, and the aqueous layer was extracted with DMC (3×25 mL). The combined organic phase was washed with brine, dried (MgSO₄), filtered and concentrated in vacuo to provide the compound as a white solid (1.3 g, 51% yield).

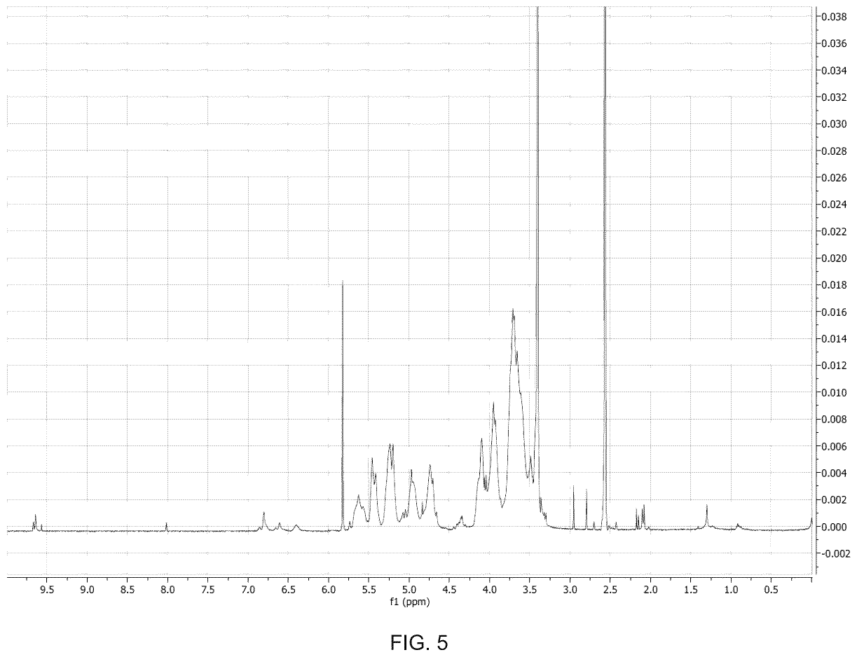

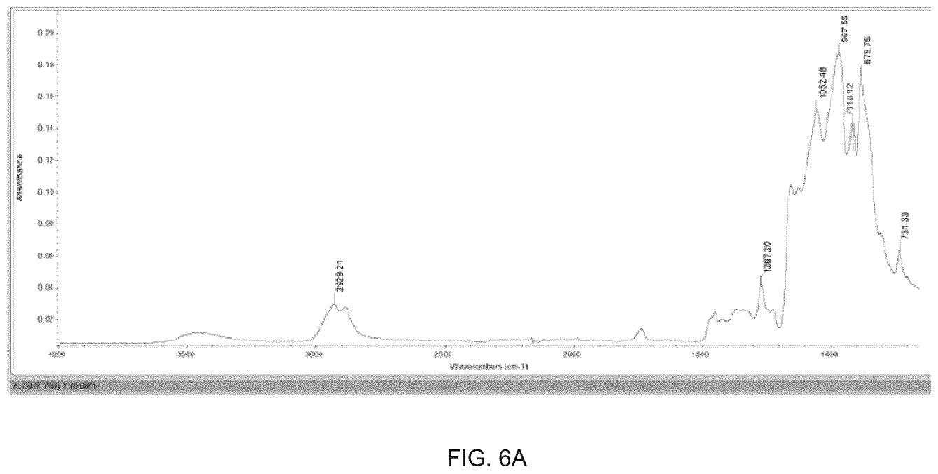

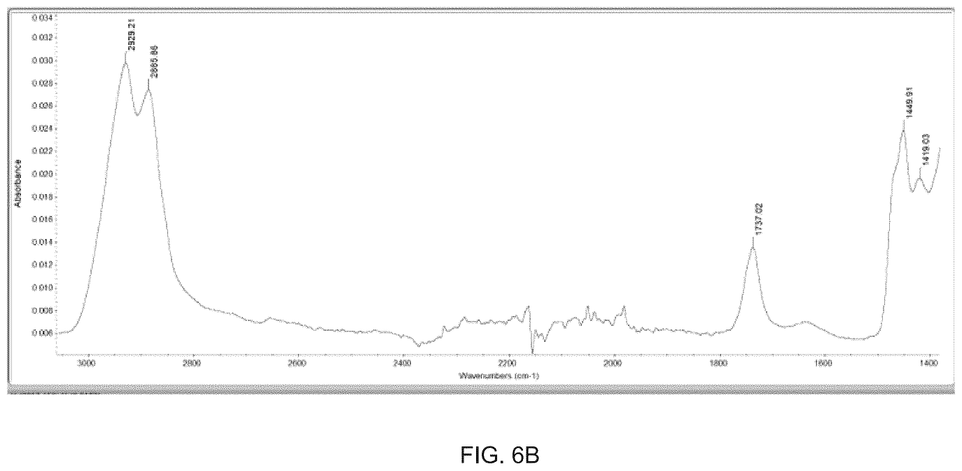

GPC analysis was carried out on this product dissolved in DMF containing 0.05M LiBr using a Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was measured as 9,974 Dalton and the Weight Average Molecular Weight (Mw) was measured as 32,213 Dalton. The polydispersity index (PDI) was 3.23. FIG. 5 and FIG. 6 show the 1H-NMR spectrum and FT-IR spectrum, respectively, of the product. IR vₘₐₓ/cm⁻¹ (film): 2929, 2885, 1737, 1449, 1419, 1267, 1052, 967, 914, 879, 731.

### Example 11. Polymerization of 2,5-Dihydroxy-1,4-Dioxane (DHDO) with Molecular Sieves and a Catalytic Amount of Aluminum Triflate Al(OTf)₃ in Propionitrile Under Reduced Pressure with Gradual Solvent Removal

An oven-dried 100 mL round bottom flask, under N₂, was charged with a stir bar and anhydrous EtCN (70 mL) followed by Al(OTf)₃ (0.59 g, 1.3 mmol) then DHDO (3.0 g, 25 mmol) and allowed to stir. The flask was then quickly connected to a Sohxlet apparatus with 3 Å mol. sieves in the thimble cup (filled 75%). The Sohxlet extractor was connected to a vacuum line pulling at a range of 5-20 torr. The mixture was heated to 40° C. and the solvent was allowed to evaporate over 1.5 h. At which point the Sohxlet apparatus and stirbar were removed and the flask was connected to a direct vacuum line pulling at a range of 5-20 torr and allowed to sit at 40° C. for 18 hours. The mixture was then cooled to room temperature and quenched with water (25 mL). The water-quenched mixture was vortexed and sonicated for a few minutes. Then the mixture was diluted with DMC (25 mL). The organic layer was separated, and the aqueous layer was extracted with DMC (3×25 mL). The combined organic layers were washed with brine, dried (MgSO₄), filtered and concentrated in vacuo to provide a white solid (1.4 g, 55% yield).

GPC analysis was carried out on this product dissolved in DMF containing 0.05M LiBr using a Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was measured as 10,038 Dalton and the Weight Average Molecular Weight (Mw) was measured as 27,977 Dalton. The polydispersity index (PDI) was 2.79.

### Example 12. Polymerization of 2,5-Dihydroxy-1,4-Dioxane (DHDO) with Molecular Sieves and a Catalytic Amount of Copper (II) Triflate Cu(OTf)₂ in Acetonitrile Under Reduced Pressure with Gradual Solvent Removal

An oven-dried 100 mL rbf, under N₂, was charged with a stir bar and anhydrous MeCN (70 mL) followed by Cu(OTf)₂ (0.45 g, 1.3 mmol) then DHDO (3.0 g, 25 mmol) and allowed to stir. The flask was then quickly connected to a Sohxlet apparatus with 3 Å mol. sieves in the thimble cup (filled 75%). The Sohxlet extractor was connected to a high vacuum line pulling at a range of 5-20 torr. The mixture was heated to 40° C. and the solvent was allowed to evaporate over 1.5 h. At which point the Sohxlet apparatus and stirbar were removed and the flask was connected to a direct high vacuum line pulling at a range of 5-20 torr and the reaction was allowed to sit at 40° C. for 18 hours. The mixture was then cooled to room temperature and quenched with water (25 mL). The mixture was vortexed and sonicated for a few minutes. Then the mixture was diluted with DMC (25 mL). The organic layer was separated, and the aqueous layer was extracted with DMC (3×25 mL). The combined organic extracts were washed with brine, dried (MgSO₄), filtered and concentrated in vacuo. to provide the compound as a white solid (1.3 g, 51% yield).

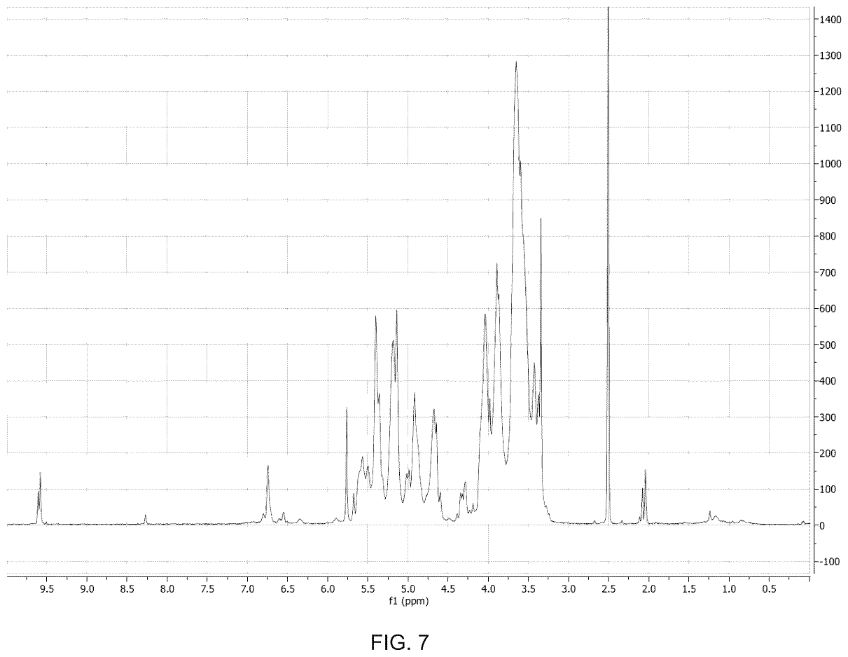

GPC analysis was carried out on this product dissolved in DMF containing 0.05M LiBr using a Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was measured as 5,690 Dalton and the Weight Average Molecular Weight (Mw) was measured as 9,310 Dalton. The polydispersity index (PDI) was 1.64. FIG. 7 shows the 1H-NMR spectrum of the compound. The FT-IR spectrum (Not shown) includes the following bands IR vₘₐₓ/cm⁻¹ (film): 2932, 1268, 1051, 962, 914, 879, 731.

### Example 13. Polymerization of 2,5-Dihydroxy-1,4-Dioxane (DHDO) with a Catalytic Amount of Aluminum Triflate Al(OTf)₃ at 70° C. In the Absence of Solvent

To a 10 mL two-necked rbf equipped with a stir bar was added DHDO (1.0 g, 8.32 mmol). The flask was capped with a septum and the other neck was connected via a two-way manifold to a J-KEM scientific digital vacuum regulator with the regulator set to full vacuum. The regulator was connected to a Maxima C Plus vacuum pump (Fisher Scientific). The reading on the regulator ranged from 1 to 10 torr. The flask was then placed in an oil bath that was heated to 70° C. The flask was held at 70° C. until a clear melting of the DHDO was observed (roughly 10 to 15 minutes). After the DHDO had fully melted, a solution of Al(OTf)₃ (10.0 mg, 0.021 mmol) in 0.1 mL of ACN was added through the septum. The solution immediately bubbled and after stirring for 10 min the solution was rapidly cooled to room temperature using air. Water (5 mL) was added and the water was decanted to give 0.35 g (41% yield) of a clear glassy solid.

### Example 14. Polymerization of 2,5-Dihydroxy-1,4-Dioxane (DHDO) with a Catalytic Amount of Aluminum Sulfate Al₂ (SO₄)₃ at 70° C. In the Absence of Solvent

To a 20 mL vial equipped with a stir bar was added DHDO (1.0 g, 8.32 mmol) and Al₂ (SO₄)₃ (0.08 mmol, 1 mol %). The vial was connected using a vacuum adapter and a two-way manifold to a J-KEM scientific digital vacuum regulator with the regulator set to full vacuum. The regulator was connected to a Fisherbrand Maxima C Plus. The reading on the regulator ranged from 1 to 10 torr. The flask was then placed in an oil bath that was heated to 70° C. The flask was held at 70° C. with stirring until a clear melting of the DHDO was observed (roughly 5 minutes). After an additional 5 minutes, the solution was rapidly cooled to room temperature using air. DCM (5 mL) and water (5 mL) were added and then decanted to give (0.32 g, 38% yield) of a gummy solid.

GPC analysis was carried out on this product dissolved in DMF containing 0.05M LiBr using a Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was measured as 2,530 Dalton and the Weight Average Molecular Weight (Mw) was measured as 3,660 Dalton. The polydispersity index (PDI) was 1.45.

### Example 15 Polymerization of 2,5-Dihydroxy-1,4-Dioxane (DHDO) with Molecular Sieves and a Catalytic Amount of Aluminum Triflate Al(OTf)₃ in Propionitrile Under Reduced Pressure with Gradual Solvent Removal with Water-Free Workup

An oven-dried 100 mL rbf, under N₂, was charged with a stir bar and anhydrous EtCN (70 mL) followed by Al(OTf)₃ (0.59 g, 1.3 mmol) then DHDO (3.0 g, 25 mmol) and allowed to stir. The flask was then quickly connected to a Sohxlet apparatus with 3 Å molecular sieves in the thimble cup (filled 75%). The Sohxlet extractor was connected to a vacuum line pulling at a range of 5-20 torr. The mixture was heated to 40° C. and the solvent was allowed to evaporate over 1.5 h. At which point, the Sohxlet apparatus and stirbar were removed and flask was connected to a direct high vacuum line pulling at a range of 5-20 torr and allowed to sit at 40° C. for 18 h. The mixture was then cooled to room temperature and DMC (40 mL) was added. The mixture was vortexed and sonicated for a few minutes before filtering over a frit. The filtrate was set aside while the solid material retentate was concentrated in a rotary evaporator then redissolved in 25 mL of DMC. This redissolution and filtration process (solid extraction) was repeated two more times. All of the filtrates were combined and concentrated in a rotary evaporator to provide a white solid (1.5 g, 59% yield).

### Example 16. Polymerization of 2,5-Dihydroxy-1,4-Dioxane (DHDO) with Molecular Sieves and a Catalytic Amount of Aluminum Triflate Al(OTf)₃ in Propionitrile Under Reduced Pressure with Gradual Solvent Removal with Water-Free and Non-Chlorinated Workup

An oven-dried 100 mL rbf, under N₂, was charged with a stir bar and anhydrous EtCN (70 mL) followed by Al(OTf)₃ (0.59 g, 1.3 mmol) then DHDO (3.0 g, 25 mmol) and allowed to stir. The flask was then quickly connected to a Sohxlet apparatus with 3 Å molecular sieves in the thimble cup (filled 75%). The Sohxlet extractor was connected to a vacuum line pulling at a range of 5-20 torr. The mixture was heated to 40° C. and the solvent was allowed to evaporate over 1.5 h. At which point the Sohxlet apparatus and stirbar were removed and flask was connected to a direct high vacuum line pulling at full vacuum and allowed to sit at 40° C. for 18 hours. The mixture was then cooled to room temperature and ethyl acetate (EtOAc, 40 mL) was added. The mixture was vortexed and sonicated for a few minutes before filtering over a frit. The filtrate was set aside while the solid material retentate was concentrated in vacuo then redissolved in 25 mL of EtOAc. This filtration and redissolving process was repeated two more times. All of the filtrates were combined and concentrated in vacuo to provide the compound as a white solid (1.5 g, 59% yield).

### Example 17. Polymerization of 2,5-Dihydroxy-1,4-Dioxane (DHDO) with Molecular Sieves and a Catalytic Amount of Aluminum Triflate Al(OTf)₃ in 1,2-Dimethoxyethane Under Reduced Pressure with Gradual Solvent Removal

An oven-dried 100 mL rbf, under N₂, was charged with a stir bar and anhydrous 1,2-Dimethoxyethane (70 mL) followed by Al(OTf)₃ (0.59 g, 1.3 mmol) then DHDO (3.0 g, 25 mmol) and allowed to stir. The flask was then quickly connected to a Sohxlet apparatus with 3 Å molecular sieves in the thimble cup (filled 75%). The Sohxlet extractor was connected to a vacuum line pulling at a range of 5-20 torr. The mixture was heated to 40° C. and the solvent was allowed to evaporate over 1.5 h. At which point the Sohxlet apparatus and stirbar were removed and the flask was connected to a direct vacuum line pulling at a range of 5-20 torr and allowed to sit at 40° C. for 18 h. The mixture was then cooled to room temperature and quenched with water (25 mL).

The mixture was vortexed and sonicated for a few minutes. Then the mixture was diluted with DMC (25 mL). The organic layer was separated, and the aqueous layer was extracted with DMC (3×25 mL). The combined organic extracts were washed with brine, dried (MgSO₄), filtered and concentrated in vacuo. to provide the compound as a white solid.

### Example 18. Polymerization of 2,5-Dihydroxy-1,4-Dioxane (DHDO) with a Catalytic Amount of Aluminum Triflate Al(OTf)₃ in Acetonitrile Under Reduced Pressure with Gradual Solvent Removal

An oven-dried 100 mL rbf, under N₂, was charged with a stir bar and anhydrous MeCN (70 mL) followed by Al(OTf)₃ (0.59 g, 1.3 mmol) then DHDO (3.0 g, 25 mmol) and allowed to stir. The flask was then quickly connected to a vacuum line pulling at a range of 5-20 torr. The mixture was heated to 40° C. and the solvent was allowed to evaporate for 18 hours. The mixture was then cooled to room temperature and quenched with water (25 mL). The mixture was vortexed and sonicated for a few minutes. Then the mixture was diluted with DMC (25 mL). The organic layer was separated, and the aqueous layer was extracted with DMC (3×25 mL). The combined organic extracts were washed with brine, dried (MgSO₄), filtered and concentrated with a rotary evaporator to provide a white solid (1.2 g, 47% yield).

GPC analysis was carried out on this product dissolved in DMF containing 0.05M LiBr using a Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was measured as 8,505 Dalton and the Weight Average Molecular Weight (Mw) was measured as 31,394 Dalton. The polydispersity index (PDI) was 3.69. IR vₘₐₓ/cm⁻¹ (film): 2942, 1288, 1223, 1154, 1025, 972, 914, 879, 733.

Polymer (200 mg) was dissolved in 2 mL of DMC. Sonication (2×30 sec) was used to speed up dissolution. The solution was allowed to evaporate to 50% of the original solvent volume and was then poured into a Teflon® (The Chemours Company FC, LLC, Delaware) fluoropolymer mold and allowed to evaporate for 20 minutes, then additional solution was added multiple times until the mold was full. The material was dried 15 days at room temperature in air. The film was removed from the mold and cut into a 3.32 mm wide and 14.50 mm long strip. The film thickness was 0.365 mm. Tensile testing was performed at room temperature (20° C.) using a RSA-G2 instrument (TA Instruments). Elongation was done at a constant linear rate of 12.0 μm/sec. Young's modulus was measured as 5.6 MPa (5,600 kPa).

### Example 19. Polymerization of 2,5-Dihydroxy-1,4-Dioxane (DHDO) with a Catalytic Amount of Aluminum Triflate Al(OTf)₃ in Acetonitrile Under Reduced Pressure with Gradual Solvent Removal

An oven-dried 100 mL rbf, under N₂, was charged with a stir bar and anhydrous MeCN (35 mL) followed by Al(OTf)₃ (0.59 g, 1.3 mmol) then DHDO (3.0 g, 25 mmol) and allowed to stir. The flask was then quickly connected to a vacuum line pulling at a range of 5-20 torr. The mixture was heated to 40° C. and the solvent was allowed to evaporate for 18 h. The mixture was then cooled to room temperature and quenched with water (25 mL). The mixture was vortexed and sonicated for a few minutes. The mixture was then diluted with DMC (25 mL). The organic layer was separated, and the aqueous layer was extracted with DMC (3×25 mL). The combined organic extracts were washed with brine, dried (MgSO₄), filtered and concentrated in vacuo. to provide a white solid.

GPC analysis was carried out on this product dissolved in DMF solvent containing 0.05M LiBr using a Waters GPC with an Optilab refractive index detector coupled with Nelson Analytical data collection software. Molecular weights (Mw, Mn, Mz) and distribution of polymer were based on calibration with monodisperse polystyrene standards. The Number Average Molecular Weight (Mn) was measured as 6880 Dalton and the Weight Average Molecular Weight (Mw) was measured as 26,764 Dalton. The polydispersity index (PDI) was 3.89.

### Example 20. Polymerization of 2,5-Dihydroxy-1,4-Dioxane (DHDO) with a Catalytic Amount of Copper (II) Triflate Cu(OTf)₂ in 1,4-Dioxane Under Reduced Pressure with Gradual Solvent Removal

Under N₂ environment, 70 mL of 1,4 dioxane was added to a 100 mL rbf followed by Cu(OTf)₂ (0.45 g, 1.3 mmol, 0.05 equival. with respect to DHDO), and DHDO (3.0 g, 25 mmol). The flask was then quickly connected (using a side arm vacuum adapter and vacuum tubing) via a two-way manifold to a J-KEM scientific digital vacuum regulator with the regulator set to full vacuum. The regulator was connected to a Maxima C Plus high vacuum pump (Fisher Scientific). The mixture was then heated to 40° C. under full vacuum for 19 h during which time the solvent was gradually removed. The mixture was then cooled to room temperature and concentrated in vacuo. Water (50 mL) was added, and the mixture was vortexed for a few minutes before 50 mL of DCM was added. The layers were separated, and the aqueous phase was extracted with 2×50 mL of DCM. The organic layers were combined, dried (MgSO₄), and concentrated in vacuo then dried under high vacuum overnight to give a white solid (0.7 g, 28% yield).

GPC analysis was carried out on this product dissolved in DMF containing 0.05M LiBr using a Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was measured as 10,774 Dalton and the Weight Average Molecular Weight (Mw) was measured as 47,470 Dalton. The polydispersity index (PDI) was measured as 4.41.

### Example 21. Polymerization of 2,5-Dihydroxy-1,4-Dioxane (DHDO) with a Catalytic Amount of Aluminum Sulfate Al₂ (SO₄)₃ at 70° C. Using Magnetic Overhead Stirring in the Absence of Solvent

To a 20 mL vial was added DHDO (2.0 g, 16.64 mmol) and Al₂ (SO₄)₃ (14 mg, 0.04 mmol, 0.25 mol %). The vial was connected to a magnetic overhead stirrer which was connected using a vacuum adapter and a two-way manifold to a J-KEM scientific digital vacuum regulator with the regulator set to full vacuum. The regulator was connected to a Maxima C Plus high vacuum pump (Fisher Scientific). The flask was then placed in an oil bath that was heated to 70° C. The flask was held at 70° C. with stirring for one hour. The solution was rapidly cooled to room temperature using compressed air blown through Tygon® plastic tubing. Water (5 mL) was added, the mixture was vortexed and then decanted and dried under high vacuum overnight to give a white solid (1.25 g, 74% yield).

### Example 22. Polymerization of 2,5-Dihydroxy-1,4-Dioxane (DHDO) with a Catalytic Amount of Aluminum Sulfate Al₂ (SO₄)₃ at 70° C. For One Hour Followed by 40° C. For 18 Hours in the Absence of Solvent

To a 20 mL vial equipped with a stir bar was added DHDO (1.0 g, 8.32 mmol) and Al₂(SO₄)₃ (0.08 mmol, 1 mol %). The vial was connected using a vacuum adapter and a two-way manifold to a J-KEM scientific digital vacuum regulator with the regulator set to full vacuum. The regulator was connected to a Fisherbrand Maxima C Plus. high vacuum pump. The reading on the regulator ranged from 1 to 10 torr. The flask was then placed in an oil bath that was heated to 70° C. The flask was held at 70° C. with stirring for one hour. The oil bath temperature was then reduced to 40° C. and the mixture was allowed to stand for an additional 18 hours. The solution was then allowed to cool to room temperature. Water (5 mL) was added, the mixture was vortexed, decanted, and dried under high vacuum for overnight to give a white solid (0.62 g, 73% yield).

### Example 23. Polymerization of 2,5-Dihydroxy-1,4-Dioxane (DHDO) with a Catalytic Amount of Copper (II) Triflate (Cu(OTf)₂) in 1,4-Dioxane Under Reduced Pressure with Gradual Solvent Removal Followed by a Temperature Increase after Solvent Removal

Under N₂ environment, 70 mL of 1,4 dioxane is added to a 100 mL 3-necked rbf followed by Cu(OTf)₂ (0.45 g, 1.3 mmol, 0.05 equival. with respect to DHDO), and DHDO (3.0 g, 25 mmol). The flask is then quickly connected (using a side arm vacuum adapter and vacuum tubing) via a two-way manifold to a J-KEM scientific digital vacuum regulator with the regulator set to 108 torr. One of the other necks is attached (using a bearing) to an overhead stirrer with a high shear mechanical mixing blade. The regulator is connected to a Maxima C Plus high vacuum pump (Fisher Scientific). The mixture is heated to 40° C. under reduced vacuum for around 90 minutes during which time the solvent is gradually removed. Once most of the solvent is judged to be removed (by visual inspection) the temperature of the oil bath is increased to 55° C. and the vacuum is set to full vacuum. The mixture is stirred at 55° C. for two hours. The mixture is then cooled to room temperature and concentrated in vacuo. Water (50 mL) is added, and the mixture is vortexed for a few minutes before 50 mL of DCM is added. The layers are separated, and the aqueous phase is extracted with 2×50 mL of DCM. The organic layers are combined, dried (MgSO₄), and concentrated in vacuo then dried under high vacuum overnight to give a white solid with Mw greater than 50,000 Da.

### Example 24. Polymerization of 2,5-dihydroxy-1,4-dioxane (DHDO) with a catalytic amount of Aluminum Sulfate Al₂ (SO₄)₃ at 70° C. using magnetic overhead stirring in the absence of solvent followed by a temperature reduction to 40° C. and addition of Aluminum triflate Al(OTf)₃

To a 20 mL vial is added DHDO (2.0 g, 16.6 mmol) and Al₂ (SO₄)₃ (14 mg, 0.04 mmol, 0.25 mol %). The vial is connected to a magnetic overhead stirrer which is connected using a vacuum adapter and a two-way manifold to a J-KEM scientific digital vacuum regulator with the regulator set to full vacuum. The regulator is connected to a Maxima C Plus high vacuum pump (Fisher Scientific). The flask is then placed in an oil bath that is heated to 70° C. The flask is held at 70° C. with stirring for one hour. The temperature of the oil bath is then decreased to 40° C. Aluminum triflate (19 mg, 0.04 mmol, 0.25 mol %) is then added and the mixture is stirred at 40° C. for two additional h. The vial is then cooled to room temperature using compressed air blown through tubing. Water (5 mL) is added, the mixture is vortexed, decanted, and then dried under high vacuum for overnight to give a white solid.

### Example 25. Polymerization of 2,5-dihydroxy-1,4-dioxane (DHDO) with a catalytic amount of Aluminum Triflate Al(OTf)₃ in Acetonitrile under reduced pressure with gradual solvent removal in a 300 mL Custom Jacketed Reactor equipped with mechanical overhead stirring

To a ChemGlass 300 mL custom Jacketed Reactor (Vineland, NJ), attached to a temperature controlled circulator bath and equipped with a Hedolph Hei-TORQUE Ultimate 400 Stirrer attached to a custom Teflon® fluoropolymer coated stir shaft that allows for minimal stirring dead space within the vessel, at room temperature, under N₂, is added anhydrous acetonitrile (178 mL) followed by Al(OTf)₃ (2.96 g, 6.5 mmol) then DHDO (15.0 g, 125 mmol) and the mixture is allowed to stir at 200 rpm, while warming the circulator and reactor jacket to 40° C. over 5 minutes. The reactor is also connected by a vacuum adapter and a two-way manifold to a J-KEM scientific digital vacuum regulator with the regulator set to 108 Torr. The regulator is connected to a Maxima C Plus high vacuum pump (Fisher Scientific) connected to a cold trap. Once the circulator reaches 40° C., the reactor is placed under regulated vacuum set at 108 Torr. The reaction is allowed to stir at 200 rpm under 108 Torr at 40° C. for 18 h, while gradually removing solvent. After 18 hours the circulator is cooled to room temperature over the course of 1 hour. Once cooled, the mixture is quenched with water (125 mL) and allowed to stir for 30 minutes to help solubilize the polymer. This aqueous layer is removed from the reactor, transferred to a separatory funnel and DMC (125 mL) is added. The organic layer is separated. DMC is added to the reactor to help solubilize remaining material in the reactor and stirred for 30 minutes before transferring to the separatory funnel for extraction of the aqueous layer. The aqueous layer is further extracted with DMC (3×125 mL). The combined organic extracts are washed with brine, dried (MgSO₄), filtered and concentrated in vacuo. to provide a white solid.

### Example 26. Polymerization of 2,5-Dihydroxy-1,4-Dioxane (DHDO) with a Catalytic Amount of Aluminum Methane Sulfonate Al(OMs)₃ in Acetonitrile Under Reduced Pressure with Gradual Solvent Removal

An oven-dried 100 mL rbf, under N₂, is charged with a stir bar and anhydrous acetonitrile (35 mL) followed by Al(OMS)₃ (0.41 g, 1.3 mmol) and then DHDO (3.0 g, 25 mmol) and the mixture is allowed to stir. The flask is then quickly connected to a vacuum line pulling at a range of 5-20 torr. The mixture is heated to 40° C. and the solvent is allowed to evaporate for 18 hours. The mixture is then cooled to room temperature and quenched with water (25 mL). The mixture is vortexed and sonicated for a few minutes. The mixture is then diluted with DMC (25 mL). The organic layer is separated, and the aqueous layer is extracted with DMC (3×25 mL). The combined organic extracts are washed with brine, dried (MgSO₄), filtered and concentrated in vacuo. to provide a white solid.

### Example 27. Determination of 5% Mass Loss Temperature (T95)

All T95 measurements were performed using a microscope slide and a melt press. A sample of polymer was placed on a tared microscope slide. The slide with the sample was placed on a melt press with the temperature set at 180° F. (82.2° C.). The slide was held at that temperature for one min and weighed again to observe any mass loss. This procedure was repeated in 20° F. increments until the sample had lost 5% of its original mass. This point is termed T95.

Alternatively, T95 can be determined using thermogravimetric analysis (TGA). A dried sample is tared on an aluminum pan and measured against a reference pan of the same material. Measurements are performed in nitrogen from 25 to 600° C. at a rate of 10° C./min. TGA experiments and analyses are performed using the TRIOS (v. 5.1.1) software from TA Instruments. To validate the method employed for all samples (above), TGA analysis was also employed to measure T95 for the polymer of Example 28. Using this method, the temperature of 5% mass loss was determined to be 280° F. (138° C.), the same result as obtained with the method described above.

### Example 28. Polymerization of 2,5-Dihydroxy-1,4-Dioxane (DHDO) with a Catalytic Amount (0.1 Mol %) of Iron (III) Tosylate Fe(OTs)₃ at 70° C. Using Mechanical Overhead Stirring in the Absence of Solvent

In a 20 mL scintillation vial, HDO (4.47 g, 37.5 mmol) and Fe(OTs)₃ (21 mg, 0.04 mmol, 0.1 mol %) were combined. The vial was vortexed for one minute. The contents of the vial were then poured into a preheated (70° C.) 2-necked 100 mL round-bottomed flask. One arm was connected using a vacuum adapter and a two-way manifold to a J-KEM scientific digital vacuum regulator with the regulator set to full vacuum. The regulator was connected to a Maxima C Plus high vacuum pump (Fisher Scientific). The other neck was connected via an airtight adapter to a mechanical overhead stirrer with a football-shaped blade made to fit the glassware. The melt solution was then stirred at 70° C. for 30 minutes before being cooled to room temperature and washed with 50 ml of water. The water was decanted, and the residual solid was dried under full high vacuum overnight to give a white solid (2.1 g, 55% yield).

GPC analysis was carried out on this product dissolved in DMF containing 0.05 M LiBr using a Waters GPC with an Optilab refractive index detector coupled with Nelson Analytical data collection software. Molecular weights (Mw, Mn, Mz) and the distribution of polymers were measured based on calibration with monodisperse polystyrene standards. The Number Average Molecular Weight (Mn) was measured as 8,074 Dalton and the Weight Average Molecular Weight (Mw) was measured as 22,569 Dalton. The polydispersity index (PDI) was 2.80.

According to the procedure of Example 27, the temperature of 5% mass loss (T95) of this sample was determined to be 280° F. (138° C.).

A portion of the product (400 mg) was placed in parchment paper and then melt pressed into a thin film using a melt press at a temperature of 104° C. The film was cooled to room temperature, was removed from the paper and cut into 2 mm wide strips. Tensile testing was performed on the strips at room temperature (20° C.) using a RSA-G2 instrument (TA Instruments, New Castle, DE). Young's modulus was measured as 13.7 MPa (2,200 kPa), elongation at break was measured as 1064% and ultimate tensile strength was measured as 2.31 MPa.

### Example 29. Polymerization of 2,5-Dihydroxy-1,4-Dioxane (DHDO) with a Catalytic Amount (0.5 Mol %) of Iron (III) Tosylate Fe(OTs)₃ at 70° C. Using Mechanical Overhead Stirring in the Absence of Solvent

Into a 20 mL scintillation vial, DHDO (3.00 g, 25.0 mmol) and Fe(OTs)₃ (71 mg, 0.1 mmol, 0.5 mol %) were combined. The vial was vortexed for one minute. The contents of the vial were then poured into a preheated (70° C.) 2-necked 100 mL round-bottomed flask. One arm was connected using a vacuum adapter and a two-way manifold to a J-KEM scientific digital vacuum regulator with the regulator set to full vacuum. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 70° C. for 60 minutes before being cooled to rt and washed with 50 ml of water. The water was decanted, and the residual solid was dried under full high vacuum overnight to give a white solid (1.7 g, 68% yield).

GPC analysis was carried out on this product dissolved in DMF containing 0.05 M LiBr using a Waters GPC with an Optilab refractive index detector coupled with Nelson Analytical data collection software. Molecular weights (Mw, Mn, Mz) and the distribution of polymers were measured based on calibration with monodisperse polystyrene standards. The Number Average Molecular Weight (Mn) was measured as 7,935 Dalton, and the Weight Average Molecular Weight (Mw) was measured as 29, 198 Dalton. The polydispersity index (PDI) was 3.68.

### Example 30. Polymerization of 2,5-Dihydroxy-1,4-Dioxane (DHDO) with a Catalytic Amount (0.5 Mol %) of Copper (II) Methane Sulfonate Cu(OMs)₂ at 70° C. Using Mechanical Overhead Stirring in the Absence of Solvent

Into a 20 mL scintillation vial, DHDO (5.00 g, 41.7 mmol) and Cu(OMs)₂ (53 mg, 0.021 mmol, 0.5 mol %) were combined. The vial was vortexed for one minute. The contents of the vial were then poured into a preheated (70° C.) 2-necked 100 mL round-bottomed flask. One arm was connected using a vacuum adapter and a two-way manifold to a J-KEM scientific digital vacuum regulator with the regulator set to full vacuum. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 70° C. for 60 minutes before being cooled to rt and washed with 50 ml of water. The water was decanted, and the residual solid was dried under full high vacuum overnight to give a white solid (3.4 g, 78% yield).

GPC analysis was carried out on this product dissolved in DMF containing 0.05 M LiBr using a Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was measured as 10, 130 Dalton, and the Weight Average Molecular Weight (Mw) was measured as 23,025 Dalton. The polydispersity index (PDI) was 2.27.

### Example 31. Polymerization of 2,5-Dihydroxy-1,4-Dioxane (DHDO) with a Catalytic Amount (0.5 Mol %) of Gallium (III) Triflate Ga(OTf)₃ at 70° C. Using Mechanical Overhead Stirring in the Absence of Solvent

Into a 20 mL scintillation vial, DHDO (5.00 g, 41.7 mmol) and Ga(OTf)₃ (108 mg, 0.02 mmol, 0.5 mol %) were combined. The vial was vortexed for one minute. The contents of the vial were then poured into a preheated (70° C.) 2-necked 100 mL round-bottomed flask. One arm was connected using a vacuum adapter and a two-way manifold to a J-KEM scientific digital vacuum regulator with the regulator set to full vacuum. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 70° C. for 60 minutes before being cooled to rt and washed with 50 ml of water. The water was decanted, and the residual solid was dried under full high vacuum overnight to give a white solid (2.4 g, 56% yield).

GPC analysis was carried out on this product dissolved in DMF containing 0.05 M LiBr using a Waters GPC with an Optilab refractive index detector coupled with Nelson Analytical data collection software. Molecular weights (Mw, Mn, Mz) and the distribution of polymers were measured based on calibration with monodisperse polystyrene standards. The Number Average Molecular Weight (Mn) was measured as 9,365 Dalton, and the Weight Average Molecular Weight (Mw) was measured as 20,137 Dalton. The polydispersity index (PDI) was 2.15.

### Example 32. Polymerization of 2,5-dihydroxy-1,4-dioxane (DHDO) with a catalytic amount (0.5 mol %) of Copper (II) triflate Cu(OTs)₂ at 70° C. using mechanical overhead stirring in the absence of solvent

Into a 20 mL scintillation vial, DHDO (5.00 g, 41.7 mmol) and Cu(OMs)₂ (75 mg, 0.02 mmol, 0.5 mol %) were combined. The vial was vortexed for one minute. The contents of the vial were then poured into a preheated (70° C.) 2-necked 100 mL round-bottomed flask. One arm was connected using a vacuum adapter and a two-way manifold to a J-KEM scientific digital vacuum regulator with the regulator set to full vacuum. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 70° C. for 60 minutes before being cooled to rt and washed with 50 ml of water. The water was decanted, and the residual solid was dried under full high vacuum overnight to give a white solid (2.4 g, 50% yield).

GPC analysis was carried out on this product dissolved in DMF containing 0.05 M LiBr using a Waters GPC with an Optilab refractive index detector coupled with Nelson Analytical data collection software. Molecular weights (Mw, Mn, Mz) and the distribution of polymers were measured based on calibration with monodisperse polystyrene standards. The Number Average Molecular Weight (Mn) was measured as 9.629 Dalton, and the Weight Average Molecular Weight (Mw) was measured as 23,936 Dalton. The polydispersity index (PDI) was 2.44.

### Example 33. Polymerization of 2,5-Dihydroxy-1,4-Dioxane (DHDO) with a Catalytic Amount (0.5 Mol %) of Iron (III) Triflate Fe(OTf)₃ at 70° C. Using Mechanical Overhead Stirring in the Absence of Solvent

Into a 20 mL scintillation vial, DHDO (5.00 g, 41.7 mmol) and Fe(OTf)₃ (105 mg, 0.02 mmol, 0.5 mol %) were combined. The vial was vortexed for one minute. The contents of the vial were then poured into a preheated (70° C.) 2-necked 100 mL round-bottomed flask. One arm was connected using a vacuum adapter and a two-way manifold to a J-KEM scientific digital vacuum regulator with the regulator set to full vacuum. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 70° C. for 60 minutes before being cooled to rt and washed with 50 ml of water. The water was decanted, and the residual solid was dried under full high vacuum overnight to give a white solid (2.3 g, 53% yield).

GPC analysis was carried out on this product dissolved in DMF containing 0.05 M LiBr using a Waters GPC with an Optilab refractive index detector coupled with Nelson Analytical data collection software. Molecular weights (Mw, Mn, Mz) and the distribution of polymers were measured based on calibration with monodisperse polystyrene standards. The Number Average Molecular Weight (Mn) was measured as 8,664 Dalton, and the Weight Average Molecular Weight (Mw) was measured as 18,624 Dalton. The polydispersity index (PDI) was 2.10.

### Example 34. Polymerization of 2,5-Dihydroxy-1,4-Dioxane (DHDO) with a Catalytic Amount (0.5 Mol %) of Copper (II) Chloride CuCl₂ at 70° C. Using Mechanical Overhead Stirring in the Absence of Solvent

Into a 20 mL scintillation vial was combined DHDO (5.00 g, 41.7 mmol) and CuCl₂ (28 mg, 0.02 mmol, 0.5 mol %). The vial was vortexed for one minute. The contents of the vial were then poured into a preheated (70° C.) 2-necked 100 mL round-bottomed flask. One arm was connected using a vacuum adapter and a two-way manifold to a J-KEM scientific digital vacuum regulator with the regulator set to full vacuum. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 70° C. for 60 minutes before being cooled to rt and washed with 50 ml of water. The water was decanted, and the residual solid was dried under full high vacuum overnight to give a white solid (1.5 g, 35% yield).

GPC analysis was carried out on this product dissolved in DMF containing 0.05 M LiBr using a Waters GPC with an Optilab refractive index detector coupled with Nelson Analytical data collection software. Molecular weights (Mw, Mn, Mz) and the distribution of polymers were measured based on calibration with monodisperse polystyrene standards. The Number Average Molecular Weight (Mn) was measured as 8,573 Dalton, and the Weight Average Molecular Weight (Mw) was measured as 16,623 Dalton. The polydispersity index (PDI) was 1.94.

### Example 35. Polymerization of 2,5-Dihydroxy-1,4-Dioxane (DHDO) with a Catalytic Amount (0.5 Mol %) of Copper (II) Sulfate CuSO₄ at 70° C. Using Mechanical Overhead Stirring in the Absence of Solvent

Into a 20 mL scintillation vial was combined DHDO (5.00 g, 41.7 mmol) and CuSO4 (33 mg, 0.02 mmol, 0.5 mol %). The vial was vortexed for one minute. The contents of the vial were then poured into a preheated (70° C.) 2-necked 100 mL round-bottomed flask. One arm was connected using a vacuum adapter and a two-way manifold to a J-KEM scientific digital vacuum regulator, with the regulator set to full vacuum. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 70° C. for 60 minutes before being cooled to rt and washed with 50 ml of water. The water was decanted, and the residual solid was dried under full high vacuum overnight to give a white solid (1.2 g, 28% yield).

GPC analysis was carried out on this product dissolved in DMF containing 0.05 M LiBr using a Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was measured as 8,879 Dalton, and the Weight Average Molecular Weight (Mw) was measured as 18,516 Dalton. The polydispersity index (PDI) was 2.09.

### Example 36. Polymerization of 2,5-Dihydroxy-1,4-Dioxane (DHDO) with a Catalytic Amount (0.1 Mol %) of Indium (III) Triflate in(OTf)₃ at 70° C. Using Mechanical Overhead Stirring in the Absence of Solvent

Into a 20 mL scintillation vial was combined DHDO (5.00 g, 41.7 mmol) and In(OTf)₃ (23 mg, 0.04 mmol, 0.1 mol %). The vial was vortexed for one minute. The contents of the vial were then poured into a preheated (70° C.) 2-necked 100 mL round-bottomed flask. One arm was connected using a vacuum adapter and a two-way manifold to a J-KEM scientific digital vacuum regulator, with the regulator set to full vacuum. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 70° C. for 30 minutes before being cooled to rt and washed with 50 ml of water. The water was decanted, and the residual solid was dried under full high vacuum overnight to give a white solid (2.7 g, 64% yield).

GPC analysis was carried out on this product dissolved in DMF containing 0.05 M LiBr using a Waters GPC with an Optilab refractive index detector coupled with Nelson Analytical data collection software. Molecular weights (Mw, Mn, Mz) and the distribution of polymers were measured based on calibration with monodisperse polystyrene standards. The Number Average Molecular Weight (Mn) was measured as 9,706 Dalton, and the Weight Average Molecular Weight (Mw) was measured as 31,654 Dalton. The polydispersity index (PDI) was 3.26.

### Example 37. Polymerization of 2,5-Dihydroxy-1,4-Dioxane (DHDO) with a Catalytic Amount (0.1 Mol %) of Bismuth (III) Triflate Bi(OTf)₃ at 70° C. Using Mechanical Overhead Stirring in the Absence of Solvent

Into a 20 mL scintillation vial was combined with DHDO (6.0 g, 50 mmol) and Bi(OTf)₃ (33 mg, 0.05 mmol, 0.1 mol %). The vial was vortexed for one minute. The contents of the vial were then poured into a preheated (70° C.) 2-necked 100 mL round-bottomed flask. One arm was connected using a vacuum adapter and a two-way manifold to a J-KEM scientific digital vacuum regulator, with the regulator set to full vacuum. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 70° C. for 30 minutes before being cooled to rt. The residual solid was dried under full high vacuum to give a white solid (2.3 g, 45% yield).

GPC analysis was carried out on this product dissolved in DMF containing 0.05 M LiBr using a Waters GPC with an Optilab refractive index detector coupled with Nelson Analytical data collection software. Molecular weights (Mw, Mn, Mz) and the distribution of polymers were based on calibration with monodisperse polystyrene standards. The Number Average Molecular Weight (Mn) was measured as 10, 100 Dalton, and the Weight Average Molecular Weight (Mw) was measured as 39,400 Dalton. The polydispersity index (PDI) was 3.90.

### Example 38. Polymerization of 2,5-Dihydroxy-1,4-Dioxane (DHDO) with a Catalytic Amount (0.025 Mol %) of Bismuth (III) Triflate Bi(OTf)₃ at 90° C. Using Mechanical Overhead Stirring in the Absence of Solvent

Into a 20 mL scintillation vial was combined with DHDO (11.7 g, 98 mmol) and Bi(OTf)₃ (16 mg, 0.0003 mmol, 0.025 mol %). The vial was vortexed for one minute. The contents of the vial were then poured into a preheated (90° C.) 2-necked 100 mL round-bottomed flask. One arm was connected using a vacuum adapter and a two-way manifold to a J-KEM scientific digital vacuum regulator, with the regulator set to full vacuum. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 90° C. for 15 minutes before being cooled to rt. The residual solid was dried under full high vacuum to give a white solid (5.3 g, 55% yield).

According to the procedure of Example 27, the Temperature of 5% mass loss (T95) of this sample was determined to be 420° F. (216° C.).

### Example 39. Polymerization of 2,5-Dihydroxy-1,4-Dioxane (DHDO) with a Catalytic Amount (0.05 Mol %) of Bismuth (III) Triflate Bi(OTf)₃ at 70° C. Using Mechanical Overhead Stirring with a Vacuum Gradient in the Absence of Solvent

Into a 20 mL scintillation vial was combined with DHDO (11.1 g, 93 mmol) and Bi(OTf)₃ (30 mg, 0.05 mmol, 0.05 mol %). The vial was vortexed for one minute. The contents of the vial were then poured into a preheated (70° C.) 2-necked 100 mL round-bottomed flask. One arm was connected using a vacuum adapter and a two-way manifold to a J-KEM scientific digital vacuum regulator, with the regulator set to 152 torr. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 70° C. at 152 torr for 60 minutes before being opened to full vacuum for 5 additional minutes. The reaction was then cooled to rt. The residual solid was dried under full high vacuum to give a white solid (5.6 g, 59% yield).

According to the procedure of Example 27, the Temperature of 5% mass loss (T95) of this sample was determined to be 300° F. (149° C.).

### Example 40. Polymerization of 2,5-Dihydroxy-1,4-Dioxane (DHDO) with a Catalytic Amount (0.2 Mol %) of Aluminum (III) Tosylate Al(OTs)₃ at 80° C. Using Mechanical Overhead Stirring in the Absence of Solvent

Into a 20 mL scintillation vial was combined with DHDO (8.5 g, 71 mmol) and Al(OTs)₃ (77 mg, 0.14 mmol, 0.2 mol %). The vial was vortexed for one minute. The contents of the vial were then poured into a preheated (80° C.) 2-necked 100 mL round-bottomed flask. One arm was connected using a vacuum adapter and a two-way manifold to a J-KEM scientific digital vacuum regulator, with the regulator set to full vacuum. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 80° C. for 35 minutes before being cooled to rt. The residual solid was dried under full high vacuum to give a white solid (3.7 g, 50% yield).

According to the procedure of Example 27, the Temperature of 5% mass loss (T95) of this sample was determined to be 380° F. (193° C.).

### Example 41. Polymerization of 2,5-Dihydroxy-1,4-Dioxane (DHDO) with a Catalytic Amount (0.1 Mol %) of Bismuth (III) Triflate Bi(OTf)₃ at 50° C. Using Mechanical Overhead Stirring in the Absence of Solvent

Into a 20 mL scintillation vial was combined with DHDO (9.4 g, 78 mmol) and Bi(OTf)₃ (51 mg, 0.08 mmol, 0.1 mol %). The vial was vortexed for one minute. The contents of the vial were then poured into a preheated (50° C.) 2-necked 100 mL round-bottomed flask. One arm was connected using a vacuum adapter and a two-way manifold to a J-KEM scientific digital vacuum regulator, with the regulator set to full vacuum. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 50° C. for 90 minutes before being cooled to rt. The residual solid was dried under full high vacuum to give a white solid (2.5 g, 31% yield).

According to the procedure of Example 27, the Temperature of 5% mass loss (T95) of this sample was determined to be 340° F. (171° C.).

### Example 42: Polymerization of 2,5-Dihydroxy-1,4-Dioxane (DHDO) with a Catalytic Amount (0.1 Mol %) of Aluminum (III) Tosylate Al(OTs)₃ from 80° C. To 100° C. Using Mechanical Overhead Stirring and a Vacuum Gradient in the Substantial Absence of Solvent

Into a 20 mL scintillation vial was combined DHDO (10.7 g, 89 mmol) and Al(OTs)₃ (48 mg, 0.08 mmol, 0.1 mol %). The vial was vortexed for one minute. The contents of the vial were then poured into a preheated (80° C.) 2-necked 100 mL round-bottomed flask. One arm was connected using a vacuum adapter and a two-way manifold to a J-KEM scientific digital vacuum regulator, with the regulator set to 150 torr. The regulator was connected to a Maxima C Plus high vacuum pump (Fisher Scientific). The other neck was connected via an airtight adapter to a mechanical overhead stirrer with a football-shaped blade made to fit the glassware. The solution was then stirred at 80° C. for 30 minutes before the setup was opened to full vacuum and the temperature was increased to 90° C. The mixture was stirred at 90° C. for 30 minutes before the temperature was increased to 100° C. The mixture was stirred at 100° C. for 30 minutes (90 minutes total reaction time) before being cooled to rt. The residual solid was dried under full high vacuum to give a white solid (5.3 g, 57% yield).

According to the procedure of Example 27, the temperature of 5% mass loss (T95) of this sample was determined to be 300° F. (149° C.).

We claim:

1. A method of producing polymers and copolymers from alpha-hydroxycarbonyl compounds and their dimers, the method comprising a condensation polymerization conducted in the presence of a Lewis acid catalyst substantially without solvent for at least a portion of the reaction time.

2. The method of claim 1 comprising a condensation polymerization conducted in the presence of a Lewis acid catalyst; wherein the reaction is conducted without addition of solvent, wherein vacuum is applied to generate subambient reaction pressure to remove water generated during reaction and wherein the polymer or copolymer produced has weight average molecular weight (Mw) equal to or greater than 15,000 Da or Young's modulus greater than 100 kPa (kilo Pascal) and/or ultimate tensile strength tensile higher than 200 kPa.

3. The method of claim 2, wherein the reaction pressure is less than 150 torr.

4. The method of claim 2, wherein the level of vacuum applied to the reaction is varied over the course of the reaction to change the reaction pressure.

5. The method of claim 2, wherein the temperature of the reaction ranges from 50° C. to 110° C.

6. The method of claim 2, wherein the alpha-hydroxycarbonyl compound is a glycolaldehyde dimer.

7. The method of claim 2, wherein the Lewis acid catalyst is an anhydrous salt of aluminum, bismuth or iron.

8. The method of claim 2, wherein the temperature of the reaction ranges from 50° C. to 100° C.

9. The method of claim 8, wherein the reaction pressure is less than 30 torr.

10. The method of claim 8, wherein the reaction pressure is 1 torr or less.

11. The method of claim 2, wherein water vapor removed from the reaction by application of vacuum is contacted with one or more dehydrating agents.

12. The method of claim 2, wherein the Lewis acid catalyst is a triflate, methanesulfonate, benzylsulfonate or tosylate of aluminum, iron or bismuth.

13. The method of claim 2, wherein the polymer or copolymer produced has weight average molecular weight (Mw) equal to or greater than 15,000 Da.

14. A method of claim 2, wherein the polymer or copolymer produced has Young's modulus greater than 100 kPa (kilo Pascal) and/or ultimate tensile strength tensile higher than 200 kPa.

15. A method of producing polymers and copolymers from one or more glycolaldehyde dimers, the method comprising a condensation polymerization of the one or more glycolaldehyde dimers conducted in the presence of a Lewis acid catalyst at a temperature ranging from 50° C. to 110° C.; wherein the reaction is conducted without addition of solvent, wherein vacuum is applied to generate subambient reaction pressure to remove water generated during reaction and wherein the polymer or copolymer produced has weight average molecular weight (Mw) equal to or greater than 15,000 Da or has Young's modulus greater than 100 kPa (kilo Pascal) and/or ultimate tensile strength tensile higher than 200 kPa.

16. The method of claim 15, wherein the one or more glycolaldehyde dimer is 2, 5-dihydoxy-1, 4-dioxane (DHDO).

17. The method of claim 15, wherein the Lewis acid catalyst is a triflate, methanesulfonate, benzylsulfonate or tosylate of aluminum, bismuth or iron.

18. The polymeric product of the process of claim 1.

19. The polymeric product of the process of claim 1, wherein the polymeric product has a weight average molecular weight (Mw) in excess of 15,000 Dalton.

20. A film or molded object prepared from a polymeric product of claim 1.
